(19) United States
(12) Patent Application Publication
(10) Pub. No.: US 2015/0302167 A1
(43) Pub. Date: Oct. 22, 2015

(54) SYSTEM AND METHOD FOR DEVELOPMENT OF THERAPEUTIC SOLUTIONS

(71) Applicants: CELLWORKS RESEARCH INDIA PRIVATE LIMITED, Karnataka, Bangalore (IN); CELLWORKS GROUP, INC., Saratoga, CA (US)

(72) Inventors: Shireen Vali, Saratoga, CA (US); Taher Abbasi, Saratoga, CA (US); Pradeep Fernandes, Saratoga, CA (US); Swaminathan Rajagopalan, Bangalore (IN); Aftab Alam, Bangalore (IN); Robinson Vidva, Karnataka (IN); Prashant Ramachandran Nair, Karnataka (IN); Shweta Kapoor, Bangalore (IN); Saumya Radhakrishnan, Karnataka (IN); Zeba Sultana, Bangalore (IN); Kadambi Sarangapani Ramanujan, Bangalore (IN); Krishna Kumar Tiwari, Bangalore (IN); Ansu Kumar, Bangalore (IN); Neeraj Kumar Singh, Bangalore (IN); Ashish Kumar Agrawal, Bangalore (IN); Anay Ashok Talawdekar, Bangalore (IN); Shahabuddin Usmani, Bangalore (IN); Ragini Singh, Bangalore (IN)

(73) Assignee: CELLWORKS GROUP, INC., Saratoga, CA (US)

(21) Appl. No.: 14/442,082

(22) PCT Filed: Nov. 8, 2013
(86) PCT No.: PCT/IB2013/060011

§ 371 Date: May 11, 2015

(30) Foreign Application Priority Data
Nov. 9, 2012 (IN) 4718/CHE/2012

(51) Int. Cl. G06F 19/00

(52) U.S. Cl. CPC G06F 19/3437; G06F 19/326

(57) ABSTRACT

The present disclosure relates to a system for obtaining a therapeutic solution for treatment of a disease or a disorder. The present disclosure also relates to a method of drug discovery and designing therapeutic solutions for various medical conditions, through the said system, comprising database, digital drug library and a processor.

### TECHNICAL FIELD

The present disclosure relates to a system for obtaining a therapeutic solution for treatment of a disease or a disorder and also relates to a method of drug discovery and obtaining therapeutic solutions for various medical conditions, through the system.

### BACKGROUND OF THE DISCLOSURE

The process of discovering a drug and bringing it to the market is highly complicated and takes an average of 10-15 years and costs around $800 million to $1 billion. This cost takes into account all the failures. For every 5000-10000 compounds that enter the research and development pipeline, ultimately only one compound receives approval. Every successful drug that reaches the market has to undergo a long process of pre-clinical and clinical testing. The entire process starting from understanding of a disease to the pre-clinical testing consumes about three to six years whereas the clinical testing phase consumes an average time span of six to seven years. A candidate drug must go through extensive studies in humans, and must prove to be safe and effective before the Food and Drug Administration (FDA) and other regulatory agencies approves the drug.

The success rates for different therapeutics vary among the different stages of clinical trials. For instance, there's only a 66% chance that a compound will get through Phase I, but only a 33% chance of success in Phase II, and a 55% chance in Phase III. Once the drug has been submitted for regulatory approval, the success rate shoots to 80%. In the year 2008 to 2010, the reported Phase II failures for new drugs and major new indications of existing drugs included 51% due to insufficient efficacy, 29% due to strategic reasons like inadequate differentiation from more advanced drugs in the same class or from drugs with similar indications in another mechanistic class and 19% due to clinical or preclinical safety reasons. Although, the success rate in the Phase II trials is a significant determining factor, the benefit-risk ratio and the increasing complexity of diseases are the major reasons for determining the probability of a compound getting approved.

Disorders like Rheumatoid Arthritis (RA), Cancer, Atherosclerosis, Leukocyte defects, autoimmune disorders, inflammatory disorders etc. are considered to be complex diseases severely affecting large populations on a global scale. Developing therapeutic drugs to these disorders with complex pathophysiology poses a major challenge owing to the very low success rate of such developed drug molecules in clinical trials.

For instance, Phase I success rate for RA therapeutics is known to be 88%, much higher than the industry standard of 64%. The Phase II success rate is 22%, which is significantly lower than the industry standard of 39%. Phase III yields a success rate of 86% for this indication, higher than the industry standard of 66%. Cumulatively, the success rate for RA is 16%, which is at par with the industry standard of 16%. This means that out of 6 drug candidates clinically investigated in this disease area, only one will make it to market successfully. [Jayasundara K S et al. J Rheumatol. 2012; Sep. 1]

Further, oncology drug development has a poor track record in clinical development and the lowest success rate overall. In the therapeutics sector, the highest overall success rate from Phase I through likelihood of approval is infectious diseases, followed by endocrine system drugs at 10.4%, autoimmune diseases at 9.4% and cancer drug success rate of 4.7% is the lowest. The reasons for a very low success rate in cancer is due to the complexity of the multi-phenotype disease that in itself is not one disease, but highly heterogeneous. At the molecular level, two cancers are hardly identical and this results in extremely varied drug responses between individual patients even for the same kind of cancer. The cancer preclinical models used to predict clinical efficacy and toxicity are insufficient and unreliable in predicting clinical outcomes in different patient populations. They lack the complexity of the differences between individual patients and also the heterogeneity of the tumor microenvironment within a particular tumor tissue. Additionally, issues related to the design of clinical trials in oncology also contribute to the low success rate in this therapeutic area.

Rheumatoid Arthritis, a complex auto-immune disorder affecting the joints and cancer, another complex disorder caused by uncontrolled growth of cells affecting specific and different tissues, affect a significant population for which the current treatment regimens are inadequate in treating or curing the disease. There is a need for developing newer therapies for these complex diseases. One of the key reasons for the failure of newly developed drug treatments, whether small molecule or biologics, is not being able to get a thorough insight and understanding of how the drug works on the disease endpoints and not being able to predict clinical outcomes early on in the process. The preclinical experimental systems used, whether in vitro cells or animal models, are all black boxes in terms of being able to see how the particular drug works. All that can be monitored is the endpoint being assayed. The biological system is a very complex network with a maze of interactions intra- and inter-cellularly and due to this cross-talk, there are multiple effects of manipulating a single target and pathway besides what is being observed. Some of the effects, if acute, are directly observed through a phenotypic manifestation while some other effects could be more indirect and could manifest to a phenotype more subtly and over a longer time interval. A thorough understanding of the biology of the manipulations in the disease and control systems is needed to avoid pitfalls in lack of efficacy or toxicity effects later in the process of drug development.

Lack of a transparent and predictive experimental system has been a key missing link in the success rate of drug discovery and development. This when compared to other orthogonal and equally complex areas of semi-conductor engineering, space, automotive, climate, traffic etc. where we have technology to predict outcomes based on different ‘what-if’ scenarios, is what the key regulatory agencies like the FDA realized is missing in the Pharma industry. Early identification of failures is equally important to increase the success rate of drug development and this insight can be obtained through creating a virtual physiology model of the disease that makes the complex network maze transparent and dynamic and allows prediction of endpoints and clinical outcomes.

The current treatment regimens to these diseases have issues with toxicity and also developing resistance to the treatment over time. This is the case with the disease modifying (DMARD) drugs for RA that are known to stop being effective after some time. For cancer too, the cytotoxic drugs that work by killing the cancer cells also affect all the rapidly dividing cells in the body thereby having severe adverse consequences on the entire system as a whole. These drugs have a very narrow therapeutic window. The targeted drugs for cancer as in RA are known to become resistant after sometime. The common theme across these multi-phenotype, heterogeneous diseases is that we need treatments that are targeting multiple aspects of the disease and those which do not become resistant over time. One way to tackle this is to have a combination drug approach with combining drugs affecting different targets and pathways. To be able to test these combinations in a high throughput manner at different concentrations and monitor the impact on multiple disease endpoints instead of one phenotype assay, a simulation based predictive approach is required at the cellular and molecular abstraction level that can in turn be transformed to disease phenotype functions based on biomarkers. This can tremendously decrease the time taken for the development of a novel therapy for complex diseases and also bring down the failure rate of therapies and hence the cost involved in the initial phases of drug development including target identification etc. This emphasizes the need for novel comprehensive virtual experimental systems using in-silico approach that aids in rationalizing target selection and prioritization.

### SUMMARY OF THE DISCLOSURE

The disclosure includes a novel methodology of designing therapeutic solutions for complex, multi-phenotype human diseases such as the autoimmune disorders like Rheumatoid Arthritis and the varied kinds of cancers, using a virtual, predictive, physiology aligned disease model. This system comprises of a comprehensive network of signaling and metabolic regulation at the intra-cellular and inter-cellular level underlying the various phenotypes of the disease. The disease is induced through various triggers and/or cellular changes caused by mutations. A digital drug library is created through representing the functional modulation of the drug targets. This digital library is run in an automated high-throughput engine and the impact on various biomarkers and phenotypes is assessed. Millions of studies of the combinations at different concentrations are tested and through designed cost functions of efficacy, low toxicity and PKPD compatibility of the drugs and compounds, the combinations for specific disease profiles and indications are identified. This process which would normally take 6-8 years conventionally can be achieved in 1-2 months. The designs are then tested and validated in appropriate and standard preclinical models of the disease. The technology and methodology allows the generation of a pipeline of effective combination therapies that can be personalized to specific profiles of the disease.

One example aspect disclosed in the present disclosure includes a system for obtaining a therapeutic solution for treatment of a disease. In one example embodiment, the system includes a database. One example embodiment of the database comprises one or more unit models, wherein the one or more unit models are configured by collating information on parameters of biological system from plurality of information sources. Further there may be one or more cell system models. The one or more cell system models are obtained by integrating the one or more unit models, the one or more cell system models facilitates simulation of at least one of the biological system or homeostatic state of the biological system. In addition, one or more disease models are obtained by integrating the one or more cell system models. The disease models facilitate simulation of the perturbed state of the biological system.

A digital drug library may be formed by combining information on plurality of categories of digital drug capsules.

A processor is communicatively connected to the database and the digital drug library and the processor is configured to transmit one of the one or more disease models along with a set of drugs from the digital drug library to a scheduler. It is noted that the set of drugs are selected from the digital drug library based on a predefined cost function, wherein the scheduler distributes one or more of the plurality of digital drug capsules with the one or more disease models to one or more computing devices. In addition, the scheduler is connected to the one or more computing devices through a network.

The processor also is configured to receive an output comprising the effect of the set of drugs on the disease model from the scheduler, wherein the scheduler transmits the output to the processor by combining matching results from the one or more computing devices. The processor is also configured to analyze the output to obtain the therapeutic solution in context of said disease.

The present disclosure further relates to a method of obtaining a therapeutic solution for treatment of a disease. In one example embodiment, the method comprises transmitting one of one or more disease model along with a set of drugs from a digital drug library to a scheduler. The set of drugs are selected from the digital drug library based on a predefined cost function. Then, the scheduler distributes the one or more of the plurality of digital drug capsules with the one or more disease models to one or more computing devices. Thescheduler is connected to the one or more computing devices through a network. The method also comprises receiving an output comprising the effect of the set of drugs on the diseased model from the scheduler, wherein the scheduler transmits the output to the processor by combining matching results from the one or more computing devices. Further the method comprises analyzing the output to obtain the therapeutic solution in context of said disease.

In an embodiment, the present disclosure further relates to a non-transitory computer readable medium wherein operations are stored which are processed by at least one processing unit. This processing causes the system to perform the acts of transmitting one of one or more disease model along with a set of drugs from a digital drug library to a scheduler. The set of drugs are selected from the digital drug library based on a predefined cost function. The scheduler then distributes one or more of the plurality of digital drug capsules with the one or more disease models to one or more computing devices. The scheduler is connected to the one or more computing devices through a network.

The processing unit thereafter receives an output comprising the effect of the set of drugs on the diseased model from the scheduler. The scheduler transmits the output to the processor by combining matching results from the one or more computing devices. The processing unit further analyzes the output to obtain the therapeutic solution in context of said disease.

In another embodiment, the present disclosure relates to a computer program for obtaining a therapeutic solution for treatment of a disease. The computer program comprises code segment for transmitting one of one or more disease model along with a set of drugs from a digital drug library to a scheduler. The set of drugs are selected from the digital drug library based on a predefined cost function. The scheduler then distributes the one or more of the plurality of digital drug capsules with the one or more disease models to one or more computing devices. The scheduler is connected to the one or more computing devices through a network, code segment for receiving an output comprising the effect of the set of drugs on the diseased model from the scheduler. The scheduler transmits the output to the processor by combining matching results from the one or more computing devices, and code segment for analyzing the output to obtain the therapeutic solutions in context of said disease.

### BRIEF DESCRIPTION OF THE ACCOMPANYING FIGURES

The features of the present disclosure are set forth with particularity in the appended claims. The embodiments of the disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates system for obtaining a therapeutic solution for treatment of a disease in accordance with an embodiment of the present disclosure.

FIG. 2 shows development of disease model in accordance with an embodiment of the present disclosure.

FIG. 3 shows pathway information for G-protein coupled Receptor (GPCR) leading to cyclic adenosine mono-phosphate (cAMP) activation, assimilated through data mining processes in accordance with an embodiment of the present disclosure.

FIG. 4 shows static representation of G-protein coupled Receptor (GPCR) leading to cyclic adenosine mono-phosphate (cAMP) activation in a unit model in accordance with an embodiment of the present disclosure.

FIG. 5 shows the definition of kinetic equations to assign dynamism of static model in accordance with an embodiment of the present disclosure.

FIG. 6 shows different steps and processes involved in virtual study execution through the system in accordance with an embodiment of the present disclosure.

FIG. 7 shows the process of integration of unit models to cell systems and cell systems to disease or co-culture models in accordance with an embodiment of the present disclosure.

FIG. 8 shows the steps involved in developing digital drug capsule into digital drug library in accordance with an embodiment of the present disclosure.

FIG. 9 shows various steps involved in the drug combination design process in accordance with an embodiment of the present disclosure.

FIG. 10 shows graphical notations and their types used in the static model representation in accordance with an embodiment of the present disclosure.

FIG. 11 shows static representation of IL6-STAT3 signaling which is dynamically simulated in accordance with an embodiment of the present disclosure.

FIG. 12 shows the interaction between TCELL_IL6_ec, TCELL_IL6R & TCELL_IL6_act and they are dynamically represented using concentration vs. time graph in accordance with an embodiment of the present disclosure.

FIG. 13 shows the linking of various cell system models to develop a co-culture model in accordance with an embodiment of the present disclosure.

FIG. 14 shows the effect of drug combinations being displayed on a user interface in accordance with an embodiment of the present disclosure.

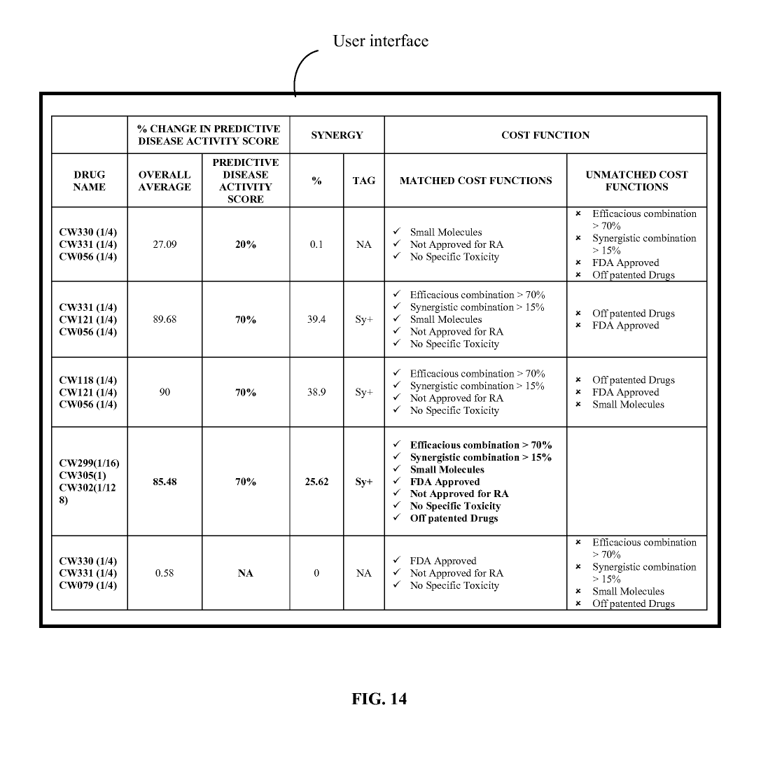

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE DISCLOSURE

The present disclosure relates to a system for obtaining a therapeutic solution for treatment of a disease. The system comprises a database having one or more unit models. The one or more unit models are configured by collating information on parameters of biological system from plurality of information sources. The database further comprises one or more cell system models, wherein the one or more cell system models are obtained by integrating the one or more unit models. The one or more cell system models facilitate simulation of at least one of the biological system or homeostatic state of the biological system. The database further comprises one or more disease models, wherein the one or more disease models is obtained by integrating the one or more cell system models. The disease models facilitate simulation of the perturbed state of the biological system.

The system further comprises a digital drug library formed by combining information on plurality of categories of digital drug capsules.

The system also comprises a processor, communicatively connected to the database and the digital drug library. The processor is configured to transmit one of the one or more disease model along with a set of drugs from the digital drug library to a scheduler. The set of drugs are selected from the digital drug library based on a predefined cost function. The scheduler distributes one or more of the plurality of digital drug capsules with the one or more disease models to one or more computing devices. The scheduler is connected to the one or more computing devices through a network. The processing unit receives an output comprising the effect of the set of drugs on the disease model from the scheduler, wherein the scheduler transmits the output to the processor by combining matching results from the one or more computing devices. The processing unit also analyzes the output to obtain the therapeutic solution in context of said disease.

In an embodiment of the present disclosure, the network is a cloud based network.

In another embodiment of the present disclosure, the one or more computing devices test effect of at least one of the set of drugs from the digital drug library to analyze the efficacy of the set of drugs on disease model based on the predefined cost function.

In another embodiment of the present disclosure, the one or more unit models comprise assimilation of information. The information is at least one selected from pathways or networks or biomarkers. The pathways are selected from a group comprising signaling pathway, metabolic pathway, apoptotic signaling pathway and signal transduction pathway. The networks are selected from a group comprising genomic networks, and protein networks; and the biomarkers are specific for the unit model.

In yet another embodiment of the present disclosure, the at least one information is selected from a group comprising biological information, therapeutic information, pathological information, computational information, information on mutation, information pertaining to kinetic rate laws and information pertaining to kinetic rate parameters or any combination thereof.

In still another embodiment of the present disclosure, the parameters are selected from at least one of biological pathway, biological network and biomarker.

In still another embodiment of the present disclosure, the biomarkers are selected from a group comprising proteins, metabolites, nucleic acids, ions, nutrients, hormones, lipids, transporters, receptors and enzymes or any combination thereof.

In still another embodiment of the present disclosure, the cell system model comprises cell selected from a group comprising but not limiting to white blood cells, dendritic cell, B Lymphocyte, Helper T Lymphocytes, Cytotoxic T Lymphocytes, Mast cell, Beta-Pancreatic cell, Cardiomyocyte, E. Coli, Endothelial Cell, Fibroblast, Adipocyte, Hepatocyte, Keratinocyte, Macrophage, Melanocyte, Mycobacterium Tuberculosis, Neutrophil, Osteoblast, Osteoclast, Skeletal Muscle, Tumor Cell, Epithelial cells, Plasma cells, Natural killer cells, other inflammatory related cells and any other human cell system or cell lines or any combination thereof.

In still another embodiment of the present disclosure, the digital drug capsule comprises at least one of a specific drug, small molecule, biomolecule, small inhibitory molecule or ligand or a combination thereof; and containing information selected from a group comprising mechanism of action (MOA) of the drug, pharmacological properties of the drug, including IC50, Cmax, bioavailability, AUC, Tmax and half-life, physical properties of the drug, including compound structure, molecular formula and molecular weight, pharmaceutical formulation information of the compounds within the drug, information pertaining to approved or safe dosing range of the drug, therapeutic category to which the drug belongs, conditions for which the drug has been indicated, information pertaining to off-target effects, drug interactions and adverse events associated with the drug, manufacturer details specific for the drug, patent information specific to the drug and indication specific alignment information including trends observed for biomarkers, phenotypes and disease scores in experiments performed on patients, animal models and cell-line cultures, or any combination thereof.

In still another embodiment of the present disclosure, the digital drug library comprises at least one of a single target drug, a multi-target drug, pseudo-drug and hypothetical drug comprising action selected from a group comprising single target or multi-target or any combination thereof.

In still another embodiment of the present disclosure, the biological system comprises processes selected from a group comprising gene transcription, RNA translation, signaling pathway, metabolic pathway, antigen presentation, signal transduction pathway, gene over-expression, gene knock-down, gene knock out, gene inhibition, genomic network, protein network, cell cycle, whole cell simulation and cell growth or any combination thereof.

In still another embodiment of the present disclosure, the therapeutic solution is selected from a group comprising drug, combination of drug or targets, combination of drug and target, combination of pseudo-drug and a target.

The present disclosure relates to a method for obtaining a therapeutic solution for treatment of a disease. The method comprises transmitting one of the one or more disease model along with a set of drugs from the digital drug library to a scheduler. The set of drugs are selected from the digital drug library based on a predefined cost function. The scheduler distributes one or more of the plurality of digital drug capsules with the one or more disease models to one or more computing devices. The scheduler is connected to the one or more computing devices through a network. The processing unit receives an output comprising the effect of the set of drugs on the disease model from the scheduler, wherein the scheduler transmits the output to the processor by combining matching results from the one or more computing devices. The processing unit also analyzes the output to obtain the therapeutic solution in context of said disease.

In an embodiment, the disease models facilitates simulation of the perturbed state of the biological system. The one or more disease model is obtained by configuring one or more unit models by collating information on parameters of biological system from plurality of information sources. The disease model further comprises one or more cell system models, wherein the one or more cell system models are obtained by integrating the one or more unit models. The one or more cell system models facilitate simulation of at least one of the biological system or homeostatic state of the biological system.

In another embodiment of the present disclosure, the digital drug library is formed by combining information on plurality of categories of digital drug capsules.

In yet another embodiment of the present disclosure, the biological system comprises processes selected from a group comprising gene transcription, RNA translation, signaling pathway, metabolic pathway, antigen presentation, signal transduction pathway, gene over-expression, gene knock-down, gene knock out, gene inhibition, genomic network, protein network, cell cycle, whole cell simulation and cell growth or any combination thereof.

In another embodiment of the present disclosure, the one or more unit models comprises assimilation of information. The information is at least one selected from pathways or networks or biomarkers. The pathways are selected from a group comprising signaling pathway, metabolic pathway, apoptotic signaling pathway and signal transduction pathway. The networks are selected from a group comprising genomic networks, and protein networks; and the biomarkers are specific for the unit model.

In still another embodiment of the present disclosure, the at least one information is selected from a group comprising biological information, therapeutic information, pathological information, computational information, information on mutation, information pertaining to kinetic rate laws and information pertaining to kinetic rate parameters or any combination thereof.

In still another embodiment of the present disclosure, the unit model comprises species and bio-molecular interactions across different parts of a cell selected from at least one of cytoplasm, nucleus, mitochondria, Endosome, Endoplasmic Reticulum, Golgi Apparatus, Inner mitochondrial membrane, Inner membrane space, Lysosome, Membrane, Melanosome, Rough Endoplasmic Reticulum, Mitochondrial Matrix, Accessory Compartment, and extracellular space.

In still another embodiment of the present disclosure, obtaining one or more cell system models comprises assimilation of information on plurality of cell lines and mutation profiles.

In still another embodiment of the present disclosure, the cell system model comprises cell selected from a group comprising white blood cells, dendritic cell, B Lymphocyte, Helper T Lymphocytes, Cytotoxic T Lymphocytes, Mast cell, Beta-Pancreatic cell, Cardiomyocyte, E. Coli, Endothelial Cell, Fibroblast, Adipocyte, Hepatocyte, Keratinocyte, Macrophage, Melanocyte, Mycobacterium Tuberculosis, Neutrophil, Osteoblast, Osteoclast, Skeletal Muscle, Tumor Cell, Epithelial cells, Plasma cells, Natural killer cells, other inflammatory related cells and any other human cell system or cell lines or any combination thereof.

In still another embodiment of the present disclosure, the method further comprises validation for optimization of model parameters and alignment of datasets.

In still another embodiment of the present disclosure, the model parameters are selected from at least one of biological pathway, biological network and biomarkers.

In still another embodiment of the present disclosure, changes in levels of the parameter are defined by specific trigger which represent perturbation in the homeostatic state, thereby inducing and representing the disease, wherein said perturbation leads to change in level of the biomarkers.

In still another embodiment of the present disclosure, the biomarkers are selected from a group comprising proteins, metabolites, nucleic acids, ions, nutrients, hormones, lipids, transporters, receptors and enzymes or any combination thereof.

In still another embodiment of the present disclosure, the perturbation lead to assertive statement which indicate the positive or negative adherence of the alignment and the validation dataset in the model, wherein the assertive statement is based on at least one of quality and quantity of the expected trend of a biomarker specific for the perturbed parameters within said model.

In still another embodiment of the present disclosure, the digital drug capsule comprises at least one of a specific drug, small molecule, biomolecule, small inhibitory molecule or ligand or a combination thereof; and containing information selected from a group comprising mechanism of action (MOA) of the drug, pharmacological properties of the drug, including IC50, Cmax, bioavailability, AUC, Tmax and half-life, physical properties of the drug, including compound structure, molecular formula and molecular weight, pharmaceutical formulation information of the compounds within the drug, information pertaining to approved or safe dosing range of the drug, therapeutic category to which the drug belongs, conditions for which the drug has been indicated, information pertaining to off-target effects, drug interactions and adverse events associated with the drug, manufacturer details specific for the drug, patent information specific to the drug and indication specific alignment information including trends observed for biomarkers, phenotypes and disease scores in experiments performed on patients, animal models and cell-line cultures, or any combination thereof.

In still another embodiment of the present disclosure, the digital drug library comprises at least one of a single target drug or a multi-target drug, pseudo-drug and hypothetical drug comprising novel mechanism of action selected from a group comprising single target or multi-target or any combination thereof.

In still another embodiment of the present disclosure, the matching comprises: simulating the perturbed state of the disease model with the information from the set of drugs; and

optimizing the dosage recursively by the drug efficacy characterization to achieve perfect alignment to trends observed in disease specific biomarker or phenotype or a combination thereof.

In still another embodiment of the present disclosure, the therapeutic solution is selected from a group comprising drug, combination of drug or targets, combination of drug and target, combination of pseudo-drug and a target.

In still another embodiment of the present disclosure, analyzing the output comprises analyzing effect of the therapeutic solution by clinical assessment selected from at least one of disease scores, synergy scores, phenotype scores and biomarker scores. In another embodiment, the analysis is done either manually or in an automated manner, preferably in an automated manner, to arrive at a therapeutic solution based on predefined cost functions.

In still another embodiment of the present disclosure, the perturbed state representing the disease is selected from at least one of autoimmune diseases, cancers, dermatological diseases, infectious diseases, cardiac conditions, pulmonary diseases, renal diseases, nerve diseases or neurological disorders, inflammatory disorders or any other human diseases.

In an embodiment, the present disclosure further relates to a non-transitory computer readable medium wherein operations are stored which are processed by at least one processing unit. This processing causes the system to perform the acts of transmitting one of one or more disease model along with a set of drugs from a digital drug library to a scheduler. The set of drugs are selected from the digital drug library based on a predefined cost function. The scheduler then distributes one or more of the plurality of digital drug capsules with the one or more disease models to one or more computing devices. The scheduler is connected to the one or more computing devices through a network.

The processing unit thereafter receives an output comprising the effect of the set of drugs on the diseased model from the scheduler. The scheduler transmits the output to the processor by combining matching results from the one or more computing devices. The processing unit further analyzes the output to obtain the therapeutic solution in context of said disease.

In another embodiment, the present disclosure relates to a computer program for obtaining a therapeutic solution for treatment of a disease. The computer program comprises code segment for transmitting one of one or more disease model along with a set of drugs from a digital drug library to a scheduler. The set of drugs are selected from the digital drug library based on a predefined cost function. The scheduler then distributes the one or more of the plurality of digital drug capsules with the one or more disease models to one or more computing devices. The scheduler is connected to the one or more computing devices through a network, code segment for receiving an output comprising the effect of the set of drugs on the diseased model from the scheduler. The scheduler transmits the output to the processor by combining matching results from the one or more computing devices, and code segment for analyzing the output to obtain the therapeutic solutions in context of said disease.

The present disclosure thus aims at arriving at a system which provides innovative therapies by overcoming the difficulties in drug discovery and deficiencies of the prior art to treat a host of varied disease conditions, such as rheumatoid arthritis, cancer, dermatological disorder and inflammatory disorders. Such a system involves a process of employing a translational research methodology towards designing therapeutic solutions to treat said disease condition(s). The said methodology involves the following steps:

(1) translation of data obtained from data mining in to an in-silico model, (2) creation of a digital drug library, (3) high-throughput simulation of a digital drug capsule in an in-silico disease model and (4) sorting and filtering of viable drugs to arrive at a therapy to treat said disease condition(s).

In the present disclosure, various aspects are described by taking certain conditions such as RA or cancer or autoimmune disease or dermatological disorder or inflammatory disorder or any combination thereof, as examples, and the scope of the instant disclosure should not be limiting to only these diseases or disorders or conditions. The scope of the present disclosure encompasses the efficient concept of drug delivery including single drugs or combination of drugs for any disease or disorder or condition known to a person skilled in the art, and for which efficient way of drug discovery is required.

The present disclosure therefore relates to an in-silico disease model, which is a highly comprehensive and complex virtual network of multiple interacting in-silico cell systems. Such disease models are made to represent a host of varied disease conditions including, but not limiting to, rheumatoid arthritis, cancer, autoimmune diseases, dermatological disorder and inflammatory disorders.

In an embodiment of the present disclosure, an in-silico model development process for any medical condition such as that for RA or cancer or for that matter, any other disease condition is based on assimilation of data from various sources wherein the sources shall vary from literature to in-house experiments, data from clinical trials etc.

In an embodiment, the models illustrate a biological system by defining the cells responsible for aggravating the disease condition(s) and how these cells communicate differently in a disease environment in comparison to a homeostatic [non-diseased] environment. Once the identity of the relevant cells is established, the developer needs to identify as to what stimuli trigger these cells in to a disease state.

In an embodiment, the basis of any disease is mainly attributed to an increase or decrease of a single or multiple disease stimuli resulting in an increase or decrease of endpoint biomarkers secreted from the different interacting cells. In order that a cell responds to these disease stimuli, several stimuli receptors connected to a complex network of signal transduction pathways are expressed exclusively on a disease cell.

In an embodiment, assimilation of data from literature and identification of disease specific cell receptors and their associated signaling/metabolic pathways is important. For the disease triggers or stimuli to actually have an impact, it is necessary that they affect the homeostatic phenotypes associated with the non-disease or control systems. Identification of disease affected phenotypes and the associated change in different end-point cell biomarkers using an efficient data mining technique illustrates a disease. These disease conditions would have interacting cells and every cell would have responsible signal transduction pathways involving proteins, metabolites, ions and nucleic acids. Hence assimilation of data from the literature and identifying these relevant signal transduction networks with associated entities is of prime importance to develop a system.

In an embodiment, every signal transduction pathway would have a stimulus, also referred to as a ligand and a receptor protein which are stimuli specific. The signal received by a receptor is transmitted with the help of adaptor proteins. The adaptor proteins can communicate to different enzymes or proteins known as transcription factors to enhance or suppress the expression of certain biomarker genes. For development of an in-silico model all the above collected data would only help in identifying the relative positions of interacting entities and designing the complete network. However to simulate the network for dynamic behavior, data pertaining to kinetic rate parameters such as dissociation constants for ligand-receptor binding, rate constants for mass transfer, enzyme turn-over and efficiency values etc. is collated.

In an embodiment, if the model does not show the intended behavior. Hence, to test the model for alignment to an intended behavior, a large comprehensive set of alignment data is developed. This alignment dataset contains information from various literatures about different in-vivo and in-vitro experiments conducted on a disease animal model, a patient, a cell line co-culture, a single entity or a multiple entity perturbation on a cell line culture. The alignment dataset contains information pertaining to the experiment protocols and the observed results. An in-silico model trained and validated against such a large alignment dataset illustrates all the known behavior pertaining to the actual biological cell or disease system.

In an embodiment of the present disclosure, one of the aims of designing an in-silico disease model is to identify therapies to suppress or control the disease; hence it becomes important that the model also exhibits the known effects of a therapy. To achieve alignment for a therapy, data/information from the literature is assimilated. This information is categorized and comprehensive alignment dataset is developed to cover the experiment protocol, the triggers used and the published results of a drug's effect. These affect the level of target efficacy, end-point biomarkers and the phenotypes. For simulating a drug effectively on a model, data pertaining to the drug's pharmacological properties (such as and not limited to IC50, Cₘₐₓ, bioavailability, AUC, Tₘₐₓ and half-life), mechanism of action (MOA) covering all the known targets, information pertaining to dosing of the drug, the therapeutic category to which the drug belongs (such as and not limited to NSAIDS, DMARDs, Biologics, natural compounds etc.) and information pertaining to off-target effects and adverse events associated with the drug have to be searched and categorized. All this information regarding a drug is categorized and curated into a digital drug capsule and placed in to a digital drug library. The model that is perfectly aligned with all the information present in the digital drug library is used to identify and design new and better therapies to cure diseases including, but not limited to, rheumatoid arthritis, cancer, autoimmune diseases, dermatological disorder, inflammatory diseases and various diseases/disorders.

In one non limiting exemplary embodiment, the present disclosure relates to an in-silico rheumatoid arthritis (RA) model, cancer model and dermatological disorder model. The model has been designed to emulate the characteristics and phenotypic properties associated with the RA, cancer and dermatological disorder by responding to self-antibodies specific to a multiplicity of immunogens such as bacterial lipopolysaccharide, external antigenic stimuli, citrullinated peptides etc. The main aim of developing the system of the instant disclosure is to bring together, the information from all the research journals on immunology, molecular biology, cell biology, etc. that have been published over the years into a single unified virtual research platform. This virtual research platform is advantageous both with respect to time, research costs and at the same time to avoid failures pertaining to the benefit-risk ratio.

In an embodiment, scientific and technical terms as used herein connection with the present disclosure shall have the meanings as further described below:

Data mining: Data mining also referred to as scoping, is the process of extraction and assimilation of concept specific information from literature resources inclusive of online peer-reviewed journals, published texts and any other reviewed literature source.

Cloud computing system: Cloud computing is the use of computing resources (hardware and software) that are delivered as a service over a network.

High level language: A high level language is a biological programming language that enables digital execution of virtual biological experiments in a user environment designed with a strong abstraction, from intricate machine details.

In-silico model: An in-silico model is a virtual biological experimental platform designed to predict stimuli based biological reactions and functions.

Disease model: An in-silico disease model is a virtual biological experimental platform designed to predict disease trigger based biological reactions and functions.

Alignment datasets: Alignment dataset refers to the group of assimilated biological data used to train the response function of an in-silico model.

Autocrine: An autocrine relates to a substance secreted by a cell and acting on surface receptors of the same cell.

Paracrine: A paracrine relates to a substance secreted by a cell and acting on surface receptors of other cells.

In an embodiment, the in-silico disease model representing RA or cancer or autoimmune disease or dermatological disorder or inflammatory disorder or any combination thereof is a highly comprehensive, complex virtual network. This network is designed using data from various publications over the past many years, say, for illustrating purpose, in the range of 5 to 10 years. This is built on a backbone of a large number of mathematical equations representing interactions between a large number of biochemical entities. The in-silico model also boasts of an alignment of results from various different experiments published in high impact journals.

In another embodiment, the process of obtaining information from data mining and providing to an in-silico model involves (1) creation and validation of unit pathway models, (2) creation and validation of cell system models and (3) creation and validation of disease model representing RA or cancer or autoimmune disease or dermatological disorder or inflammatory disorder or any combination thereof.

In another embodiment, the disclosure relates to a method of assigning dynamism to an in-silico model, said method involving (1) establishing viable representations for interactions between proteins, ions, metabolites and nucleic acids, (2) defining kinetic rate parameters for interactions between proteins, ions, metabolites and nucleic acids and (3) defining kinetic rate equations for interactions between proteins, ions, metabolites and nucleic acids.

In another embodiment, the disclosure relates to a method of automated integration of in-silico models, which involves (1) integration of in-silico unit pathway models to create a cell system model and (2) integration of in-silico cell system models to create a homeostatic model which on perturbations simulate a disease model representing RA or cancer or autoimmune disease or dermatological disorder or inflammatory disorder or any combination thereof.

In another embodiment, the disclosure relates to a method of translating experimental alignment data to a digital alignment data set, which involves (1) creating digital alignment data sets for an in-silico unit pathway model, (2) creating digital alignment data sets for an in-silico cell system model and (3) creating digital alignment data sets for an in-silico disease model representing RA or cancer or autoimmune disease or dermatological disorder or inflammatory disorder or any combination thereof.

In another embodiment, the disclosure relates to a method of obtaining digital alignment and validation of an in-silico model of RA or cancer or autoimmune disease or dermatological disorder or inflammatory disorder or any combination thereof, which involves (1) optimizing the kinetic rate parameters to obtain digital alignment to the datasets and (2) high-throughput validation of the in-silico unit pathway model, in-silico cell system model and the in-silico disease model representing RA or cancer or autoimmune disease or dermatological disorder or inflammatory disorder or any combination thereof for alignment to the digital alignment data sets.

In an embodiment, the validation is a process to determine whether the given model is an accurate representation of the real system intended to study with the predictive model. In the validation process, the model is compared to actual system to calibrate the model and to determine the discrepancies between the model using validation datasets. This process is repeated until the acceptable model accuracy/predictability is reached.

In an embodiment of the present disclosure, the unit model, the cell system model and the disease models are validated with respective validation datasets. The unit models are validated with experimental data on biomarkers from perturbation on particular pathway and signaling. The cell system model are validated with data from cell line or cell culture based experiments where single or multi pathway/signaling are perturbed, and along with unit model validation datasets. The disease models, represents multi-cellular co-culture systems developed to represent a disease physiology/phenotype. Therefore, usually dataset from in-vivo animal models and human clinical trials are used to validate the model along with prospective validations from each of the cell system model.

In another embodiment, the disclosure relates to a method of employing a system for simultaneous validation of a large number of digital alignment data sets to in-silico model comprising an in-silico unit pathway model, an in-silico cell system model and an in-silico disease model representing RA or cancer or autoimmune disease or dermatological disorder or inflammatory disorder or any combination thereof over a distributed network.

In another embodiment, the disclosure relates to methods of computing and reporting the validation of an in-silico model comprising in-silico unit pathway model, an in-silico cell system model and an in-silico disease model representing RA or cancer or autoimmune disease or dermatological disorder or inflammatory disorder or any combination thereof against a large number of digital alignment datasets.

In another embodiment, the disclosure relates to a method of creating a digital drug capsule and a digital drug library.

In another embodiment, the disclosure relates to a method of automated high-throughput simulation of:

(1) “c/n” different dosages of individual digital drug capsule information in the in-silico disease model representing RA or cancer or autoimmune disease or dermatological disorder or inflammatory disorder or any combination thereof, where “c” represents the approved therapeutic dose for the drug and “n” is any number greater than 0; and
(2) x-degree combination (where x is any number greater than 0) of “c/n” different dosages of different individual drug capsule information in the disease model representing RA or cancer or autoimmune disease or dermatological disorder or inflammatory disorder or any combination thereof involving:
(2.1) Exhaustive “x-degree” combination of information from all “y” digital drug capsules present in the digital drug library; and
(2.2) Exhaustive “x-degree” combination of information from “y-m” digital drug capsules against information from “m” anchor digital drug capsules present in the digital drug library.

In another embodiment, the disclosure relates to the process of digital curation, which involves (1) curation of an in-silico model, (2) curation of digital alignment data set and (3) curation of digital drug capsules.

In another embodiment, the disclosure relates to a method of computing and reporting of simulated drug data towards sorting and filtering based on selected sort or filter parameters.

In another embodiment, the disclosure relates to a method of automated sorting and filtering of simulated drug data involving sorting and filtering on the basis of (1) N-ACR scores, (2) synergy scores, (3) phenotype scores, (4) biological target compatibility, (5) PK/PD data and/or (6) compound structural properties.

In another embodiment, data mining forms the core process that shapes the definition and functionality of the in-silico model representing biological concepts, in this case, a disease model representing RA or cancer or autoimmune disease or dermatological disorder or inflammatory disorder or any combination thereof.

In another embodiment, the development of unit model, cell system model, disease model representing RA or cancer or autoimmune disease or dermatological disorder or inflammatory disorder or any combination thereof or co-culture model representing said condition, digital drug library and designing therapeutic solution is provided in the sections below. Although the development of these models and designing therapeutic solution in the below sections represent a specific disease condition, i.e., rheumatoid arthritis or cancer or autoimmune disease or dermatological disorder or inflammatory disorder or any combination thereof, the same should not be considered limiting to the said disease condition. In other words, similar procedure to arrive at the said models and therapeutic solution may be employed for treatment of other varied disease conditions. All such development and designing for all such disease conditions fall within the purview of the instant disclosure.

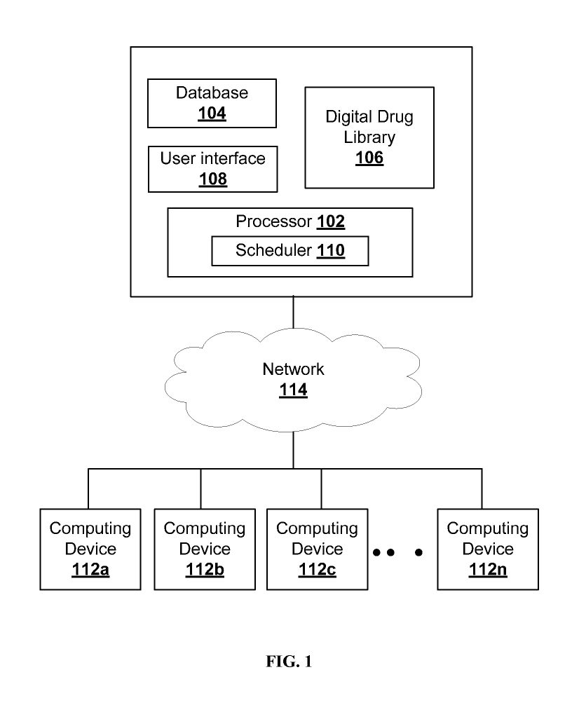

Referring now to FIG. 1, it illustrates a system for obtaining a therapeutic solution for treatment of a disease in accordance with an embodiment of the present disclosure. The system comprises one or more processors 102 (processor 102 for ease of understanding), connected to a database 104, a digital drug library 106 and a user interface 108. The processor 102 comprises a scheduler 110 configured within. The processor 102 is connected to one or more computing devices 112a, 112b, . . . , 112n (collectively referred to as 112) through a network 114. In an embodiment, the network 114 is a cloud based network. In another embodiment, the network 114 can be a wired network or a wireless network, including, but is not limiting to, Internet, Wi-Fi, Local Area Network (LAN), virtual private network etc. The database 104 comprises one or more unit models, one or more cell system models and one or more disease models. In an embodiment the database 104 can be configured with the processor 102. In an alternate embodiment, the database 104 can be located at a separate location from the processor 102.

In an embodiment, the processor 102 transmits one of the one or more disease models along with a set of drugs from the digital drug library 106 to the scheduler 110. The said set of drugs are selected from the digital drug library 106 based on a predefined cost function. Then, the scheduler 110 distributes one or more of the plurality of digital drug capsules with the one or more disease models to one or more computing devices 112 through the network 114. In a non-limiting embodiment, the network 114 is a distributed network which provides dynamic load balancing and transparent access to the resources available over the network 114. The network monitors the process for all possible errors in each client machine.

The scheduler 110 of the system is configured to split the job of processing the plurality of digital drug capsules with the one or more disease models into multiple jobs based on a set of commands representing one or more perturbed state of the model. The scheduler 110 distributes the logins on the basis including, but not limited to, job priority, number of pending jobs with the one or more computing devices 112, the client machine configuration and the number of available client machines. The scheduler 110 is additionally configured to check the progress of the job at each of the one or more computing devices 112.

The one or more computing devices 112 processes the one or more of digital drug capsules with the one or more disease models and provides an output accordingly to the scheduler 110. The output comprises the effect of the set of drugs on the diseased model. The scheduler 110 transmits the output to the processor 102 by combining matching results from the one or more computing devices 112. Finally the processor 102 analyzes the output to shortlist the therapeutic solutions in context of said disease or disorder or the combination thereof.

The described steps may be implemented as a method or a system using standard programming and/or engineering techniques to produce software, firmware, hardware, or any combination thereof. The described steps may be implemented as code maintained in a “non-transitory computer readable medium”, where a processing unit may read and execute the code from the computer readable medium. The processing unit is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

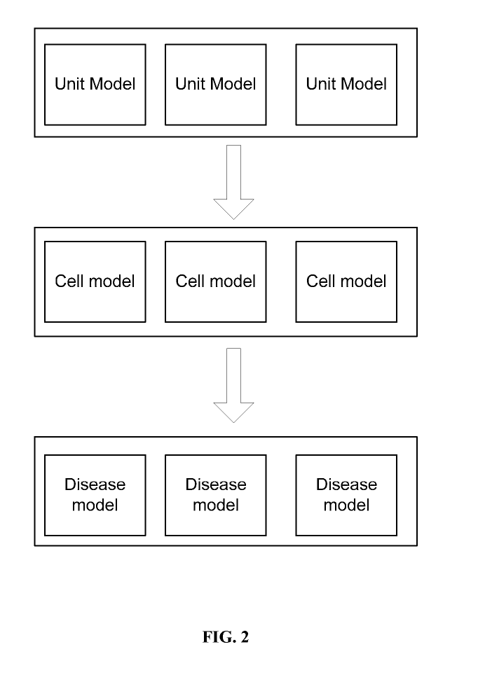

FIG. 2 illustrates development of disease model in accordance with an embodiment of the present disclosure. The development of disease model comprises firstly developing a unit model, followed by developing a cell model. Then, the cell model is used to develop the disease model. The steps are explained in detail below.

### Development of Unit Model:

The unit model is developed by assimilating data from plurality of information sources on a specific signaling/metabolic pathway, which is diligently used to create meaningful information. The alignment data gathered in parts is integrated logically and correlated and the flow of the events is charted out and the various bio-molecules, metabolites, ions in the signaling or metabolic network are positioned accordingly to develop a comprehensive pathway.

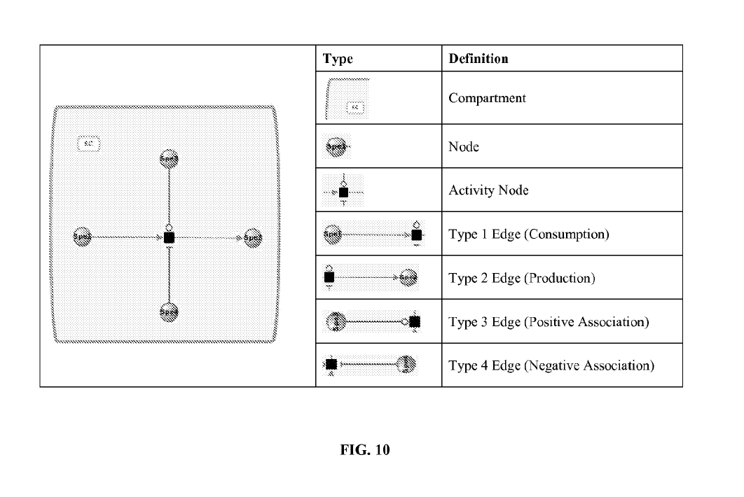

Every event in a pathway is represented as a static map, as illustrated in FIG. 10, showing input/output of the interaction, type of activity and the positive/negative influences on the interaction. The static information on a particular interaction is represented as a chemical reaction upon considering the stoichiometry of the inputs/outputs and each such reaction based on the type of their biological relationship is defined as specific kinetic rate law equations which will enable the user to represent and study the static interactions dynamically.

For instance, from a literature, the details on different cascades getting activated through a particular pathway is obtained, but, the detailed regulation of each of these cascades might not be covered in the same literature and these regulations will have to be studied separately from data present in various other literatures. The data so gathered in parts is integrated logically to develop a comprehensive pathway. Further, different signaling pathways can, in common, have one or more cascades getting activated. Hence, while developing a static model for a pathway which has common cascades activated as that of various other existing comprehensive models in the library, the common parts present in the existing models are re-used.

In an embodiment, the unit model developed are further used to develop multiple cell systems, with addition and deletion of bio-molecular interactions, events and gene expression specific to the new cell-type based on assimilated data/information.

In another embodiment, bio-molecules, metabolites, ions are represented as a separate entity known as species in the static unit model. Further, the molecules in each state are again defined as a separate species (e.g.: inactive and active forms of a protein are shown as two separate species).

In another embodiment, the various events involved in a pathway include bio-molecular interactions like binding of bio-molecules (e.g.: Ligand receptor binding), sequestration, phosphorylation, activation, inhibition, transport, translocation (unidirectional/bidirectional) of biomolecules, metabolites and ions from one part of the cell to another, transcription, translation, degradation etc. Every single event involved in a pathway is represented as a specific reaction while creating a static unit model.

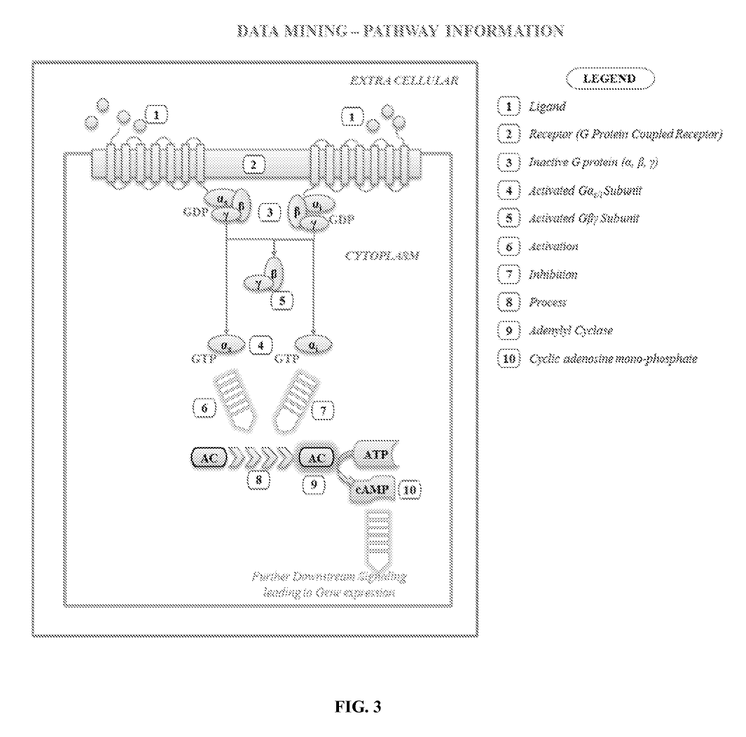

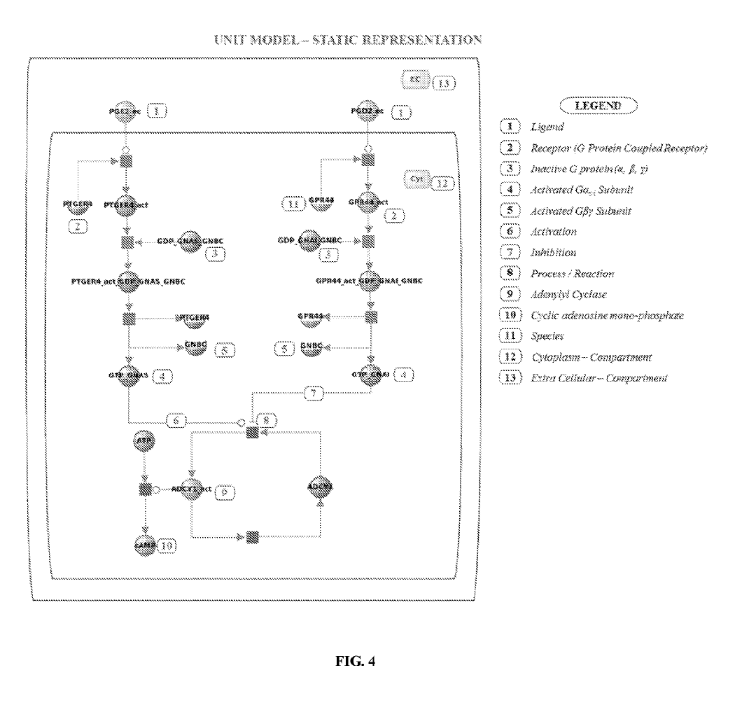

In another embodiment, it is to be noted that a pathway has species and bio-molecular interactions across different parts of a cell including cytoplasm, nucleus, mitochondria, extracellular space etc. These different parts of the cell are represented in a model as a separate category of entities named compartments. Species can also be transported across different compartments within a cell. All the entities in a model including species, reactions and compartments are named based on pre-defined standards as defined in Tables 3 and 4 below. The data assimilated from all the literatures are captured in the static unit model. The static unit model thus developed logically correlates with the datasets created. The data obtained from literature as shown in FIG. 3 is represented as a static unit model in FIG. 4.

In another embodiment, different species present in the static unit model are assigned with specific concentration values based on the data extracted from the literatures.

In another embodiment, every event in a pathway is represented as a reaction and each reaction is defined by specific kinetic rate law equations. Different equations defined for reactions include those based on Mass-Action Kinetics (reversible/irreversible), Simple Michaelis Menten equations, First-Order Transport or a modified form of these (Refer Table 1). Table 2 further also describes the different kinetic rate law equations defined for specific reactions of Table 1.

In another embodiment, the equation selected and defined in the reactions, is based on the type of biological events and thereby aligns with physiological outcomes (for example, as described with FIG. 10).

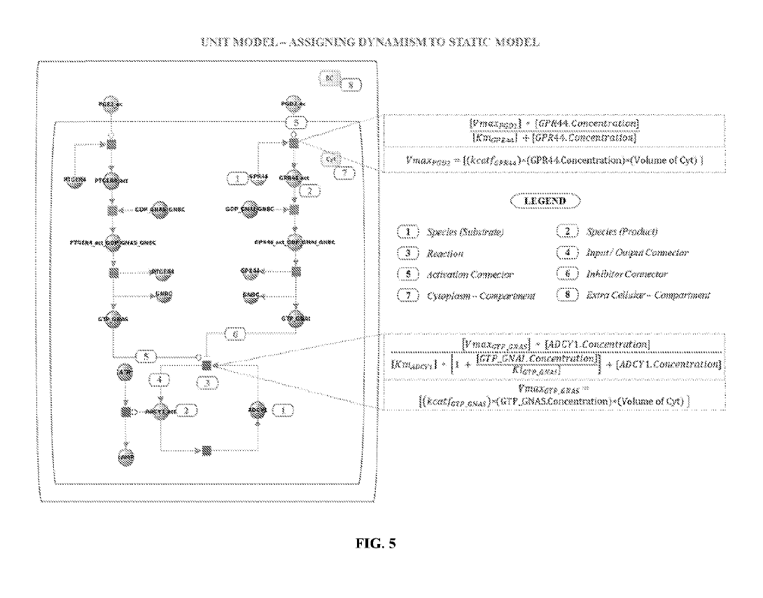

In another embodiment, the alignment is created either manually or through automated processes which define equations based on the biological interactions defined according to the pre-defined standard as defined in Tables 3 and 4 nomenclatures for reactions. FIG. 5 describes the definition of equations to reactions in a static unit model.

Table 1: Describes the various biological events and their respective equation types.

| Sl No. | Reaction Type | Equations |
|---|---|---|
| 1 | Acetylation | Simple Michaelis Menten |
| 2 | Activation | Simple Michaelis Menten |
| 3 | Addition | Irreversible Mass Action/Simple |
| | | Michaelis Menten |
| 4 | Adenosylation | Simple Michaelis Menten |
| 5 | Adenylation | Simple Michaelis Menten |
| 6 | Amination | Simple Michaelis Menten |
| 7 | Aromatization | Simple Michaelis Menten |
| 8 | Auto-oxidation | Irreversible Mass Action |
| 9 | Autophosphorylation | Simple Michaelis Menten |
| 10 | Binding | Reversible Mass Action |
| 11 | Carboxylation | Simple Michaelis Menten |
| 12 | Cleavage | Simple Michaelis Menten |
| 13 | Condensation | Simple Michaelis Menten |
| 14 | Constitutive | Simple Michaelis Menten |
| 15 | Cyclization | Simple Michaelis Menten |
| 16 | Damage | Simple Michaelis Menten |
| 17 | Deesterification | Simple Michaelis Menten |
| 18 | Deacetylation | Simple Michaelis Menten |
| 19 | Deamination | Simple Michaelis Menten |
| 20 | Decarboxylation | Simple Michaelis Menten |
| 21 | Degradation | Simple Michaelis Menten/ |
| | | Irreversible Mass Action |
| 22 | Dehydration | Simple Michaelis Menten |
| 23 | Deoligomerization | Simple Michaelis Menten |
| 24 | Deprenylation | Simple Michaelis Menten |
| 25 | Dephosphorylation | Simple Michaelis Menten |
| 26 | Depolymerisation | Simple Michaelis Menten |
| 27 | De-ubiquitination | Simple Michaelis Menten |
| 28 | Dimerization | Simple Michaelis Menten |
| 29 | Distribution | Simple Michaelis Menten |
| 30 | Dissociation | Irreversible Mass Action |
| 31 | Esterfication | Simple Michaelis Menten |
| 32 | Exchange | Simple Michaelis Menten |
| 33 | Facilitated transport | Simple Michaelis Menten |
| 34 | Folding | Simple Michaelis Menten |
| 35 | Formylation/ | Simple Michaelis Menten |
| | Transformylation | |
| 36 | Formation | Simple Michaelis Menten/ |
| | | Irreversible Mass Action |
| 37 | Fragmentation | Simple Michaelis Menten |
| 38 | Galactosylation | Simple Michaelis Menten |
| 39 | Glucosylation | Simple Michaelis Menten |
| 40 | Hydration | Simple Michaelis Menten |
| 41 | Hydrogen abstraction | Irreversible Mass Action |
| 42 | Hydrolysis | Simple Michaelis Menten |
| 43 | Hydroxylation | Simple Michaelis Menten |
| 44 | Inactivation | Simple Michaelis Menten |
| 45 | Inhibition | Simple Michaelis Menten |
| 46 | Isomerisation | Simple Michaelis Menten |
| 47 | Ligand Receptor Binding | Simple Michaelis Menten |
| 48 | Ligation | Simple Michaelis Menten |
| 49 | Lysis | Simple Michaelis Menten |
| 50 | Methylation | Simple Michaelis Menten |
| 51 | Nitration | Irreversible Mass Action |
| 52 | Oligomerization | Simple Michaelis Menten |
| 53 | Oxidation | Simple Michaelis Menten/ |
| | | Irreversible Mass Action |
| 54 | Phosphorylation | Simple Michaelis Menten |
| 55 | Polymerisation | Simple Michaelis Menten |
| 56 | Post Translational | Irreversible Mass Action |
| | Modifications | |
| 57 | Prenylation/Iso-prenylation | Simple Michaelis Menten |
| 58 | Recycling | Irreversible Mass Action/ |
| | | Reversible Mass Action |
| 59 | Redox Reaction | Reversible Mass Action/ |
| | | Simple Michaelis Menten |
| 60 | Reduction | Simple Michaelis Menten/ |
| | | Irreversible Mass Action |
| 61 | Regeneration | Simple Michaelis Menten |
| 62 | Release | Irreversible Mass Action |
| 63 | Repair | Simple Michaelis Menten |
| 64 | Replication | Simple Michaelis Menten |
| 65 | Source | Reversible Mass Action (Kf = Kr) |
| 66 | Splicing | Simple Michaelis Menten |
| 67 | Synthesis | Simple Michaelis Menten |
| 68 | Tetramerization | Simple Michaelis Menten |
| 69 | Transacylation | Simple Michaelis Menten |
| 70 | Transaldolation | Simple Michaelis Menten |
| 71 | Transamination | Simple Michaelis Menten |
| 72 | Transcription | Simple Michaelis Menten |
| 73 | Transketolation | Simple Michaelis Menten |
| 74 | Translation | Simple Michaelis Menten |
| 75 | Translocation | First Order Transport |
| 76 | Transfer | Irreversible Mass Action/Simple |
| | | Michaelis Menten |
| 77 | Transport | Irreversible First Order Transport |
| 78 | Transulfuration | Simple Michaelis Menten |
| 79 | Trimerization | Simple Michaelis Menten |
| 80 | Truncation | Simple Michaelis Menten |
| 81 | Ubiquitination | Simple Michaelis Menten |

Table 2: Describes the different kinetic rate law equations defined for specific reactions.

| Sl | Reaction | | |
|---|---|---|---|
| No. | Names | Nature | Equation |
| 1 | Mass Action | Reversible | ((Kf*S.Concentration) − (Kr*P.Concentration))*Volume |
| 2 | Mass Action | Irreversible | (Kf*S.Concentration)*Volume |
| 3 | First-Order | Reversible | (Kf*S.Concentration) − (Kr*P.Concentration) |
| | Transport | | |
| 4 | First-Order | Irreversible | Kf*S.Concentration |
| | Transport | | |
| 5 | Uni-uni SMM | Reversible | (((Vf_E*Km_P)*S.Concentration) − |
| | | | ((Vr_E*Km_S)*P.Concentration))/(((Km_S*P. |
| | | | Concentration) + (Km_P*S.Concentration)) + (Km_S*Km_P)) |
| 6 | Simple | Irreversible | (Vf_E*S.Concentration)/(Km_S + S.Concentration) |
| | Michalis- | | |
| | Menten SMM | | |
| 7 | Simplified | Irreversible | (Vf_E*(S1.Concentration/Km_S1))/(1 + (S1.Concentration/ |
| | SMM Single | | Km_S1)) |
| | Substrate | | |
| 8 | SMM Bi | Irreversible | ((((Vf_E*S1.Concentration)*S2.Concentration)* . . .)* |
| | Substrate,Tri | | Sn.Concentration)/((Km_S1 + S1.Concentration)*(Km_ |
| | substrate and | | S2 + S2.Concentration)* . . . *(Km_Sn + Sn.Concentration)) |
| | so on | | |
| 9 | SMM | Irreversible | (Vf_E*((S1.Concentration/Km_S1)*(S2.Concentration/ |
| | Simplified Bi | | Km_S2))* . . . *(Sn.Concentration/Km_Sn))/((1 + (S1. |
| | Substrate, Tri | | Concentration/Km_S1))*(1 + (S2.Concentration/Km_ |
| | Substrate and | | S2))* . . . *(1 + (Sn.Concentration/Km_Sn))) |
| | so on | | |
| 10 | Ordered uni-bi | Reversible | (((Vf_E*Vr_E)*S1.Concentration) − |
| | | | ((((Vf_E*Vr_E)*P1.Concentration)*P2.Concentration)/ |
| | | | Keq))/((((((Vr_E*Km_S1) + (Vr_E*S1.Concentration)) + |
| | | | (((Vf_E*Km_P2)*P1.Concentration)/Keq)) + (((Vf_E* |
| | | | Km_P1)*P2.Concentration)/Keq)) + (((Vr_E*S1. |
| | | | Concentration)*P1.Concentration)/Kd_P1)) + (((Vf_E*P1. |
| | | | Concentration)*P2.Concentration)/Keq)) |
| 11 | Ordered Bi Bi | Reversible | ((Vf_E*Vr_E)*((S1.Concentration*S2.Concentration) − |
| | | | ((P1.Concentration*P2.Concentration)/Keq)))/ |
| | | | ((((((((((((Vr_E*Kd_S1)*Km_S2) + ((Vr_E*Km_S2)*S1. |
| | | | Concentration)) + ((Vr_E*Km_S1)*S2.Concentration)) + |
| | | | (((Vf_E*Km_P2)*P1.Concentration)/Keq)) + (((Vf_E*Km_ |
| | | | P1)*P2.Concentration)/Keq)) + ((Vr_E*S1.Concentration)* |
| | | | S2.Concentration)) + ((((Vf_E*Km_P2)*S1.Concentration)* |
| | | | P1.Concentration)/(Keq*Kd_S1))) + (((Vf_E*P1. |
| | | | Concentration)*P2.Concentration)/Keq)) + ((((Vr_E*Km_ |
| | | | S1)*S2.Concentration)*P2.Concentration)/Kd_P2)) + |
| | | | ((((Vr_E*S1.Concentration)*S2.Concentration)*P1. |
| | | | Concentration)/Kd_P1)) + ((((Vf_E*S2.Concentration)* |
| | | | P1.Concentration)*P2.Concentration)/(Kd_S2*Keq))) |
| 12 | Ordered Ter- | Reversible | ((Vf_E*Vr_E)*(((S1.Concentration*S2.Concentration)* |
| | Bi/Bi-Ter | | S3.Concentration) − ((P1.Concentration*P2.Concentration)/ |
| | | | Keq)))/((((((((((((((((((((Vr_E*Kd_S1)*Kd_S2)*Km_S3) + |
| | | | (((Vr_E*Kd_S2)*Km_S3)*S1.Concentration)) + (((Vr_E* |
| | | | Kd_S1)*Km_S2)*S3.Concentration)) + (((Vr_E*Km_S3)* |
| | | | S1.Concentration)*S2.Concentration)) + (((Vr_E*Km_S2)* |
| | | | S1.Concentration)*S3.Concentration)) + (((Vr_E*Km_S1)* |
| | | | S2.Concentration)*S3.Concentration)) + (((Vr_E*S1. |
| | | | Concentration)*S2.Concentration)*S3.Concentration)) + |
| | | | (((Vf_E*Km_P2)*P1.Concentration)/Keq)) + (((Vf_E* |
| | | | Km_P1)*P2.Concentration)/Keq)) + (((Vf_E*P1. |
| | | | Concentration)*P2.Concentration)/Keq)) + ((((Vf_E*Km_ |
| | | | P2)*S1.Concentration)*P1.Concentration)/(Kd_S1*Keq))) + |
| | | | (((((Vf_E*Km_P2)*S1.Concentration)*S2.Concentration)* |
| | | | P1.Concentration)/((Kd_S1*Kd_S2)*Keq))) + ((((((Vf_E* |
| | | | Km_P2)*S1.Concentration)*S2.Concentration)*S3. |
| | | | Concentration)*P1.Concentration)/(((Kd_S1*Kd_S2)* |
| | | | Kd_S3)*Keq))) + (((((Vr_E*Kd_S1)*Km_S2)*S3. |
| | | | Concentration)*P2.Concentration)/Kd_P2)) + (((((Vr_E* |
| | | | Km_S1)*S2.Concentration)*S3.Concentration)*P2. |
| | | | Concentration)/Kd_P2)) + ((((((Vr_E*Kd_S1)*Km_S2)*S3. |
| | | | Concentration)*P1.Concentration)*P2.Concentration)/(Kd_ |
| | | | P1*Kd_P2))) + ((((((Vr_E*Km_S1)*Kd_S3)*S2. |
| | | | Concentration)*P1.Concentration)*P2.Concentration)/(Kd_ |
| | | | P1*Kd_P2))) + ((((((Vr_E*Km_S1)*S2.Concentration)*S3. |
| | | | Concentration)*P1.Concentration)*P2.Concentration)/ |
| | | | (Kd_P1*Kd_P2)) |
| 13 | Ordered bi-bi | Irreversible | ((Vf_E*S1.Concentration)*S2.Concentration)/((((Kd_ |
| | or bi-ter | | S1*Km_S2) + (Km_S2*S1.Concentration)) + (Km_S1*S2. |
| | | | Concentration)) + (S1.Concentration*S2.Concentration)) |
| 14 | Ordered Ter- | Irreversible | (((Vf_E*S1.Concentration)*S2.Concentration)*S3. |
| | ter/Random | | Concentration)/(((((((((Kd_S1*Kd_S2)*Km_S3) + ((Kd_S2* |
| | A-B, ordered C | | Km_S3)*S1.Concentration)) + ((Kd_S1*Km_S3)*S2. |
| | | | Concentration)) + ((Kd_S1*Km_S2)*S3.Concentration)) + |
| | | | ((Km_S3*S1.Concentration)*S2.Concentration)) + ((Km_ |
| | | | S2*S1.Concentration)*S3.Concentration)) + ((Km_ |
| | | | S1*S2.Concentration)*S3.Concentration)) + ((S1. |
| | | | Concentration*S2.Concentration)*S3.Concentration)) |
| 15 | Random Bi Bi | Reversible | ((((Vf_E*S1.Concentration)*S2.Concentration)/((alpha* |
| | | | Kd_S1)*Kd_S2)) − |
| | | | (((Vr_E*P1.Concentration)*P2.Concentration)/((beta* |
| | | | Kd_P1)*Kd_P2)))/((((((((1 + (S1.Concentration/Kd_S1)) + |
| | | | (S2.Concentration/Kd_S2)) + (P1.Concentration/Kd_ |
| | | | P1)) + (P2.Concentration/Kd_P2)) + ((S1.Concentration* |
| | | | S2.Concentration)/((alpha*Kd_S1)*Kd_S2))) + ((P1. |
| | | | Concentration*P2.Concentration)/((beta*Kd_P1)*Kd_P2))) + |
| | | | ((S2.Concentration*P2.Concentration)/((gamma*Kd_S2)* |
| | | | Kd_P2))) + ((S1.Concentration*P1.Concentration)/ |
| | | | ((delta*Kd_S1)*Kd_P1))) |
| 16 | Random bi-bi | Irreversible | ((Vf_E*S1.Concentration)*S2.Concentration)/(((((a*Km_ |
| | or bi-ter | | S1)*Km_S2) + ((a*Km_S1)*S2.Concentration)) + ((a* |
| | | | Km_S2)*S1.Concentration)) + (S1.Concentration*S2. |
| | | | Concentration)) |
| 17 | Ping-pong bi- | Irreversible | (((Vf_E*S1.Concentration)*S2.Concentration)*S3. |
| | uni-uni-uni/bi- | | Concentration)/((((((Kd_S1*Km_S2)*S3.Concentration) + |
| | uni-uni-bi Ter- | | ((Km_S3*S1.Concentration)*S2.Concentration)) + ((Km_ |
| | Bi | | S2*S1.Concentration)*S3.Concentration)) + ((Km_S1* |
| | | | S1.Concentration)*S2.Concentration)) + ((S1. |
| | | | Concentration*S2.Concentration)*S3.Concentration)) |
| 18 | Ping-pong bi- | Irreversible | ((Vf_E*S1.Concentration)*S2.Concentration)/(((Km_S2* |
| | bi | | S1.Concentration) + (Km_S1*S2.Concentration)) + (S1. |
| | | | Concentration*S2.Concentration)) |
| 19 | Ping Pong Bi- | Reversible | ((Vf_E*Vr_E)*((S1.Concentration*S2.Concentration) − |
| | Bi | | ((P1.Concentration*P2.Concentration)/Keq)))/(((((((((Vr_ |
| | | | E*Km_S2)*S1.Concentration) + ((Vr_E*Km_S1)*S2. |
| | | | Concentration)) + (((Vf_E*Km_P2)*P1.Concentration)/ |
| | | | Keq)) + (((Vf_E*Km_P1)*P2.Concentration)/Keq)) + |
| | | | ((Vr_E*S1.Concentration)*S2.Concentration)) + ((((Vf_E* |
| | | | Km_P2)*S1.Concentration)*P1.Concentration)/(Keq* |
| | | | Kd_S1))) + (((Vf_E*P1.Concentration)*P2.Concentration)/ |
| | | | Keq)) + ((((Vr_E*Km_S1)*S2.Concentration)*P2. |
| | | | Concentration)/Kd_P2)) |
| 20 | Bi Uni Uni Bi | Reversible | ((Vf_E*Vr_E)*(((S1.Concentration*S2.Concentration)* |
| | Ping Pong Ter | | S3.Concentration) − |
| | Ter | | (((P1.Concentration*P2.Concentration)*P3.Concentration)/ |
| | | | Keq)))/((((((((((((((((((((((((Vr_E*Kd_S1)*Km_S2)* |
| | | | S3.Concentration) + (((Vr_E*Km_S3)*S1.Concentration)* |
| | | | S2.Concentration)) + (((Vr_E*Km_S2)*S1.Concentration)* |
| | | | S3.Concentration)) + (((Vr_E*Km_S1)*S2.Concentration)* |
| | | | S3.Concentration)) + (((Vr_E*S1.Concentration)*S2. |
| | | | Concentration)*S3.Concentration)) + ((((Vf_E*Kd_P3)* |
| | | | Km_P2)*P1.Concentration)/Keq)) + ((((Vf_E*Km_S1)* |
| | | | P1.Concentration)*P2.Concentration)/Keq)) + |
| | | | ((((Vf_E*Km_P2)*P1.Concentration)*P3.Concentration)/ |
| | | | Keq)) + ((((Vf_E*Km_P1)*P2.Concentration)*P3. |
| | | | Concentration)/Keq)) + ((((Vf_E*P1.Concentration)*P2. |
| | | | Concentration)*P3.Concentration)/Keq)) + (((((Vf_E*Km_ |
| | | | P2)*Kd_P3)*S1.Concentration)*P1.Concentration)/ |
| | | | (Kd_S1*Keq))) + (((((Vr_E*Kd_S1)*Km_S2)*S3. |
| | | | Concentration)*P3.Concentration)/Kd_P3)) + ((((((Vf_E* |
| | | | Km_P2)*Kd_P3)*S1.Concentration)*S2.Concentration)*P1. |
| | | | Concentration)/((Kd_S1*Kd_S2)*Keq))) + ((((((Vf_E* |
| | | | Kd_P1)*Km_P3)*S1.Concentration)*S2.Concentration)* |
| | | | P3.Concentration)/((Kd_S1*Kd_S2)*Keq))) + (((((Vr_ |
| | | | E*Km_S1)*S2.Concentration)*S3.Concentration)*P3. |
| | | | Concentration)/Kd_P3)) + (((((Vf_E*Km_P3)*S1. |
| | | | Concentration)*P1.Concentration)*P2.Concentration)/(Kd_ |
| | | | S1*Keq))) + ((((((Vr_E*Km_ S1)*Kd_S1)*S2. |
| | | | Concentration)*P2.Concentration)*P3.Concentration)/(Kd_ |
| | | | P2*Kd_P3))) + ((((((Vr_E*Kd_S1)*Km_S2)*S3. |
| | | | Concentration)*P2.Concentration)*P3.Concentration)/(Kd_ |
| | | | P2*Kd_P3))) + (((((((Vf_E*Kd_P1)*Km_P3)*S1. |
| | | | Concentration)*S2.Concentration)*S3.Concentration)*P2. |
| | | | Concentration)/(((Kd_S1*Kd_S2)*Kd_S3)*Keq))) + ((((((Vf_ |
| | | | E*Km_P3)*S1.Concentration)*S2.Concentration)*P1. |
| | | | Concentration)*P2.Concentration)/((Kd_S1*Kd_S2)* |
| | | | Keq))) + ((((((Vr_E*Km_S1)*S2.Concentration)*S3. |
| | | | Concentration)*P2.Concentration)*P3.Concentration)/(Kd_ |
| | | | P2*Kd_P3))) + (((((((Vr_E*Km_S1)*Kd_S3)*S2. |
| | | | Concentration)*P1.Concentration)*P2.Concentration)*P3. |
| | | | Concentration)/((Kd_P1*Kd_P2)*Kd_P3))) |
| 21 | Bi Uni Uni | Reversible | ((Vf_E*Vr_E)*(((S1.Concentration*S2.Concentration) |
| | Uni Ping Pong | | *S3.Concentration) − |
| | | | ((P1.Concentration*P2.Concentration)/Keq)))/ |
| | | | ((((((((((((((((Vr_E*Kd_S1)*Km_S2)*S3.Concentration) + |
| | | | (((Vr_E*Km_S3)*S1.Concentration)*S2.Concentration)) + |
| | | | (((Vr_E*Km_S2)*S1.Concentration)*S3.Concentration)) + |
| | | | (((Vr_E*Km_S1)*S2.Concentration)*S3.Concentration)) + |
| | | | (((Vr_E*S1.Concentration)*S2.Concentration)*S3. |
| | | | Concentration)) + ((((Vf_E*Km_P2)*S1.Concentration)*P1. |
| | | | Concentration)/(Kd_S1*Keq))) + (((((Vf_E*Km_P2)* |
| | | | S1.Concentration)*S2.Concentration)*P1.Concentration)/ |
| | | | ((Kd_S1*Kd_S2)*Keq))) + (((Vf_E*Km_P2)*P1. |
| | | | Concentration)/Keq)) + (((Vf_E*Km_P1)*P2. |
| | | | Concentration)/Keq)) + (((Vf_E*P1.Concentration)*P2. |
| | | | Concentration)/Keq)) + (((((Vr_E*Km_S1)*Kd_S3)*S2. |
| | | | Concentration)*P2.Concentration)/Kd_P2)) + (((((Vr_E* |
| | | | Kd_S1)*Km_S2)*S3.Concentration)*P2.Concentration)/ |
| | | | Kd_P2)) + ((((((Vr_E*Km_S1)*Kd_S3)*S2.Concentration)* |
| | | | P1.Concentration)*P2.Concentration)/(Kd_P1*Kd_P2))) + |
| | | | (((((Vr_E*Km_S1)*S2.Concentration)*S3.Concentration)* |
| | | | P2.Concentration)/Kd_P2)) |

TABLE 3
Standards for naming virtual cell systems

| Cell Type | Abbreviation |
|---|---|
| B Lymphocyte | BCELL |
| Beta-Pancreatic cell | BPAN |
| Cardiomyocyte | CMYO |
| E. Coli | ECOLI |
| Endothelial Cell | ENC |
| Fibroblast | FB |
| Adipocyte | FC |
| Hepatocyte | HEP |
| Keratinocyte | KER |
| Macrophage | MCP |
| Melanocyte | MEL |
| Mycobacterium | MTB |
| Tuberculosis | |
| Neutrophil | NPL |
| Osteoblast | OSB |
| Osteoclast | OSC |
| Skeletal Muscle | SM |
| Tumor Cell | TC |
| T Lymphocyte | TCELL |

TABLE 4
Standards for naming compartments in the virtual cell systems

| Compartment Name | Abbreviation |
|---|---|
| Cellular-(Cytoplasm) | Cyt |
| Dendritic Melanosome | D_Msome |
| Extracellular | EC |
| Endosome | Endo |
| Endoplasmic Reticulum | ER |
| Golgi Apparatus | GA |
| Inner mitochondrial | IMM |
| membrane | |
| Inner membrane space | IMS |
| Lysosome | Ly |
| Membrane | Memb |
| Melanosome | Msome |
| Mitochondria | Mt |
| Nucleus | N |
| Rough Endoplasmic | RER |
| Reticulum | |
| Mitochondrial Matrix | MTM |
| Accessory Compartment | ACC |

### Species Nomenclature Standards:

<cell type>_<prefix>_<species_name>_<suffix>
<cell type> represents the name of the virtual cell system (refer tables above)
<prefix> any pre-defined prefix (for details, refer table 5 below)

TABLE 5

| | |
|---|---|
| Soluble (s) | <cell |
| | type>_s_<species_name>_<suffix> |
| Membrane (m) | <cell |
| | type>_m_<species_name>_<suffix> |
| Pro/Pre Form (pro) | <cell |
| | type>_pro_<species_name>_<suffix> |
| Globular (glb) | <cell |
| | type>_glb_<species_name>_<suffix> |
| Full Length (fl) | <cell |
| | type>_fl_<species_name>_<suffix> |

<species_name> can be NCBI Gene name or common name.
<suffix> any pre-defined suffix (for details, refer table 6 below)

TABLE 6

| Based on the compartment type | |
|---|---|
| Cytoplasm (Cyt) | <cell |
| | type>_<prefix>_<species_name>_<other |
| | suffix> |
| Nucleus (N) | <cell |
| | type>_<prefix>_<species_name>_<other |
| | suffix>_n |
| Mitochondria (Mt) | <cell |
| | type>_<prefix>_<species_name>_<other |
| | suffix>_mt |
| Extracellular (EC) | <cell |
| | type>_<prefix>_<species_name>_<other |
| | suffix>_ec |
| Endoplasmic | <cell |
| Reticulum (ER) | type>_<prefix>_<species_name>_<other |
| | suffix>_er |
| Based_on_species_state_of_activation_(active/inactive) | |
| Activated | <cell type>_<prefix>_<species |
| | name>_act_<other suffix> |
| Inactivated | <cell type>_<prefix>_<species |
| | name>_inact_<other suffix> |

Reaction nomenclature Standards:
<Cell Type>_<Substrate name(s)>_<reaction type>
<cell type> represents the name of the virtual cell system (refer tables above).
<Substrate name(s)> names of the substrate involved in the reaction.
<reaction type>, few scenarios mentioned in table 7 below:

TABLE 7

| Reaction Type | Abbreviation |
|---|---|
| Acetylation | AC |
| Activation | Actn |
| Binding | Bd |
| Carboxylation | Cb |
| Dimerization | Di |
| Exchange | Exg |
| Facilitated transport | Ftr |
| Transfer | Tf |
| Translation | Trl |
| Translocation | Tro |
| Transport | Tr |

### Parameter Nomenclature Standards:

TABLE 8

| | |
|---|---|
| Forward rate constant | Kf |
| Reverse rate constant | Kr |
| SMM - Forward Vmax | Vf_<Enzyme/Activator name> |
| SMM - Reverse Vmax | Vr_<Enzyme/Activator name> |
| Forward reaction (kcat) | kcatf_<Enzyme/Activator name> |
| Reverse reaction (kcat) | kcatr_<Enzyme/Activator name> |
| MM constant (Km) | Km_<Substrate> |
| Inhibition Constant | Ki_<Inhibitor name> |
| Activation Constant | Ka_<Activator name> |

In another embodiment, the values for different kinetic parameters are assigned based on the data extracted from literatures. In case of inconsistent or unknown enzyme kinetic parameters, optimization strategy is employed to attain physiological outcome.

In another embodiment, the pathway dynamics are simulated by interconnecting ordinary differential equations describing kinetic behavior of each species in the pathway.

In another embodiment, training the static unit model with alignment dataset is carried out for developing a model which validates or predicts the responses to perturbations given to the model similar to that of the natural physiological outcomes.

In another embodiment, values for the kinetic rate parameters for a reaction are defined and it is carried out for all the reactions in a model in such a way that: flux balances are maintained with the system reaching a steady state, and the model is sensitive enough for a wide range of input values.

In another embodiment, the unit model developed is robust as it does not reach saturation within a very small range of input values, which would make the model less sensitive to respond to different user-defined perturbations.

In another embodiment, a unit model can have multiple pathways or activators activated within the pathways or activators converging at different common points (reactions). Maintaining the contribution of each pathway or activator at a convergent point is crucial and this is carried out logically so as to attain proper alignment with the datasets created from assimilated data. Different tools are developed that aid in defining the parameter values for setting the desired percentage contributions from each activator or pathway towards a common convergent point.

In an embodiment, datasets for alignment and validations are represented in a high level language so as to facilitate its execution on the model. This includes assertive statements which indicate the positive or negative adherence of the alignment and validation datasets on the model. These assertive statements are based on both quality and quantity of the expected trend of the biomarker in focus which is usually based on assimilated data.

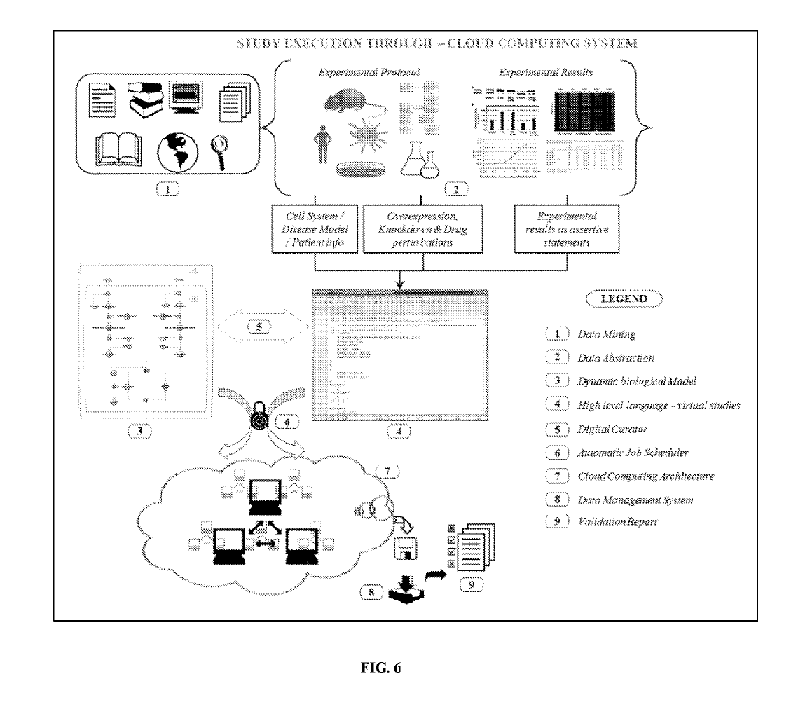

In another embodiment, validation of unit model is carried out by running iterative regression of the alignment and validation datasets represented in high level language either manually or through an automated high throughput system, preferably by cloud computing system. While testing the model by running iterative regression, informative reports are generated based on the assertive statements which aids in analysis of the results. The above described processes are depicted in FIG. 6.

In another embodiment, analysis of different perturbations like over-expressions, knock-down, knock out, inhibition etc. of different species or reactions before confirming the final parameter values is carried out manually or through different automated tools, preferably by the automated tools. The automated tools are as follows—(a) One that shows the effect of a user-defined perturbation on the model based on color-codes with the intensity of color changing based on the extent to which the species is affected due to the perturbation, and/or (b) One that highlights all the possible paths, such that a signal can flow from one point to the other with details on the shortest and longest path highlighted, when the two points (can be species, reactions etc.) in a model are given as inputs.

In an embodiment, the dynamic unit model developed elicits response to perturbations in a fashion similar to the way the natural biological system would respond.

In another embodiment, development of unit model undergoes a series of checks for ensuring its correctness at every stage. Testing for inherent errors in the model is carried out manually or by automated checks on the model or a combination thereof. Biological networks including flow of the pathway, various links and interactions present in the model, etc. are checked manually. Correctness of the protein function representations in the model including equations defined for depicting each reaction are also checked manually or by using automated scripts or a combination thereof.

In another embodiment, the unit model is checked to ensure the correctness of the protocols used for alignment and validation data-sets mentioned in high level language.

In another embodiment, the reports generated post running iterative regression of alignment and validation datasets represented in the high level language are based on the assertive statements mentioned in the high level language. Thus, a check is always carried out on the assertive statements for biomarkers and the trends defined in the unit model.

In another embodiment, the model is always checked for computational rigidness so as to ensure smooth simulation of the model in the simulator. Further, the model is also checked for adherence to pre-defined standards to ensure compatibility between two models during integration.

In another embodiment, the unit model is perturbed to different condition through a set of commands. The perturbations can be disease setting, overexpression, knock-down, addition of a drug or addition of a function. Apart from these, there are other set of commands to assert the anticipated output from the set of commands.

In another embodiment, set of executable commands are coded based on the assimilated data, which is executed on the model using the computational solver and the results are validated, which helps in developing predictive computational simulation

The computational solver is a simulation engine designed to solve biochemical equations built into the physiological models herein that are transformed mathematically to Ordinary Differential Equations (ODE), in which there is a single independent variable (t) and one or more dependent variables x, (t). Multiple techniques to solve single ODEs as well as system of ODEs are provided by way of the solver.

### Development of Cell System Model:

The cell system model is developed by integrating the one or more developed unit models. Development of a cell type model starts with thorough data mining by understanding cell physiology and functions, key phenotype markers, different stimuli that triggers the cell system, key unit pathways involved in the cell physiology, crosstalk between different unit pathways and details of the outputs of the cell that acts in autocrine or paracrine fashion. To emulate the responses of the cell-type to a specific disease, deciding the right set of triggers specific to the disease based on data assimilated from literatures and defining those in the model becomes crucial. This is carried out by either increasing or decreasing single or multiple stimuli leading to a variation (increase or decrease) in the levels of the bio-markers. The in-silico cell system developed is capable of responding to a multiplicity of disease stimuli.

In an embodiment, the in-silico cell system is developed for white blood cells, bone cells, synovial fibroblast, endothelilia cells and dendritic cells, osteoblast, osteoclast, Keratinocytes, Melanocytes and Langerhans cells and also to other cells involved in inflammation, cells involved in autoimmune disease, and the cells that turn cancerous.

In an embodiment, a cell system model integrates variety of cell signaling pathways which are represented by different unit models to represent intended physiologic phenotypes or functions of the cell. These different pathways converge at different levels of signaling and each of those convergence points will have varied signaling contribution from different pathways.

In an embodiment, thoroughly validated cell-specific unit models which have passed through all the inherent error checks are integrated together to develop a comprehensive cell-system.

In another embodiment, integration of unit models or group of unit models is carried out either manually or by using an automated integration management system, preferably by automated system which automatically identifies the similarity and differences between the two models (intermediate cell type model and unit model to be integrated to it) and flags the anomalies for required action.

In another embodiment, integration of unit model to develop a cell type is carried out by the following methods: (a) Flat method, which involves integrating all pathways present in the same compartment. The model developed using this method appears to be more complex in figuring out the common components between pathways including bio-molecules, metabolites, ions and their interactions, gene expressions etc.; (b) Hierarchy level integration method, which involves integration of each pathway in a sub-compartment which is present in the common compartment. Unlike flat method, the components specific to the unit pathways are present in the sub-compartments, whereas common components between different pathways are present in the common compartment which makes it easy for the user to understand the complex model interactions.

In another embodiment, hierarchy level integration method is carried out to integrate unit models that are developed for specific cell type, which is carried out by the following ways: (a) sequentially integrating the unit models one by one to create the intermediate virtual cell-type and continuing integration of other unit models one by one; and (b) sequentially integrating a group of unit models with the total number of models divided into different groups based on similar functionality, and integrating each group to already existing intermediate virtual cell-type model.

In another embodiment, based on literature, post integrating, the autocrine modules for specific biomarkers expressed in the model is well defined in order to complete feedback regulations.

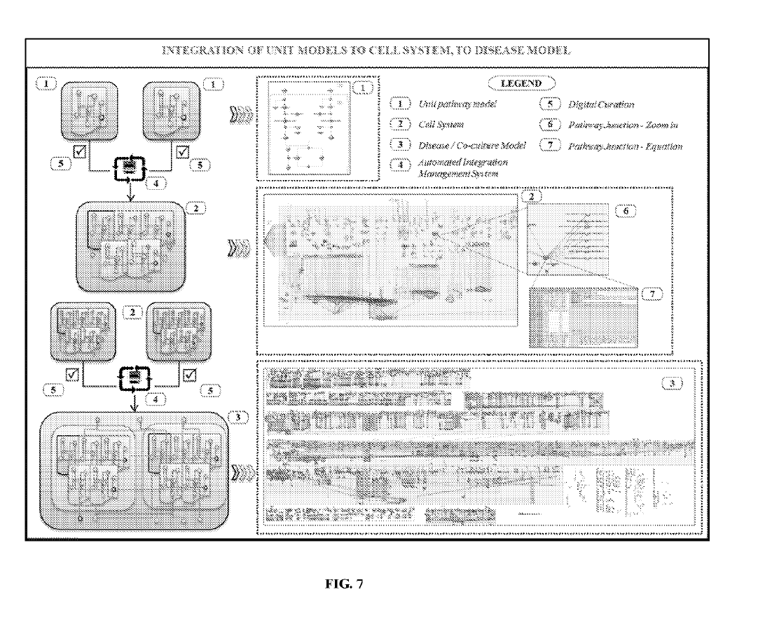

In another embodiment, according to the data gathered from literatures, various factors are defined in the model based on changes in specific bio-markers or phenotypes or a combination to show the effect on cell proliferation, survival, apoptosis, cell-counts etc. FIG. 7 shows the process of integration of unit models to develop a cell system model.

In another embodiment, integrated models are trained with alignment data gathered specifically for the cell type prior to using the model for validating or predicting cellular response to perturbations made to the system. Optimal parameter values are defined to get the system to steady state and ensure proper sensitivity of the model.

In another embodiment, during integration of the unit models, multiple models will converge at multiple common points. Maintaining the right contributions from each model/pathway at a converging point, based on alignment data, by defining the optimal parameter values is very critical. This is carried out manually or by using different tools similar to unit model development process.

In another embodiment, the alignment & validation datasets used in validating the unit models are integrated in a high level language so as to facilitate its execution in the model. This is further analyzed to check the unit model integrity after it is integrated into the cell type system.

In another embodiment, new cell-type specific alignment and validation data-sets, is checked only in integrated systems and those based on protocols involving simultaneous perturbations of species from different unit models (multi-pathway related studies), are also integrated in the high level language.

In another embodiment, information from Digital drug library 106 and the alignment and validation data-sets for the same, created from assimilated data, are also added in the high level language so as to test the efficacy of a drug on the cell-type model. In another embodiment, the model is tested by running iterative regression of the alignment and validation datasets represented in high level language either manually or through an automated high throughput technology, preferably by cloud computing technology and the informative reports are generated for analysis based on defined assertive statements (based on the assimilated data).

In another embodiment, analysis of different perturbations like over-expressions, knock-down, knock out, inhibition etc. are carried out manually or through different automated tools, preferably by the automated tools. The automated tools are—(a) One that shows the effect of a user-defined perturbation on the cell model based on color-codes with the intensity of color changing based on the extent to which the species is affected due to the perturbation; and/or (b) One that highlights all the possible paths, such that a signal can flow from one point to the other with details on the shortest and longest path highlighted, when the two points (can be species, reactions etc.) in a cell model are given as inputs.

In another embodiment, the cell-type model developed elicits response to perturbations in a fashion similar to the way the natural biological system would respond.

In another embodiment, to ensure correctness and re-usability of the cell-type model developed, the model is passed through a series of checks for inherent errors, including checks on disease trigger definitions, biological networks including inter-pathway interactions, protein function representations, protocols used for alignment and validation data-sets, assertive statements for the biomarkers and the trends, computational rigidness and adherence to pre-defined standards as defined in Tables 3 and 4.

In another embodiment, series of check on the cell type model is carried out to ensure correctness and re-usability of the model and also to ensure compatibility between two cell-type models when they are integrated to develop a comprehensive disease or co-culture model/platform.

### Development of Disease Model or Co-Culture Model:

The disease model is developed by integrating the one or more cell system models. Development of an in-silico model for any complex diseases selected from a group comprising Rheumatoid Arthritis (RA), cancer, dermatological disorder, inflammatory disorder, autoimmune disease and any combination thereof requires intensive research on the disease patho-physiology. This involves thorough data mining and aggregation of details including the different cell systems involved in the patho-physiology of these diseases and their dominance in various stages of the disease, the set of stimuli that can trigger the onset of the disease, the in-depth details of the different inter-cellular interactions and details on disease specific phenotype markers.

In an embodiment, the in-silico model representing RA or cancer or dermatological disorder or inflammatory disorder or autoimmune disease or any combination thereof is developed by integrating a group of different comprehensive in-silico cell-type models involved in the disease patho-physiology comprising, white blood cells, bone cells, synovial fibroblast, macrophages, endothelial cells, osteoblast, osteoclast, Keratinocytes, Melanocytes and Langerhans cells and dendritic cells or a combination thereof.

In another embodiment, based on the data assimilated from literatures, a set of disease triggers (increase or decrease of specific stimuli) are decided and defined in the model which results in an increase or decrease of endpoint biomarkers secreted from the thoroughly validated disease specific cell-type models, based on the datasets gathered for the disease. Thus, the integration of cell system models lead to a homeostatic model, in which perturbations by way of disease triggers are simulated to obtain a disease model. The outputs from one cell-type may act as stimuli to the same cell-type (autocrine) or a different cell-type (paracrine) which consists of stimuli receptors connected to a complex network of signal transduction. The details of these inter-cellular interactions involved in a disease of interest are represented in a common compartment for extra-cellular space in the in-silico model, where the different cell-type models with their respective compartments are placed.

In another embodiment, the key disease phenotypic markers inferring different outcomes of RA comprises synovitis, cartilage degradation, bone erosion, pain, angiogenesis etc. are defined to relate the responses elicited by the system to the intensity of the disease.

In another embodiment, the key disease phenotypic markers inferring different outcomes of cancer comprises cell proliferation, cell viability, apoptosis, pro-angiogenesis, anti-angiogenesis and metastasis etc. are defined to relate the responses elicited by the system to the intensity of the disease.

In another embodiment, the key disease phenotypic markers inferring different outcomes of dermatological disorder comprises epidermal barrier function, skin hydration, inflammation etc. are defined to relate the responses elicited by the system to the intensity of the disease.

In another embodiment, in-silico disease model developed in the present disclosure is designed using data from various publications, for example, in the range of 5 to 10 years and built on a backbone of a large number of mathematical equations representing interactions between a large number of biochemical entities. FIG. 7 shows the process of integration of cell system models to develop disease or co-culture model.

In another embodiment, integrated model with alignment datasets designed specifically for the disease [RA or cancer or dermatological disorder or inflammatory disorder or autoimmune disorder or a combination thereof] is trained prior to using the integrated disease model for predictions and validations.

In another embodiment, the key converging points between multiple cell types integrated in a disease/co-culture model are majorly at the biomarker expression levels, where the contribution of each cell system towards a particular bio-marker is set on the basis of disease specific alignment datasets. Defining optimal parameter values at these converging points to set the right contributions from each cell type is crucial.

In another embodiment, the kinetic rate parameters are optimized at the inter-cellular interaction points so that the in-silico system elicits responses to the disease triggers similar to that of the natural biological systems.

In another embodiment, a comprehensive dataset specific for a disease of interest such as RA or cancer or dermatological disorder or inflammatory disorder or autoimmune disease or a combination thereof comprising data from animal studies, humans, clinical trials etc. is extracted and integrated to high level language along with alignment and validation datasets designed for different cell-type models so as to facilitate its execution in the model.

In another embodiment, information from Digital drug library 106 and the alignment and validation datasets specific to the disease of interest such as RA or cancer or dermatological disorder or inflammatory disorder or autoimmune disease or a combination thereof, developed from assimilated data, are integrated to high level language so as to test the efficacy of drugs on the in-silico model representing the disease.

In another embodiment, validating the model's alignment comprising a huge comprehensive dataset is carried out by using a comprehensive cloud computing technology over a distributed network to perform repeated large-scale high-throughput virtual experiments in an extremely short period of time.

In another embodiment, informative reports are generated based on the assertive statements defined in the high level language based assimilated data.

In another embodiment, analysis of different perturbations like over-expressions, knock-down, knock out, inhibition etc. are carried out manually or through different automated tools, preferably by the automated tools on the disease in-silico model. The automated tools are—(a) One that shows the effect of a user-defined perturbation on the model based on color-codes with the intensity of color changing based on the extent to which the species is affected due to the perturbation; and (b) One that highlights all the possible paths, such that a signal can flow from one point to the other with details on the shortest and longest path highlighted, when the two points (can be species, reactions etc.) in a model are given as inputs.

In another embodiment, in-silico disease model is aligned and validated for results from over 4000 different experimental information obtained from the assimilated data

In another embodiment, the disease in-silico model is subjected to a series of checks for inherent errors in the model including checks on the disease trigger definitions, biological networks including inter-cellular interactions, autocrine and paracrine definitions, protein function representations, protocols used for alignment and validation datasets, assertive statements for the biomarkers and the trends, computational rigidness and adherence to pre-defined standards as defined in Tables 3 and 4.

In another embodiment, the validated in-silico model showing good correlation with validation data collected for Rheumatoid Arthritis or cancer or dermatological disorder or inflammatory disorder or autoimmune disease or any combination thereof serves as the validation dataset over the in-silico model's credibility for predicting drug effects. The in-silico disease/co-culture model is hence used for finding novel therapies for the treatment of the disease of interest, such as those exemplified above.

### Development of Digital Drug Library:

The digital drug library 106 is a comprehensive electronic repository containing multiple categories of digital drug capsules. A digital drug capsule is an electronic file representing a specific drug and containing intensive information such as—

The mechanism of action (MOA) of the drug, covering information regarding all the known and speculated targets of the drugs.
The pharmacological properties of the drug, such as IC50, Cₘₐₓ, bioavailability, AUC, Tₘₐₓ and half-life.
The physical properties of the drug, such as compound structure, molecular formula, molecular weight etc.
The pharmaceutical formulation information of the compounds within the drug.
Information pertaining to approved or safe dosing range of the drug.
The therapeutic category to which the drug belongs, such as and not limited to NSAIDS, DMARDs, Biologics, natural compounds etc.
Conditions for which the drug has been indicated.
Information pertaining to off-target effects, drug interactions and adverse events associated with the drug.
Manufacturer details specific for the drug.
Patent information specific to the drug.
Indication specific alignment information not limited to trends observed for biomarkers, phenotypes, disease scores etc. in experiments performed on patients, animal models, cell-line cultures etc.

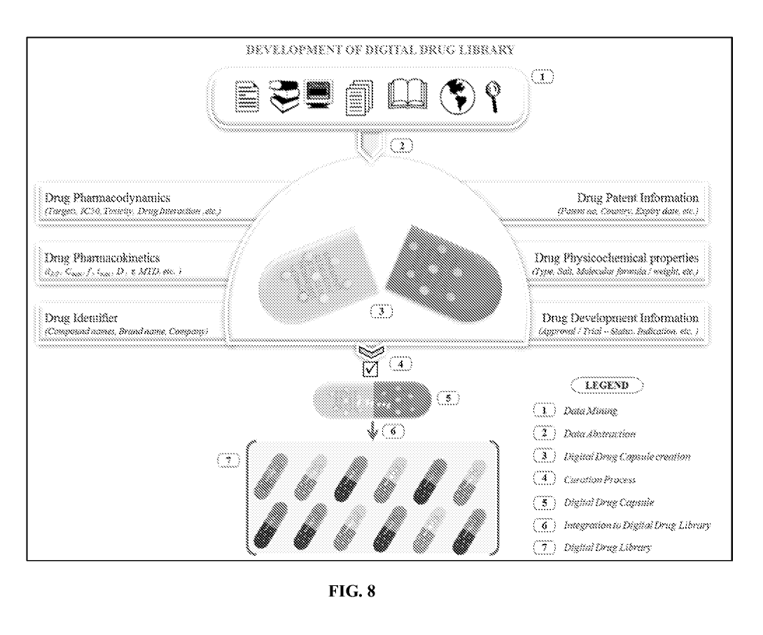

In another embodiment, digital drug library 106 for in-silico disease model representing RA or cancer or dermatological disorder or inflammatory disorder or autoimmune disease or any combination thereof is developed using data from various publications over the past many years, say, for illustrating purpose, in the range of 5 to 10 years and built on a backbone of a large number of mathematical equations representing drug pharmacodynamics, drug pharmacokinetics, drug identifier, drug patent information, drug physicochemical properties and drug development information. FIG. 8 shows the process of developing a digital drug library 106.

In another embodiment, the digital drug library 106 comprises intensive information about all under-trials and FDA approved drugs specific for RA and also other inflammatory conditions.

In another embodiment, the disease in-silico model ensures that the model will replicate intensively, the known or published effects of different drugs on RA patients or animal models of RA such as Collagen-induced arthritis (CIA), Adjuvant-Induced Arthritis (AIA), Collagen Antibody-Induced Arthritis (CAIA) etc.

In another embodiment, the disease in-silico model ensures that the model replicates intensively, the known or published effects of different drugs on cancer patients or animal models of cancer such as carcinoma, sarcoma, lymphoma, leukemia, adenoma etc. The model also represents the cancers mentioned above with KRAS and non-KRAS mutation.

In another embodiment, the disease in-silico model ensures that the model replicates intensively, the known or published effects of different drugs on dermatological conditions such as atopic dermatitis, Contact dermatitis, Irritant contact dermatitis, psoriasis, Eczema, and Xerosis etc.

In another embodiment, the disease in-silico model ensures that the model replicates intensively, the known or published effects of different drugs on inflammatory conditions such as acne vulgaris, asthma, autoimmune disease, celiac disease, chronic prostatis, glomerulonephritis, hypersensitivities, inflammatory bowel disease, pelvic inflammatory disease, reperfusion injury, rheumatoid arthritis, sarcoisosis, transplant rejection, vasculitis etc.

In another embodiment, the disease model is simulated with the information from the digital drug capsule and the dosing optimized recursively in a process known as drug efficacy characterization to achieve perfect alignment to trends observed in disease specific biomarkers and phenotypes of RA or cancer or dermatological disorder or inflammatory disorder or autoimmune disease or any combination thereof. Tables 9 and 10 provide a comprehensive list of all associated biomarker for all the phenotypes associated with RA pathogenesis and cancer.

Table 9: Shows various RA phenotypes and their associated biomarkers:

| SL. | RA | | |
|---|---|---|---|
| No. | Phenotypes | Biomarkers | |
| 1 | Synovial | MMP3 | Matrix Metallo-proteinase 3 |
| | Inflammation | EGF | Epidermal growth factor |
| | | RETN | Resistin |
| | | IL6 | Interleukin 6 |
| | | CCL22 | Chemokine (C-C motif) ligand 22 |
| | | TNFRSF1A | Tumor necrosis factor receptor |
| | | | superfamily, member 1A |
| | | IL6R | Interleukin 6 receptor |
| | | TNFSF13B | Tumor necrosis factor (ligand) |
| | | | superfamily, member 13b |
| | | APCS | Amyloid P component, serum |
| | | CALCB | Calcitonin-related polypeptide beta |
| | | CD40LG | CD40 ligand |
| | | CSF1 | Macrophage colony-stimulating |
| | | | factor (MCSF) |
| | | CSF2 | Granulocyte - macrophage colony- |
| | | | stimulating factor (GM-CSF) |
| | | CSF3 | Granulocyte colony-stimulating |
| | | | factor (GCSF) |
| | | CST3 | Cystatin C |
| | | FLT3LG | Fms-related tyrosine kinase 3 ligand |
| | | GHRL | Ghrelin |
| | | NTF4 | Neurotrophin 4 |
| | | TNFRSF8 | Tumor necrosis factor receptor |
| | | | superfamily, member 8/CD30L |
| | | | receptor |
| | | SPP1 | Secreted phosphoprotein 1 |
| | | IL18RA | Interleukin 18 receptor 1 |
| | | IL18 | Interleukin 18 |
| 2 | Cartilage | CTX-II | C-terminal crosslinking Telopeptide |
| | Degradation | | of type II collagen |
| | | COMP | Cartilage Oligomeric Matrix Protein |
| | | C2C | Collagen Type II Cleavage |
| | | Cl, 2C | Collagen Type I and II Cleavage |
| | | MMP10 | Matrix metalloproteinase 10 |
| 3 | Bone | CTX-I | C-terminal crosslinking Telopeptide |
| | Degradation | | of type I collagen |
| 4 | Joint | ICTP | ICTP |
| | Destruction | MMP1 | Matrix metallopeptidase 1 |
| | | ADIPOQ | Adiponectin, C1Q and collagen |
| | | | domain containing |
| | | FGF2 | Fibroblast growth factor-2 |
| | | LIF | Leukemia Inhibitory Factor |
| | | MMP2 | Matrix metallopeptidase 2 |
| | | MMP9 | Matrix metallopeptidase 9 |
| | | TNFRSF11B | Tumor necrosis factor receptor |
| | | | superfamily, member 11b; |
| | | | Osteoprotegerin |
| 5 | Angiogenesis | VCAM1 | Vascular cell adhesion molecule 1 |
| | | ICAM1 | Intercellular adhesion molecule 1 |
| | | VEGFA | Vascular Endothelial Growth Factor |
| | | FLT1 | Fms-related tyrosine kinase 1, |
| | | | VEGFR1 |
| | | FLT4 | Fms-related tyrosine kinase 4, |
| | | | VEGFR-3 |
| | | ICAM3 | Intercellular adhesion molecule 3 |
| | | PGF | Placenta growth factor |
| | | KDR | Kinase insert domain receptor, |
| | | | VEGFR2 |
| 6 | Pain | PGE2 | Prostaglandin E2 |
| 7 | Bone | BGLAP | Bone gamma-carboxyglutamate |
| | Remodeling | | (gla) protein |
| | | BMP6 | Bone morphogenetic protein 6 |
| | | BMP2 | Bone morphogenetic protein 2 |
| | | TNFSF11 | Tumor necrosis factor (ligand) |
| | | | superfamily, member 11/RANKL |
| 8 | Disease | Calprotectin | S100 calcium binding protein A8 & |
| | Activity | | A9 |
| | | IL8 | Interleukin 8 |
| | | LEP | Leptin |
| | | Pyridinoline | Pyridinoline |
| | | ADM | Adrenomedullin |
| | | AGER | Advanced glycosylation end |
| | | | product-specific receptor, RAGE |
| | | CS3B3 | Chondroitin sulphate epitopes |
| | | | 3-B-3 |
| | | EGFR | Epidemal growth factor receptor |
| | | FGA | Fibrinogen alpha chain |
| | | HP | Haptoglobin |
| | | IFNA1 | Interferon alpha-1 |
| | | IFNA2 | Interferon alpha-2 |
| | | IL10 | Interleukin-10 |
| | | IL12A | Interleukin 12A |
| | | IL12B | Interleukin 12B |
| | | IL13 | Interleukin 13 |
| | | IL15 | Interleukin 15 |
| | | IL17 | Interleukin 17 |
| | | IL2 | Interleukin-2 |
| | | IL2RA | Interleukin 2 receptor, alpha |
| | | IL3 | Interleukin-3 |
| | | IL4 | Interleukin-4 |
| | | IL4R | Interleukin 4 receptor |
| | | NGF | Nerve growth factor |
| | | PDGFA | Platelet-derived growth factor A |
| | | PDGFB | Platelet-derived growth factor B |
| | | PDGFC | Platelet-derived growth factor C |
| | | PDGFD | Platelet-derived growth factor D |
| | | PRL | Prolactin |
| | | SELE | soluble E-selectin |
| | | SELL | Selectin L |
| | | SELP | Selectin P |
| | | SLPI | Secretory leukocyte peptidase |
| | | | inhibitor |
| | | CD80 | B-lymphocyte activation antigen |
| | | | B7 |
| | | CD86 | B-lymphocyte activation antigen |
| | | | B7-2 |
| | | CD83 | CD83 |
| | | IL5 | Interleukin 5 |
| | | IL6ST | Interleukin 6 signal transducer, |
| | | | (gp130 oncostatin M receptor) |
| | | IL7 | Interleukin-7 |
| | | IL9 | Interleukin-9 |
| | | KIT | C-Kit |
| | | LTA | Lymphotoxin α |
| | | LYZ | Lysozyme |
| | | MPO | Myeloperoxidase |
| | | SOST | Sclerostin |
| | | SPARC | Secreted protein, acidic, cysteine- |
| | | | rich (osteonectin) |
| | | TGFA | Transforming growth factor, alpha |
| | | THBD | Thrombomodulin |
| | | TNF | Tumor Necrosis Factor |
| | | TNFRSF9 | Tmor necrosis factor receptor |
| | | | superfamily, member 9/4-1BB |
| | | | ligand receptor |
| | | TNFSF12 | tumor necrosis factor (ligand) |
| | | | superfamily, member 12; TWEAK |
| | | TNFSF13 | tumor necrosis factor (ligand) |
| | | | superfamily, member 12; APRIL |
| | | TNFSF14 | Tumor necrosis factor (ligand) |
| | | | superfamily, member 14; LIGHT |
| | | TNFSF18 | tumor necrosis factor (ligand) |
| | | | superfamily, member 18; GITRL |
| | | TPO | Thyroid peroxidase |
| 9 | Cartilage | CP II | Procollagen II C-Propeptide |
| | Synthesis | CS846 | Aggrecan Chondroitin Sulfate 846 |
| | | | Epitope |
| 10 | Radiographic | CCL5 | Chemokine (C-C motif) ligand 5 |
| | progression | CXCL1 | Chemokinc (C-X-C motif) ligand 1 |
| | | | (melanoma growth stimulating |
| | | | activity, alpha) |
| | | C1Q | Complement component 1, q |
| | | | subcomponent, A chain |
| | | CHI3L1 | chitinase 3-like 1 (cartilage |
| | | | glycoprotein-39); YKL-40 |
| | | CRP | C-reactive protein |
| | | TNFRSF1B | Tumor necrosis factor receptor |
| | | | superfamily, member 1B |
| | | Keratan | Keratan Sulphate |
| | | Sulphate | |
| | | CCL11 | Chemokine (C-C motif) ligand 11/ |
| | | | Fotaxin |
| | | HGF | Hepatocyte growth factor |
| 11 | Cardiovascular | APOA1 | Apolipoprotein A-I |
| | Effects | APOB | Apolipoprotein B |
| | | APOE | Apolipoprotein F |
| | | NPPB | Natriuretic peptide B/BNP |
| | | PTX3 | Pentraxin 3 |
| 12 | Rheumatoid | IGFBP1 | Insulin-like growth factor binding |
| | Cachexia | | protein 1 |
| 13 | Disease | IFNG | Interferon, gamma |
| | Remission | | |
| 14 | Genotypic | SAA1 | Scrum amyloid A1 |
| | Distribution | | |
| 15 | ACR Response | IL1RN/ | (Interleukin 1 Receptor |
| | for MTX | 1L1B Ratio | antagonist)/(Interleukin 1 beta) |
| | | | Ratio |
| 16 | DAS28 | Macrophage | Number of Synovial Tissue |
| | | Counts | Macrophages. |
| 17 | Apoptosis | FASLG | Fas ligand |
| 18 | Anaemia | EPO | Erythropoietin |
| 19 | Hyper- | ALPL | Alkaline phosphatase |
| | phosphatasaemia | | |
| 20 | Nerve Function | PPY | Pancreatic polypeptide Y |
| 21 | Body Mass | GH1 | Growth hormone 1 |
| 22 | Compensated | FSHB | Follicle stimulating hormone, beta |
| | Partial Gonadal | | polypeptide |
| | Failure | | |

Table 10: Shows various cancer phenotypes and their associated biomarkers:

| Cancer disease | | |
|---|---|---|
| phenotype | Markers | |
| Proliferation | CDK4-CCND1 | CDK4-CCND1 active complex |
| | CDK2-CCNE | CDK2-CCNE active complex |
| | CDK2-CCNA | CDK2-CCNA active complex |
| | CDC2-CCNB1 | CDC2-CCNB1 active complex |
| Apoptosis | BAX | Bcl-2-associated X protein |
| | CASP3 | Caspase 3 |
| | CASP8 | Caspase 8 |
| | NOXA | NOXA/PMA-induced protein 1 |
| | BIM | BCL2 interacting protein BIM |
| Survival | AKT1 | AKT1 kinase |
| | BCL2 | BCL2 protein |
| | MCL1 | MCL1 |
| | XIAP | X-linked inhibitor of apoptosis |
| | BIRC2 | Baculoviral IAP repeat containing 2 |
| | BIRC5 | Baculoviral IAP repeat containing 5 |
| Viability | Survival/Apoptosis | |
| Pro-Angiogenesis | IL8 | Interleukin 8 |
| | VEGFA | Vascular endothelial growth factor A |
| Anti-Angiogenesis | SERPINFI | Serpin peptidase inhibitor, clade F |
| | THBS2 | Thrombospondin 2 |

In an embodiment, the insilico model represents major phenotypes associated with RA pathogenesis such as swollen joints, tender joints, bone destruction, cartilage degradation, pannus formation, pain and synovitis.

In another embodiment, swelling of joints is a major clinical assessment phenotype associated with RA disease. The biomarkers directly and indirectly influencing joint swelling are selected and not limited to a group comprising Tumor Necrosis Factor-alpha (TNF), Interleukin-1 beta (IL1B), Interleukin-6 (IL6), Interleukin-17 (IL17), Interleukin-18 (IL18), chemokine [C-C motif] ligand 2 (CCL2), Vascular Endothelial Growth Factor alpha (VEGFA) etc.

In another embodiment, joint tenderness is a phenotype that is critically observed during the clinical assessment of RA. The biomarkers that influence Joint tenderness are selected from and not limited to a group comprising RANK Ligand (TNFSF11), Matrix Metallopeptidase 9 (MMP9), Cathepsin K (CTSK), Matrix Metallopeptidase 3 (MMP3), C-telopeptide of type 1 collagen (CTX1) etc.

In another embodiment, the biomarkers that influence bone destruction are selected from and not limited to a group comprising RANK Ligand (TNFSF11), Cathepsin K (CTSK), Matrix Metallopeptidase 3 (MMP3), Matrix Metallopeptidase 9 (MMP9), C-telopeptide of type 1 collagen (CTX-1), cross-linked telopeptide of type I collagen (ICTP), N-telopeptide of type 1 collagen (NTX-1), Bone Sialoprotein (IBSP) etc.

In another embodiment, the biomarkers that influence cartilage degradation are selected from and not limited to a group comprising Matrix Metallopeptidase 3 (MMP3), Matrix Metallopeptidase 13 (MMP13), C-telopeptide of type 2 collagen (CTX-2), Cartilage glycoprotein 39 (CHI3L1) etc.

In another embodiment, the biomarkers that influence pannus formation are selected from and not limited to a group comprising Vascular Endothelial Growth Factor-alpha (VEGFA), Fibroblast Growth Factor 2 (FGF2), Angiopoietin 1 (ANGPT1) etc.

In another embodiment, pain associated with the RA disease is directly characterized by biomarkers selected from and not limited to a group comprising Prostaglandin E2 (PGE2), Nerve Growth Factor (NGF), Substance P (TAC1) etc.

In another embodiment, the biomarkers that influence inflammation or synovitis are selected from and not limited to a group comprising C-Reactive Protein (CRP), Erythrocyte Sedimentation Rate (ESR), Tumor Necrosis Factor-alpha (TNF), Interleukin-1 beta (IL1B), Interleukin-6 (IL6), Interleukin-17 (IL17), Interleukin-8 (IL8), chemokine [C-C motif] ligand 2 (CCL2), chemokine [C-C motif] ligand 5 (CCL5), chemokine [C-X-C motif] ligand 13 (CXCL13) etc.

In another embodiment, the disease in-silico model is evaluated on the effect of a therapy based on the phenotypic markers, comprising mathematical scoring functions representing each phenotype. This Phenotype Scoring function involves multiplicity of mathematical operations pertaining to the levels of the associated biomarkers derived from the in-silico RA disease model.

In another embodiment, the scores generated from the mathematical scoring functions are correlated to the published clinically assessed scores stored in the digital drug capsule to ensure perfect alignment of the in-silico model to a particular therapy.

In another embodiment, American College of Rheumatoid (ACR) scoring system and DAS28 scoring system are used to determine the extent of improvement in the RA disease symptoms on treatment with a drug.

In another embodiment, the ACR scoring system involves three main scores: ACR20 score pertaining to 20% improvement in the disease, ACR50 score pertaining to 50% improvement in the disease and ACR70 score pertaining to 70% improvement in the disease. Clinically, the calculation of the ACR score is dependent on inputs from a patient Health Assessment Questionnaire (HAQ) and analysis of the percentage improvement in the RA disease phenotypes.

In another embodiment, the DAS28 scoring system employs a complex formula taking into account tender joints, swollen joints, synovitis, and global health of the biological system as parameters to assess improvement in the disease condition upon administration of a drug or combination of drugs. The formula is as follows: [DAS28=0.56*sqrt(tender joints)+0.28*sqrt(swollen joints)+0.70*Ln(synovitis)+0.014*Global Health]. A DAS28 score of above 5.1 represents a high disease activity and highlights the ineffectiveness of a therapy. A DAS28 score in a range of 5.1 and 3.2 represents medium disease activity on administration of a therapy. A DAS28 score in a range of 3.2 and 2.6 represents a low disease activity on administration of a therapy and a DAS28 score below 2.6 signifies disease remission.

In another embodiment, to evaluate the ACR or DAS28 score for a drug in an in-silico RA disease model, an ACR scoring function referred to as N-ACR and a DAS28 scoring function are designed and formulated to include, a multiplicity of mathematical operations on the phenotype scores generated from the Phenotype Scoring function.

In an embodiment, in silico model represents the major phenotypes associated with cancer such as proliferation, viability, apoptosis, pro-angiogenesis, anti-angiogenesis and metastasis.

In another embodiment, proliferation is a major clinical assessment phenotype associated with cancer. The biomarkers directly and indirectly influencing proliferation are selected and not limited to a group comprising CDK4-CCND1 active complex, CDK2-CCNE active complex, CDK2-CCNA active complex AND CDC2-CCNB1 active complex etc., wherein proliferation is calculated by a formula: Proliferation=average (0.4*CDK4−CCND1+0.2*CDK2−CCNE+0.2*CDK2−CCNA+0.2*CDC2−CCNB1) to determine the improvement in disease on administering a drug or a combination of drug from digital drug library 106.

In another embodiment, apoptosis is a phenotype that is critically observed during the clinical assessment of cancer. The biomarkers that influence apoptosis are selected from and not limited to a group comprising Bcl-2-associated X protein, caspase-3, caspase-8, NOXA/PMA-induced protein 1 and BCL2 interacting protein BIM etc., wherein apoptosis is calculated by a formula:

Apoptosis=average (0.2*BAX+0.2*CASP3+0.2*CASP8+0.2*NOXA+0.2*BIM)

to determine the improvement in disease on administering a drug or a combination of drug from digital drug library 106.

In another embodiment, the biomarkers that influence survival of cells in cancer disease phenotype are selected from and not limited to a group comprising ATK1 kinase, BCL2 protein, MCL1, X-linked inhibitor of apoptosis, Baculoviral IAP repeat containing 2 and Baculoviral IAP repeat containing 5 etc., wherein apoptosis is calculated by a formula:

Apoptosis=average (0.2*BAX+0.2*CASP3+0.2*CASP8+0.2*NOXA+0.2*BIM)

to determine the improvement in disease on administering a drug or a combination of drug from digital drug library 106.

In another embodiment, the biomarkers that influence viability of cancer cells are selected and not limited to a group comprising Bcl-2-associated X protein, caspase-3, caspase-8, NOXA/PMA-induced protein 1, BCL2 interacting protein BIM, ATK1 kinase, BCL2 protein, MCL1, X-linked inhibitor of apoptosis, Baculoviral IAP repeat containing 2 and Baculoviral IAP repeat containing 5 etc.

In another embodiment, the biomarkers that influence Pro-angiogenesis are selected from and not limited to a group comprising interleukin-8 and vascular endothelial growth factor A etc., wherein pro-angiogenesis is calculated by a formula:

Pro-angiogenesis=average (0.5*IL8+0.5*VEGFA)

to determine the improvement in disease on administering a drug or a combination of drug from digital drug library 106.

In another embodiment, the biomarkers that influence anti-angiogenesis are selected from and not limited to a group comprising serpin peptidase inhibitor, Glade F and thrombospondin etc., wherein anti-angiogenesis is calculated by a formula:

Anti-angiogenesis=average (0.5*SERPINF1+0.5*THBS2)

to determine the improvement in disease on administering a drug or a combination of drug from digital drug library 106.

In another embodiment, metastasis of a insilico cancer model is defined by matrix degradation, motility, chemotaxis, and EMT, wherein;

Matrix degradation is calculated by the formula:

Matrix degradation=0.3*MMP2+0.2*MMP9+0.2*MMP1+0.3*PLAU−PLAUR;

Motility is calculated by a formula:

Motility=0.33*RAC1−GTP+0.33*RHOA−GTP+0.33*CDC42−GTP;

Chemotaxis is calculated by the formula

Chemotaxis=100*CXCR4;

EMT is calculated by the formula:

EMT=100*CTNNA1−CTNNB1−CTNND1.

Once all the individual parameter of metastasis is calculated, the overall metastasis rate of a cancer is determined by a formula:

Metastasis=average (0.35*Matrix Degradation+0.35*Motility+0.1*Chemotaxis+0.2*EMT)

to determine the improvement in disease on administering a drug or a combination of drug from digital drug library 106.

The metastasis is defined by considering matrix degradation, motility, chemotaxis, and EMT as parameters, each of which further comprise specific calculations of biomarkers representing the said parameter. For example, matrix degradation takes into account the levels of MMP2, MMP9, MMP1m PLAU-PLAUR biomarkers, whereas chemotaxis takes into account the levels of CXCR4 biomarker.

In another embodiment, angiogenesis of in silico cancer model is defined by factors such as BM degree, endothelial cell motility, endothelial cell proliferation, endothelial cell survival, endothelial cell apoptosis, endothelial cell viability, wherein these factors are calculated in the model by the below mentioned formula in the Table 11.

TABLE 11

| | |
|---|---|
| Angiogenesis | Factor_BM_Deg = 0.5*glb_MMP2_ec + 0.5*glb_MMP9_ec |
| (Tumor | Factor_ENC_Motility = 0.5*glb_MMP2_ec + (0.5*glb_MMP9_ec |
| Co- | Factor_ENC_Proliferation = (1*ENC_CCND1)/(1*ENC_CDKN1A) |
| culture | Factor_ENC_Survival |
| System) | 0.33*ENC_AKT1_pp + 0.33*ENC_BCL2 + 0.33*ENC_BCL2L1 |
| | Factor_ENC_Apoptosis = |
| | 0.33*ENC_BAX_act + 0.33*ENC_CASP3 + 0.33*ENC_CASP8 |
| | Factor_ENC_Viability |
| | {(Factor_ENC_Survival/Factor_ENC_APOPTOSIS)} |

Further, improvement of the disease condition, i.e. cancer upon administering a drug or a combination of drug from the digital drug library 106 is analyzed by calculating the overall angiogenesis score by a formula:

Angiogenesis=average (0.3*Factor_BM_Deg)+(0.3*Factor_ENC_Motility)+(0.2*Factor_ENC_Proliferation)+(0.2*Factor_ENC_Viability).

The angiogenesis score is obtained by considering Factor_BM_Deg, Factor_ENC_Motility, Factor_ENC_Proliferation and Factor_ENC_Viability as parameters, each of which further comprise specific calculations of biomarkers representing the said parameter. For example, Factor_ENC_Motility takes into account the levels of MMP2 and MMP9 biomarkers, whereas Factor_ENC_Proliferation takes into account the levels of CCND1 and CDKN1A biomarkers.

In another embodiment, overall response rate of tumor co-culture system in cancer model is calculated by a formula:

{((0.25*PROLIFERATION)+(0.25*VIABILITY)+(0.25*ANGIOGENESIS-CO-CULTURE)+(0.25*METASTASIS))}

to determine the improvement in the disease after administering a drug or combination of drug from digital drug library 106.

The overall response rate takes into consideration the angiogenesis score obtained above, along with proliferation, viability and metastasis as parameters, each of which is given equal weightage to arrive at an average overall response rate.

In another embodiment, tumor volume of tumor co-culture system in cancer model is calculated by a formula:

{((0.4*VIABILITY)+(0.4*PROLIFERATION)+(0.2*ANGIOGENESIS-CO-CULTURE))}

to determine the improvement in the disease after administering a drug or combination of drug from digital drug library 106.

The tumor volume takes into consideration the angiogenesis score obtained above, along with proliferation and viability as parameters, wherein each of proliferation and viability are given equal weightage, whereas the angiogenesis score is given half weightage when compared to the other two parameters to arrive at an average tumor volume.

In another embodiment, tumor shrinkage of tumor co-culture system in cancer model is calculated by a formula:

{((0.5*VIABILITY)±(0.5*PROLIFERATION))}

to determine the improvement in the disease after administering a drug or combination of drug from digital drug library 106.

The tumor shrinkage takes into consideration the proliferation and viability as parameters, wherein each of proliferation and viability are given equal weightage, to arrive at average tumor shrinkage.

In another embodiment, tumor burden of tumor co-culture system in cancer model is calculated by a formula:

{((0.2*TUMOR SHRINKAGE)±(0.4*ANGIOGENESIS-CO-CULTURE)+(0.4*METASTASIS))}

to determine the improvement in the disease after administering a drug or combination of drug from digital drug library 106.

The tumor burden takes into consideration the angiogenesis score and tumor shrinkage score obtained above, along with metastasis as parameters, wherein each of angiogenesis score and metastasis are given equal weightage, whereas the tumor shrinkage score is given half weightage when compared to the other two parameters to arrive at average tumor burden.

In another embodiment, the phenotypes representing cancer model mentioned in the previous embodiments are all supported in the single cell system and gives a good insight into the therapeutic effect of a drug, as a measure of these indexes, in terms of reduction in tumor cell proliferation and viability. However, for aspects of measuring tumor burden, angiogenic factors need to be accounted which is covered better in a co-culture system wherein, the overall angiogenic potential of the tumor, mainly a property of the endothelial cells and other neighboring cells like macrophages and fibroblast which support tumor cell survival, gets factored in the overall tumor burden index

In another embodiment, the cancer in-silico models are evaluated on the effect of a therapy based on the phenotypic markers, comprising mathematical scoring functions representing each phenotype. This Phenotype Scoring function involves multiplicity of mathematical operations pertaining to the levels of the associated biomarkers derived from the in-silico model.

### Therapy Design Specification:

The basic idea behind designing a novel therapeutic solution would find its roots in the fact that most single drug therapies are either in-efficacious or efficacious but have associated toxicities.

In an embodiment, designing an effective combination therapy involves bringing together two or more drugs at varying concentrations (concentrations lower than the approved concentration in the pharmacopeia) for administration either as a single formulation or as separate therapies that can be administered concomitantly or sequentially, such that there is a synergistic effect in the overall efficacy of the participating drugs. The design of a combination therapy involves the following-Combining multiple in-efficacious drugs to increase the overall efficacy. Combining multiple efficacious but toxic drugs in lower doses to increase efficacy but negate acute toxicities.

Combining in-efficacious drugs with lower doses of efficacious drugs to obtain synergistic efficacy and negate acute toxicities.

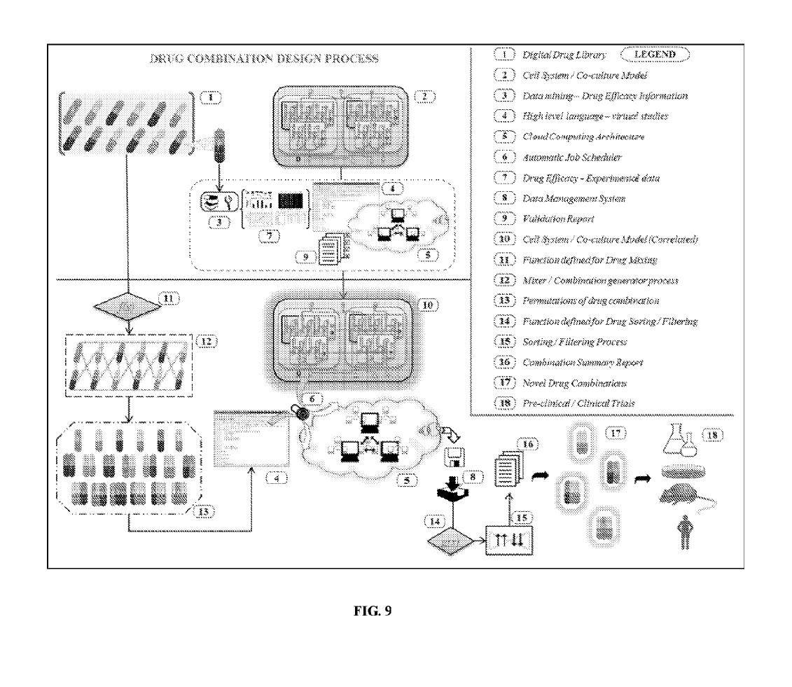

In another embodiment, designing and testing a combination therapy in the in-silico disease/co-culture model representing RA or cancer or dermatological disorder or inflammatory disorder or autoimmune disease or any combination thereof, involves selecting digital drug capsules from the library using either an exclusive or a non-exclusive selection process and the information contained in the capsules are combined exhaustively using a mixer tool in to a digital combination drug capsule. This combination capsules are simulated in the model to calculate the therapeutic benefits. FIG. 9 describes the processes involved in designing drug combination therapy

In another embodiment, the digital capsules from a digital drug library 106 are combined in a plurality of ways such as—

‘x’-degree exhaustive combination of ‘v’ capsules in full dose (c dose) with c dose of ‘y−1’ other capsules present in the library. Here y′ represents the number of capsules present in the library and ‘x’ is any non-zero whole number such that ‘x-degree’ represents the number of drugs present in the combination, for example, a 2-degree combination would represent a combination of 2 drugs.

In another embodiment, the combination of digital capsules in a system of the instant invention are exemplified by the following ways but not limited to the same, wherein A, B and C represent individual drug molecules used to treat one or more disease/disorder which is being described in the instant invention, for the ease of representation the drug molecules have been designated as A, B and C—

The library with 3 capsules say A, B and C, then a 2-degree exhaustive combination of full dose (c) is designed to yield the following combinations:

| | | |
|---|---|---|
| A(c)-B(c) | B(c)-C(c) | A(c)-C(c) |

‘x’-Degree Combination of ‘y’ Capsules in c/n Dose with c/n Dose of ‘y−1’ Other Capsules Present in the Library. Here n is any Non-Zero Whole Number and c/n Represents a Fractional Dose.

The library with 3 capsules say A, B and C, then a 3-degree exhaustive combination of full dose (c) and half dose (c/2) is designed to yield the following combinations:

| | | | |
|---|---|---|---|
| A(c) - B(c) - | A(c) - B(c/2) - | A(c/2) - B(c) - | A(c/2) - B(c/2) - |
| C(c) | C(c) | C(c) | C(c) |
| A(c) - B(c) - | A(c) - B(c/2) - | A(c/2) - B(c) - | A(c/2) - B(c/2) - |
| C(c/2) | C(c/2) | C(c/2) | C(c/2) |

‘x’-Degree Combination of ‘y-m’ Capsules in c Dose with c Dose of ‘m’ Selected Anchor Capsules Present in the Library.

The library with 3 capsules say A, B and C, then a 2-degree exhaustive combination of full dose (c) of A as anchor with full dose (c) of B and C is designed to yield the following combinations:

| | |
|---|---|
| A(c)-B(c) | A(c)-C(c) |

‘x’-Degree Combination of ‘y-m’ Capsules in c/n Dose with c Dose of ‘m’ Selected Anchor Capsules Present in the Library.

The library with 3 capsules say A, B and C, then a 2-degree exhaustive combination of full dose (c) of A as anchor with half dose (c/2) of B and C is designed to yield the following combinations

| | |
|---|---|
| A(c)-B(c) | A(c)-C(c) |
| A(c)-C(c/2) | A(c)-B(c/2) |

‘x’-Degree Combination of Capsules in c/n Dose with c/n Dose of ‘m’ Selected Anchor Capsules Present in the Library.

The library with 3 capsules say A, B and C, then a 2-degree exhaustive combination of half dose (c/2) of A as anchor with full dose (c) and half dose (c/2) of B and C is designed to yield the following combinations

| | |
|---|---|
| A(c/2)-B(c) | A(c/2)-C(c) |
| A(c/2)-B(c/2) | A(c/2)-C(c/2) |

In another embodiment, the combinations of the digital capsules are stored automatically in a digital combinatorial drug library and using a high-throughput cloud computing technology simulated in the in-silico disease model representing RA or cancer or dermatological disorder or inflammatory disorder or autoimmune disease or any combination thereof.

In another embodiment, filtering of efficacious combination of digital capsule is carried out by a data extraction and reporting tool (DERT), which automatically retrieves preset biomarker level values pertaining to control, disease and drug simulation time points and calculates the percentage change in the defined biomarker.

In another embodiment, the percentage change for the biomarkers is calculated by the following—

percentage change in the levels of the biomarker with drug administration compared to its levels in the diseased state; and/or
percentage change in the levels of the biomarkers with drug administration compared to its levels in both the diseased and control states.

In another embodiment, the percentage change values of all the biomarkers for all the capsule combinations simulated in the model are recorded in data extraction and reporting tool (DERT) to calculate the phenotype scores using phenotype scoring function.

In another embodiment, drug efficacy scores, mainly ACR or DAS28 scores, are calculated by data extraction and reporting tool (DERT) using the biomarker scores and the phenotype scores as inputs. These scores are also used to calculate synergy values for the combinations. Synergy value in this context refers to the percentage improvement, observed in the efficacy scores with combination drug therapy with respect to the sum of efficacy scores observed with the individual, constituent drug therapies. The calculated values are provided to an electronic file which is referred to here as a drug efficacy report (DER).

In another embodiment, Drug Efficacy Report (DER) is subjected to multi-level filtering using automated or manual techniques to identify viable drug combinations, that show good efficacy, less associated toxicities, good pharmacological affinities and formulation compatibility.

In another embodiment, the filtering process of combination of drugs or individual drugs at lower concentration than the approved value, for their efficacy towards the improvement of RA condition mainly involves the following strategies—

Level 1-filtering of the combinations on the basis of drug efficacy, which involves:

Filtering on the basis of ACR scores;
Filtering on the basis of DAS28 scores;
Filtering on the basis of synergy scores;
Filtering on the basis of phenotype scores;
Filtering on the basis of biomarker scores; or
Any degree of combination of the above strategies.

Level 2-filtering of the combinations on the basis of drug properties, which involves:

Filtering on the basis of logical drug target preference;
Filtering on the basis of logical affinities in drug pharmacological properties;
Filtering on the basis of multi-drug formulation compatibility;
Filtering on the basis of associated side effects;
Filtering on the basis of novelty of the combination, involving and not limited to, the following:
Filtering on the basis of non-obviousness of the target set; or
Filtering on the basis of existing prior art pertaining to the combination;
Filtering on the basis of ease of procurement and patent restrictions on the compounds; or
Any degree of combination of the above strategies.

In another embodiment, the filtering process of combination of drugs or individual drugs at lower concentration than the approved value, for their efficacy towards the improvement of cancer condition mainly involves the following strategies—

Level 1-filtering of the combinations on the basis of drug efficacy, which involves:

Filtering on the basis of synergy scores;
Filtering on the basis of phenotype scores such as proliferation, viability, survival, pro and anti-angiogenesis;
Filtering on the basis of biomarker scores; or
Any degree of combination of the above strategies.

Level 2-filtering of the combinations on the basis of drug properties, which involves:

Filtering on the basis of logical drug target preference;
Filtering on the basis of logical affinities in drug pharmacological properties;
Filtering on the basis of multi-drug formulation compatibility;
Filtering on the basis of associated side effects;
Filtering on the basis of novelty of the combination, involving and not limited to, the following:
Filtering on the basis of non-obviousness of the target set; or
Filtering on the basis of existing prior art pertaining to the combination;
Filtering on the basis of ease of procurement and patent restrictions on the compounds; or
Any degree of combination of the above strategies.

In another embodiment, the filtering process of combination of drugs or individual drugs at lower concentration than the approved value, for their efficacy towards the improvement of dermatological disorder condition mainly involves the following strategies—

Level 1-filtering of the combinations on the basis of drug efficacy, which involves:

Filtering on the basis of synergy scores;
Filtering on the basis of phenotype scores such as epidermal barrier/skin barrier, skin
hydration and inflammation etc;
Filtering on the basis of biomarker scores; or
Any degree of combination of the above strategies.

Level 2-filtering of the combinations on the basis of drug properties, which involves:

Filtering on the basis of logical drug target preference;
Filtering on the basis of logical affinities in drug pharmacological properties;
Filtering on the basis of multi-drug formulation compatibility;
Filtering on the basis of associated side effects;
Filtering on the basis of novelty of the combination, involving and not limited to:
Filtering on the basis of non-obviousness of the target set; or
Filtering on the basis of existing prior art pertaining to the combination;
Filtering on the basis of ease of procurement and patent restrictions on the compounds; or
Any degree of combination of the above strategies.

In another embodiment, upon arriving at the desired set of combinations, the individual compounds are procured, formulated and tested pre-clinically in animal models to validate the predictive data.

In another embodiment, the validated in-silico disease model/co-culture model representing RA or cancer or dermatological disorder or inflammatory disorder or autoimmune disease or any combination thereof is used as a powerful platform upon which new and effective combination therapies is designed to achieve remission from various diseases.

Thus in brief, the present disclosure relates to a system for obtaining a therapeutic solution for treatment of a disease, wherein said system comprises database, digital drug library and processor. The database within the system comprises unit models configured by collating information on parameters of biological system from plurality of information sources. These unit models further integrate to form cell system models which facilitates simulation of at least one of the biological system or homeostatic state of the biological system. The unit and cell system models then come together to arrive at a homeostatic model, which when perturbed provides a user with a model which depict the conditions of a disturbed or diseased biological system, known as disease model.

The digital drug library of the instant system is formed by combining information on plurality of categories of digital drug capsules, whereas the processor is communicatively connected to the database and the digital drug library. The processor, based on a predefined cost function, therefore transmits one of the one or more disease model along with a set of drugs from the digital drug library to a scheduler. The scheduler distributes one or more of the plurality of digital drug capsules with the one or more disease models to one or more computing devices. The scheduler also is connected to the one or more computing devices through a network. The processor then receives an output comprising the effect of the set of drugs on the disease model from the scheduler, wherein the scheduler transmits the output to the processor by combining matching results from the one or more computing devices. The processor thereafter analyzes the output to obtain the therapeutic solution in context of said disease.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The disclosed configurations are further illustrated by the following examples. The following examples are provided for illustrative purposes only and are not intended to limit the scope of the disclosure.

### EXAMPLES

### Example-1

### Development of Novel therapeutic solution for Rheumatoid Arthritis (RA)

Rheumatoid arthritis (RA) is complex autoimmune disease affecting mainly joints; wherein the disease involves multiple cell interactions through various inter-cellular mediators like cytokines, chemokines, etc. The main clinical manifestations of the disease are inflammation, synovial hyperplasia, endothelial dysfunction, cartilage degradation and bone degradation. These clinical features can be linked to abnormal activity of various cells. The local or systemic inflammation can be linked to abnormal activation of immune cells like Dendritic cells, T lymphocytes, B lymphocytes and Macrophages, Neutrophils, whereas the synovial hyperplasia is due to abnormal proliferation of Fibroblasts like Synoviocytes.

These abnormal activities of the cells in turn cause alterations in the expression levels of the inter-cellular mediators causing the disease cascade to increase severity from early phase to late phase of the disease.

Some key cytokines produced from inflammatory cells & Fibroblast like Synoviocytes are IL1B (Interleukin 1-beta), TNFA (Tumor Necrosis Factor-alpha), IL6 (Interleukin 6), IL18 (Interleukin 18), IL17 (Interleukin 17), GMCSF (Granulocyte Colony Stimulating Factor), VEGF (Vascular Endothelial Growth Factor), EGF (Epidermal Growth Factor) and CC & CXC chemokines.

Similarly Chondrocyte, Osteoclasts produce matrix degradation enzymes like MMPs (Metalloproteinase), CTSK (Cathepsin K) & RANKL causing cartilage and bone damage.

These inter-cellular mediators exert their specific functions in each target cell through cell signaling or signal transduction pathways through specific receptors which involve activation of respective adapter proteins, accessory proteins, kinases, transcription factors and leading to specific gene expression pattern. Multiple such cell signaling pathways converge synergistically or antagonistically to represent different phenotypes of the cell.

Therefore for the development of in-silico disease model for rheumatoid arthritis (RA), considering the above mentioned understandings on RA disease pathophysiology; a bottom-up block development method have been adopted, which involves development of multiple unit models depicting each important intra-cellular signal transduction pathways for specific cell systems,

these unit models developed for specific cell systems are strategically integrated to form a cell system model which will be able to predict cell phenotypes & biomarkers expression based on different trigger sets or disease triggers,
Such different cell system models based on their relevance in the disease focus are integrated considering their cell to cell interactions and disease phenotypes to form a robust disease model for rheumatoid arthritis (RA).

### Development of Unit Model for RA Condition:

For the development of unit model representing Rheumatoid arthritis (RA), data is assimilated from literature on a specific signaling/metabolic pathway. The instant example illustrates the development of a unit model representing Interleukin 6 (IL6) signaling in the Cell system model “T Lymphocyte” (TCELL) with a disease focus of “Rheumatoid Arthritis” (RA). Here, the example describes the development of unit model representing interleukin 6 (IL6), as IL6 is one of the key markers in the disease condition of RA. The below Tables 12 and 13 exemplify the literatures that are referred to assimilate data regarding the role of IL6 in RA and the inference obtained. Further, Tables 14, 15, 16, 17 and 18 illustrate on how the data assimilated from the literatures on IL6 shows a biological relationship with STAT3 signaling and how the relationship is represented by a specific kinetic rate law equations.

TABLE 12

| | |
|---|---|
| Literature | A CD4 T cell gene signature for early rheumatoid arthritis |
| Reference | implicates interleukin 6-mediated STAT3 signaling, |
| | particularly in anti-citrullinated peptide antibody-negative |
| | disease. [PMID: 22532634] |
| Inference | “IL6-mediated STAT3 signaling in CD4+ T cells plays a key |
| | role in earliest clinical phase of RA”. Therefore this |
| | literature signifies the importance of IL6 signaling in T |
| | lymphocytes (CD4+ T cells) in disease Rheumatoid Arthritis |
| | (RA). |

TABLE 13

| | |
|---|---|
| Literature | Interleukin-6 receptor blockade selectively reduces IL-21 |
| Reference | production by CD4 T cells and IgG4 autoantibodies in |
| | rheumatoid arthritis. [PMID: 23493630] |
| Inference | Interleukin-6 signaling on CD4+ T lymphocytes results in |
| | production of Interleukin 21, which is validated by studying |
| | effect of tocilizumab on CD4+ T cells. |

TABLE 14

| Interaction | 1 | |
|---|---|---|
| Biological | Binding of IL6 ligand with IL6 receptor | |
| Relationship | | |
| Literature | Expression of IL6R on T Lymphocytes (Chen X et.al, | |
| | 2010), IL6 signaling mechanism (Heinrich PC et.al, 2003), | |
| | IL6 physiological role (Teague TK et.al, 1997) | |
| Mechanism | The reaction has been modeled as a Simple Michaelis | |
| | Menten equation, with the receptor as the substrate and | |
| | ligand as the activator | |
| Chemical | [TCELL_IL6R = TCELL_IL6R_act] | |
| Equation | | |
| Kinetic Rate | (Vf_TCELL_IL6_ec*TCELL_IL6R.Concentration)/(Km_ | |
| Equation | TCELL_IL6R + TCELL_IL6R.Concentration) | |
| | Vf_TCELL_IL | (kcatf_TCELL_IL6_ec*TCELL_IL |
| | 6_ec | ncentration)*VCyt |

TABLE 15

| Interaction | 2 | |
|---|---|---|
| Biological | Binding of IL6 ligand-receptor complex with 2 molecules of | |
| Relationship | GP130 (IL6ST) | |
| Literature | Expression of GP130 on T Lymphocytes (Betz UA et.al, | |
| | 1998) | |
| Mechanism | The reaction has been modeled as a Reversible Mass Action | |
| | reaction with a Non-Competitive inhibition from soluble | |
| | GP130 | |
| Chemical | [TCELL_IL6R_act + 2 TCELL_IL6ST = | |
| Equation | TCELL_IL6R_act_IL6ST_di] | |
| Kinetic Rate | (((Kf_app*TCELL_IL6R_act.Concentration)*(TCELL_IL6 | |
| Equation | ST.Concentration*TCELL_IL6ST.Concentration))- | |
| | (Kr*TCELL_IL6R_act_IL6ST_di. Concentration))*VCyt | |
| | Kf_ | Kf/(1 + (TCELL_IL6ST_s_ec.Concentration/Ki_T_ |
| | app | IL6ST_s_ec)) |

TABLE 16

| Interaction | 3 | |
|---|---|---|
| Biological | Binding & Phosphorylation of JAK1 by IL6 receptor | |
| Relationship | complex | |
| Literature | SOCS inhibition of IL6 induced JAK1 phosphorylation | |
| | (Fischer P et.al, 2004), Activation of JAK kinases by IL6 | |
| | signaling (Narazaki M et.al, 1994) | |
| Mechanism | The reaction has been modeled as a Simple Michaelis | |
| | Menten equation, with SOCS1 and SOCS3 inhibiting the | |
| | phosphorylation competitively. | |
| Chemical | [TCELL_JAK1 = TCELL_IL6R_act_IL6ST_di_JAK1_p] | |
| Equation | | |
| Kinetic Rate | (Vf_TCELL_IL6R_act_IL6ST_di*TCELL_JAK1.Concentra- | |
| Equation | tion)/(Km_TCELL_JAK1_app + TCELL_JAK1.Concentra- | |
| | tion) | |
| | Vf_TCELL_IL6R_ | (kcatf_TCELL_IL6R_act_IL6ST |
| | act_IL6ST_di | CELL_IL6R_act_IL6ST_di.Con |
| | | on)*VCyt |
| | Km_TCELL_JAK | (Km_TCELL_JAK1*((1 + (TCELL_SO |
| | 1_app | CS1.Concentration/Ki_TCELL_SOCS1))* |
| | | (1 + (TCELL_ SOCS3.Concentration/ |
| | | Ki_TCELL_SOCS3)))) |

TABLE 17

| Interaction | 4 | |
|---|---|---|
| Biological | Binding & Phosphorylation of JAK2 by IL6 receptor | |
| Relationship | activated JAK1 complex | |
| Literature | Activation of JAK kinases by IL6 signaling (Narazaki M | |
| | et.al, 1994) | |
| Mechanism | The reaction has been modeled as a Simple Michaelis | |
| | Menten equation with IL6-JAK1p complex as an activator. | |
| Chemical | [TCELL_JAK2 = | |
| Equation | TCELL_IL6R_act_IL6ST_di_JAK1_p_JAK2_p] | |
| Kinetic Rate | (Vf_TCELL_IL6R_act_IL6ST_di_JAK1_p*TCELL_JAK | |
| Equation | 2.Concentration)/(Km_TCELL_JAK2 + TCELL_JAK2. | |
| | Concentration) | |
| | Vf_TCELL_IL6R_a | (kcatf_TCELL_IL6R_act_IL6S |
| | ctIL6ST_di_JAK1_ | JAK1_p*TCELL_IL6R_act_II |
| | p | i_JAK1_p.Concentration)*VC: |

TABLE 18

| Interaction | 5 | |
|---|---|---|
| Biological | Phosphorylation of STAT3 by the IL6 receptor activated | |
| Relationship | JAK2 complex | |
| Literature | JAK-STAT signal transduction mechanism (Yamada S et.al, | |
| | 2003), SOCS3 based negative regulation of IL6 signaling | |
| | (Croker BA et.al, 2003), (Yasukawa H et.al, 2003), (Fischer | |
| | P et.al, 2004), SOCS1 based negative regulation of IL6 | |
| | signaling (Lee TL et.al, 2006), Role of STAT3 in T | |
| | Lymphocytes (Yang XO et.al, 2007) | |
| Mechanism | The reaction has been modeled as a Simple Michaelis | |
| | Menten equation with IL6-JAK1p-JAK2p complex as an | |
| | activator. | |
| Chemical | [TCELL_STAT3 = TCELL_STAT3_p] | |
| Equation | | |
| Kinetic Rate | ((Vf_TCELL_IL6R_act_IL6ST_di_JAK1p_JAK2_p)*T | |
| Equation | CELL_STAT3.Concentration)/(Km_TCELL_STAT3_app + | |
| | TCELL_STAT3.Concentration) | |
| | Vf_TCELL_I | (kcatf_TCELL_IL6R_act_IL6ST_di_ |
| | L6R_act_IL6 | p_JAK2_p*TCELL_IL6R_act_IL6S1 |
| | ST_di_JAK1_ | AK1_p JAK2_p.Concentration)*VC: |
| | p_JAK2_p | |
| | Km_TCELL_ | Km_TCELL_STAT3*((1+ (TCELL_S. |
| | STAT3_app | Concentration/Ki_TCELL_SOCS1)) |
| | | CELL_SOCS3.Concentration/Ki_TC |
| | | OCS3))) |

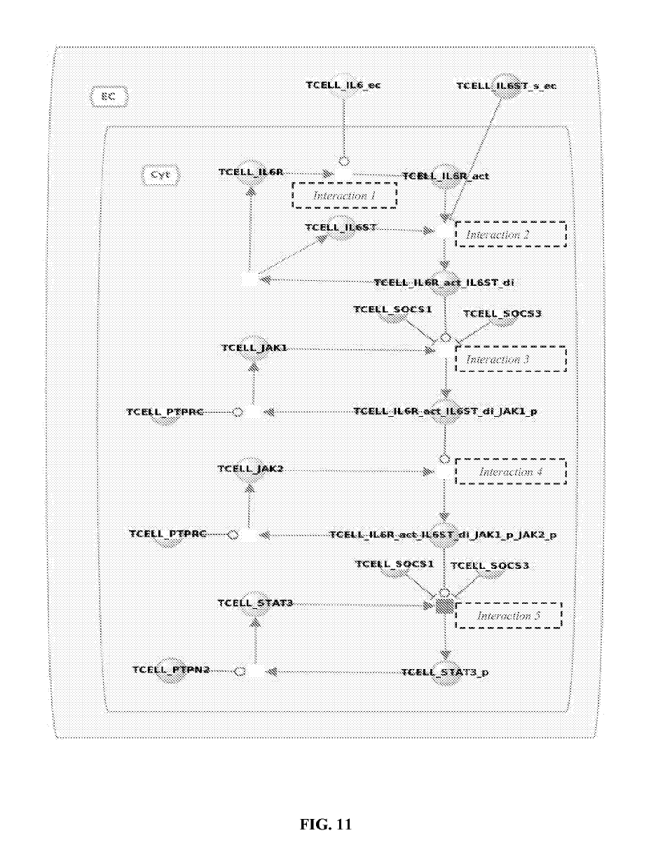

Based on the information/data made available in the Tables 14, 15, 16, 17 and 18 static representation of IL6-STAT3 signaling is dynamically simulated (refer FIG. 11)—by evaluating the specific kinetic rate law equations with a computational solver to predict the dynamicity of the different cellular interactions for a given simulation time.

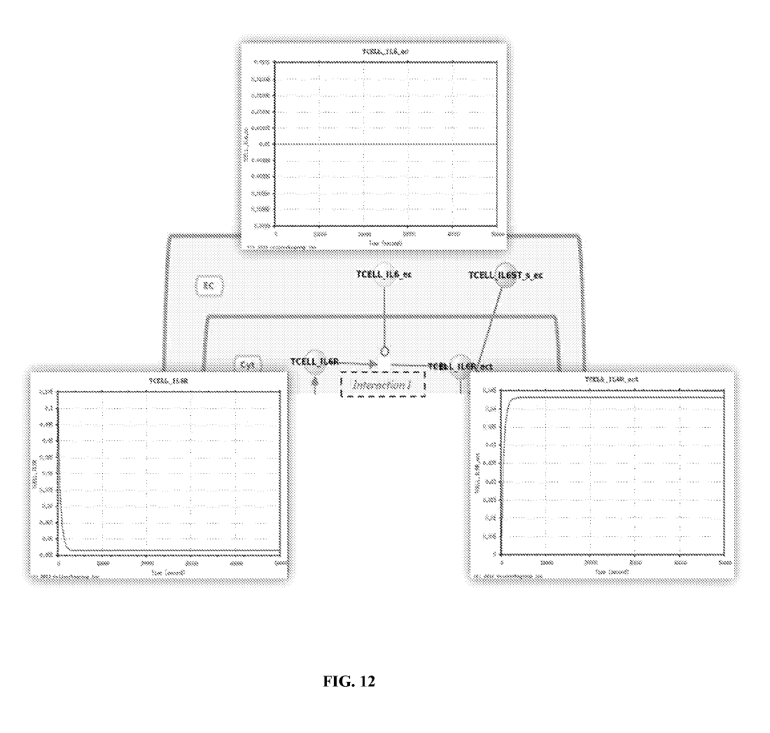

The FIG. 12, describes the interaction between TCELL_IL6_ec, TCELL_IL6R & TCELL_IL6_act and they are dynamically represented using concentration vs. time graph.

| Interaction | 1 | |
|---|---|---|
| Kinetic | (Vf_TCELL_IL6_ec*TCELL_IL6R.Concentration)/(Km_T | |
| Rate | CELL_IL6R + TCELL_IL6R.Concentration) | |
| Equation | Vf_TCEL = (kcatf_TCELL_IL6_ec*TCELL_IL | |
| | L_IL6_ec | 6_ec.Concentration)*VCyt |
| kcatf TCE | 7.50E−01 | |
| LL_IL6_ec | | |
| Km_TCEL | 1.00E+01 | |
| L_IL6R | | |

As shown above, these kinetics rate parameter values are optimized recursively to get the preferred steady state conditions which are defined based on model validations i.e. alignment datasets.

Similarly each biological relationship can be modeled among different ligands, receptors, adapter proteins, kinases, transcription factors, gene transcriptional regulations, translation, post-translation modifications, and gene expressions with respect to the phenotype or biomarker of interest in a specific cell system.

### Development of Cell System Model for RA Condition:

The focus above in developing unit model is on the role of IL6 in T-cell, which is exploited later to study their implications in RA model upon administering individual drug or a combination of drugs. On similar lines various biomarkers (as illustrated in Table 19) are studied individually from various literature to analyze their biological relationship with the corresponding biomarker in a respective signaling/metabolic pathway in T-lymphocyte and thereupon the specific kinetic rate law equations based on the relationship is developed. The below table-19 illustrates the key steps in cell system model development for T-lymphocyte with a disease focus of rheumatoid arthritis.

TABLE 19

| Key steps | Biomarkers involved in T lymphocyte signaling |
|---|---|
| Cell system's key | For “T Lymphocyte” based on data mining the following are the |
| phenotype and | important phenotypes |
| related markers | Antigen Recognition (related marker CD28 receptor complex) |
| | T cell proliferation (marker Interleukin 2 expression) |
| | T cell differentiation (marker TBET, GATA3) |
| | T cell mediated cytokine production (IFNG, TNF, IL1B, IL6) |
| Stimuli that can | For “T Lymphocyte” based on data mining the following are the |
| trigger the cell | important triggers |
| system | Antigen with HLA complex |
| | Complement System |
| Key unit | For “T Lymphocyte” based on data mining the following are the |
| pathways | important unit pathways |
| involved in the | T Cell Receptor pathway (TCR) |
| cell physiology | Co-stimulatory pathway (CD28) |
| | Interleukin 2 (IL2) |
| | Interferon gamma (IFNG) |
| | Interleukin 4 (1L4) |
| | Interleukin 12 (IL12) |
| | Interleukin 6 (IL6) |
| | Chemokines (CCL2, CCL4, CCL5) |
| Crosstalk between | For “T Lymphocyte” based on data mining the following cross talk |
| different unit | between TCR & CD28 pathway is identified |
| pathways | CD28 pathway enhances increases the downstream pathway of TCR. |
| | IL-6 rapidly up-regulates c-Maf transcription, as early as 3 h after |
| | TCR activation in naive CD4+ T cells. (PMID: 15728480) |
| Details of the | For “T Lymphocyte” based on data mining the following key outputs |
| outputs of the cell | are identified |
| that acts in | Cytokines (IL2, IL4, IL6, IL17) |
| autocrine or | Interferons (IFNG, IFNA) |
| paracrine fashion. | Chemokines (CCL2, CCL5) |

### Development of Disease Model Representing Rheumatoid Arthritis:

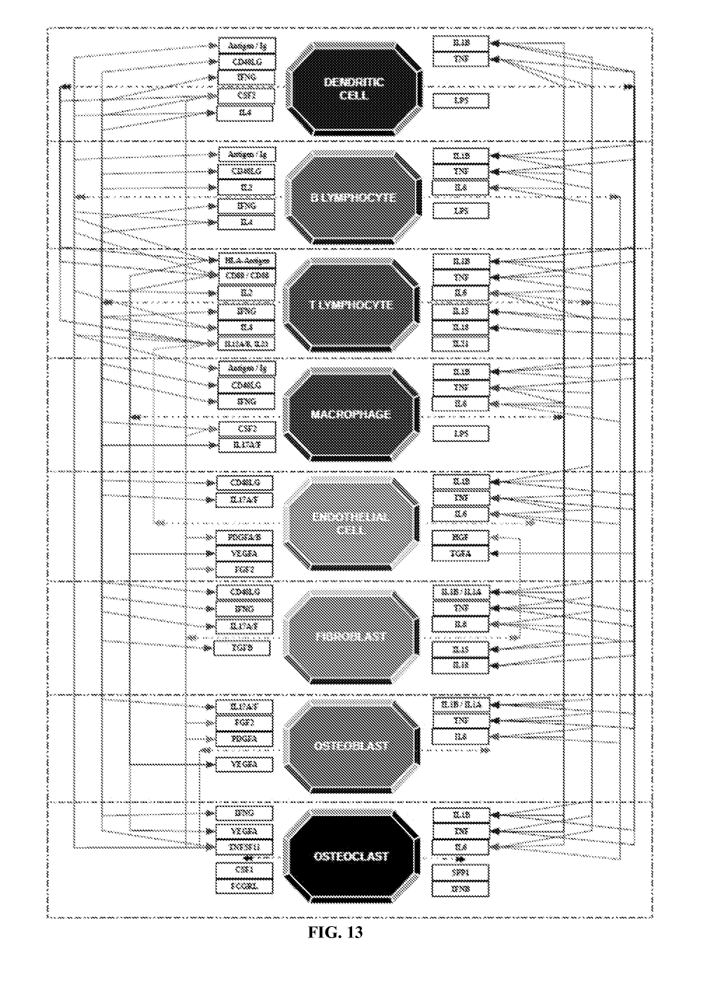

In-silico disease model for RA is developed by aggregating details from different cell systems involved in the pathophysiology of RA and their dominance in various stages of the disease, the set of stimuli that will trigger the onset of the disease, the in-depth details of the different inter-cellular interactions and details on disease specific phenotype markers. FIG. 13 shows the linking of various cell system model to develop a co-culture model, which also represents the relationship of biomarkers of one cell with another cell, wherein developed co-culture model is perturbed in a specific manner to replicate a RA disease model in a particular cell system or in a co-culture model.

The different cells within the cell system represented herein provides for the following types of cells:

Dendritic Cells (DC) functions mainly as APC (Antigen Presenting Cell) and activation of T lymphocytes;
B-Lymphocytes (BCELL) which are also responsible for antigen recognition and production of specific antibodies;
T-Lymphocytes (TCELL) (CD4+ Cells) are important decision making cells which directly controls the activation of macrophage and B lymphocytes;
Macrophages (MCP) which are responsible for responding to antigens or a bacterial insult and thereby invoking a profound inflammatory response;
Fibroblast (FB) which synthesizes the extracellular matrix and collagen;
Endothelial cell (ENC) which is responsible for angiogenesis in RA synovium.

Bone remodeling system involving the cells Osteoclast (OSC) and Osteoblast (OSB) are selected to highlight their effect on the bone in response to the inflammatory cytokines.

Each of the above mentioned cell systems are converged by careful analysis of literatures describing the pathophysiology of the disease and relating the function or phenotypes of these cell-systems with the phenotypes of the disease.

Once the individual cell system which is involved in the development of RA is analyzed and the biological relationship of the biomarkers with all the cells involved is established, the specific expression and signaling pattern across these different cell systems is analyzed in order to arrive at specific kinetic rate law equations. The below Table 20 represents the specific expression and signaling patterns:

TABLE 20

| | | | | | | | |
|---|---|---|---|---|---|---|---|
| DC | MCP | TCELL | BCELL | FB | ENC | OSB | OSC |

IL1B/Interleukin 1, beta

| | | | | | | | | |
|---|---|---|---|---|---|---|---|---|
| Expression | ✓ | ✓ | ✓ | ✓ | ✓ | ✓ | ✓ | ✓ |
| Signaling | ✓ | ✓ | ✓ | x | ✓ | ✓ | ✓ | ✓ |

TNF/TNFSF2/tumor necrosis factor

| | | | | | | | | |
|---|---|---|---|---|---|---|---|---|
| Expression | ✓ | ✓ | ✓ | ✓ | ✓ | ✓ | ✓ | ✓ |
| Signaling | ✓ | ✓ | ✓ | ✓ | ✓ | ✓ | ✓ | ✓ |

IL6/Interleukin 6 (interferon, beta 2)

| | | | | | | | | |
|---|---|---|---|---|---|---|---|---|
| Expression | ✓ | ✓ | ✓ | ✓ | ✓ | ✓ | ✓ | ✓ |
| Signaling | ✓ | ✓ | ✓ | ✓ | ✓ | ✓ | ✓ | ✓ |

IL18/Interleukin 18 (interferon-gamma-inducing factor)

| | | | | | | | | |
|---|---|---|---|---|---|---|---|---|
| Expression | ✓ | ✓ | x | x | ✓ | x | ✓ | x |
| Signaling | x | ✓ | ✓ | ✓ | ✓ | ✓ | x | x |

IL17A/Interleukin 17A

| | | | | | | | | |
|---|---|---|---|---|---|---|---|---|
| Expression | ✓ | x | ✓ | x | x | ✓ | ✓ | x |
| Signaling | x | ✓ | x | x | ✓ | ✓ | ✓ | x |

CSF2/GMCSF/colony stimulating factor 2 (granulocyte-macrophage)

| | | | | | | | | |
|---|---|---|---|---|---|---|---|---|
| Expression | ✓ | ✓ | ✓ | ✓ | ✓ | ✓ | ✓ | x |
| Signaling | ✓ | ✓ | x | x | ✓ | ✓ | x | x |

VEGFA/VEGF/vascular endothelial growth factor A

| | | | | | | | | |
|---|---|---|---|---|---|---|---|---|
| Expression | ✓ | ✓ | ✓ | x | ✓ | ✓ | ✓ | ✓ |
| Signaling | ✓ | ✓ | x | x | x | ✓ | ✓ | ✓ |

CCL2/MCP-1/chemokine (C-C motif) ligand 2

| | | | | | | | | |
|---|---|---|---|---|---|---|---|---|
| Expression | ✓ | ✓ | ✓ | x | ✓ | ✓ | ✓ | ✓ |
| Signaling | ✓ | ✓ | x | x | ✓ | x | x | x |

CXCL1/GRO-alpha/Chemokine (C-X-C motif) ligand

| | | | | | | | | |
|---|---|---|---|---|---|---|---|---|
| Expression | ✓ | ✓ | x | x | ✓ | ✓ | x | x |
| Signaling | ✓ | ✓ | x | x | x | x | x | x |

CTSK/cathepsin K

| | | | | | | | | |
|---|---|---|---|---|---|---|---|---|
| Expression | x | x | x | x | x | x | x | ✓ |
| Signaling | x | x | x | x | x | x | x | x |

MMP9/GELB/matrix metallopeptidase 9 (gelatinase B)

| | | | | | | | | |
|---|---|---|---|---|---|---|---|---|
| Expression | ✓ | ✓ | ✓ | ✓ | ✓ | ✓ | ✓ | ✓ |
| Signaling | x | x | x | x | x | x | x | x |

TNFSF11/RANKL/tumor necrosis factor (ligand) superfamily, member 11

| | | | | | | | | |
|---|---|---|---|---|---|---|---|---|
| Expression | x | x | ✓ | ✓ | ✓ | x | ✓ | x |
| Signaling | x | x | x | x | x | x | x | ✓ |

Further, the instant example describes the perturbation which is applied to the cell system model/co-culture model to develop a perturbed model replicating the condition of RA in a cell or in a co-culture model. For illustrative purposes, the example describes the perturbation of IL6 to describe the overexpression of STAT3 in T-cell to replicate a condition similar to biological system with RA condition.

These set of commands represent the highlighted experimental protocol (as provided in Table 21) obtained from the literature which provides a study on overexpression of Interleukin 6 (IL6) in a T lymphocyte (TCELL) cell system and asserting its effect on STAT3 phosphorylation.

The validations are analyzed based on the assertion report generated at the end of the validation which defines the dynamism of the generated perturbed RA co-culture model/disease model. For illustrative purposes, find below the assertion report of IL6 perturbation.

| ############################################# | | |
|---|---|---|
| # | Assertion Report | # |

| | | |
|---|---|---|
| # | Model Name - IL6_TCELL_RA | # |

#############################################

### For Study IL6_OE

There is no false assertion.
True assertion is:

TABLE 22
ASSERTION TABLE

| Name | Assertion | Control value | IL6_OE value | Status | Trend | Fold | Perc |
|---|---|---|---|---|---|---|---|
| TCELL_STAT3_p | Posedge | 1.061894e−02 | 2.151207e−02 | Assertion | Same | 2.03 | 102.58 |
| | | | | true | | | |

The developed perturbed co-culture model upon validation as provided above, is simulated with various combinations of drugs. The drugs which are selected to arrive at the combination is based on the predictive disease activity score which shows high correlation with various RA drug's published clinical trial data like ACR disease remission score. Table 23 illustrates the predictive activity score of various approved drugs. Further, Table 24 illustrates the effect of individual drug on the specific phenotype in relation to the specific biomarker.

TABLE 23

| | | ACR20 | ACR50 | ACR70 | Highest Significant | Predictive |
|---|---|---|---|---|---|---|
| | | *Significant | | | Clinical Disease | Disease |
| Drug | Type | difference > 15% | | | Remission Score | Activity Score |
| ABATACEPT | Drug | 60.8 | 45.3 | 17.6 | ACR50 | 50% |
| | Placebo | 45.3 | 27.3 | 5.5 | | |
| | Diff. | 15.5 | 18* | 12.1 | | |
| ETANERCEPT | Drug | 86 | 71 | 49 | ACR70 | 70% |
| | Placebo | 71 | 42 | 21 | | |
| | Diff. | 15 | 29 | 28* | | |
| TOFACITINIB | Drug | 80.8 | 72 | 25 | ACR70 | 70% |
| | Placebo | 14.3 | 14.3 | 5 | | |
| | Diff. | 66.5 | 57.7 | 20* | | |
| TOCILIZUMAB | Drug | 74 | 53 | 37 | ACR70 | 70% |
| | Placebo | 41 | 29 | 16 | | |
| | Diff. | 33 | 24 | 21* | | |
| DENOSUMAB | Drug | 23 | 9 | 1 | Non | No |
| | Placebo | 25 | 15 | 6 | Responsive | Effect |
| | Diff. | <0 | <0 | <0 | | |
| ANAKINRA | Drug | 38 | 17 | 6 | ACR20 | 20% |
| | Placebo | 22 | 8 | 2 | | |
| | Diff. | 16* | 9 | 4 | | |
| SECUKINUMAB | Drug | 54 | 27 | 12 | ACR20 | 20% |
| | Placebo | 31 | 15 | 8 | | |
| | Diff. | 23* | 12 | 0 | | |
| AMG714 | Drug | 62 | 0 | 0 | ACR20 | 20% |
| | Placebo | 26 | 0 | 0 | | |
| | Diff. | 36* | 0 | 0 | | |
| METHOTREXATE | Drug | 46 | 23 | 9 | ACR50 | 50% |
| | Placebo | 26 | 8 | 4 | | |
| | Diff. | 20 | 15* | 5 | | |
| RITUXIMAB | Drug | 54 | 34 | 20 | ACR70 | 70% |
| | Placebo | 28 | 13 | 5 | | |
| | Diff. | 26 | 21 | 15* | | |

TABLE 24

| RA | | | | |
|---|---|---|---|---|
| DISEASE | | | | |
| PHENOTYPE | MARKERS | | ANAKINRA | ETANERCEPT |
| Swollen Joints | IL1B | Interleukin 1, beta | 33.72% | 74.6% |
| | TNFA | Tumor necrosis factor | 21.19% | 72.3% |
| | IL6 | Interleukin 6 (interferon, beta 2) | 22.02% | 70% |
| | CCL2 | Chemokine (C-C motif) ligand 2 | 17.83% | 63.7% |
| | IL18 | Interleukin 18 (interferon-gamma- | 33.72% | 54% |
| | | inducing factor) | | |
| | IL17A | Interleukin 17A | 24.87% | 56.4% |
| | = average(0.15*IL1B + 0.2*TNFA 0.2* | | 21.49% | 65.75% |
| | IL6 + 0.15*CCL2 + 0.15*IL18 + 0.15*IL17A) | | | |
| Tender Joints | TNFSF | Tumor necrosis factor (ligand) | 30.69% | 75.68% |
| | 11 | superfamily, member 11 | | |
| | CTSK | Cathepsin K | 20.23% | 50.72% |
| | MMP9 | Matrix metallopeptidase 9 | | |
| | | (gelatinase B) | 19.00% | 66.53% |
| | = average(0.3*TNFSF11 + 0.4*CTSK + | | 22.99% | 62.95% |
| | 0.3 *MMP9) | | | |
| Pain | PGE2 | Prostaglandin E2 | 47.11% | 98.8% |
| CRP | CRP | C-reactive protein | 16.71% | 53.7% |

| | | | |
|---|---|---|---|
| PREDICTIVE | = average {Swollen Joints + Tender Joints + | 27.08% | 70.31% |
| DISEASE | Pain + CRP} | | |
| ACTVITY | = average {0.3*(average(0.15*IL1B + | | |
| SCORE | 0.2*TNFA + 0.2*IL6 + 0.15*CCL2 + | | |
| | 0.15*IL18 + 0.15*IL17A)) + 0.3*( | | |
| | average(0.3* TNFSF11 + 0.4*CTSK + | | |
| | 0.3*MMP9)) + 0.2*(PGE2) + 0.2*(CRP)} | | |

| | | |
|---|---|---|
| OVERALL EFFIACY RANGE | 20% | 70% |

Based on the predictive score, various combinations of drugs are tested from the digital drug library 106 to analyze the efficacy of the combination on RA disease model. The effect of the drug combinations in terms of predictive disease activity score and key RA disease phenotypes sorted based on level of synergy is also shown in below Table 25. In an embodiment, the effect of drug combinations is displayed on a user interface 108 as illustrated in FIG. 13.

The drugs within the digital drug library 106 are represented by proprietary designations, such as CWxxx, wherein xxx represents a combination of numbers, depending on the user defined criteria.

The combinations are tested through designed cost functions of concentrations, efficacy, low toxicity and PKPD compatibility of the drugs and compounds, in order to optimize the selectivity and to arrive at the most efficient therapeutic solution, based on which the combinations for specific disease profiles and indications are identified.

Cost functions such as the following are designed for the optimization of the process:

Inclusion of small molecule drugs;

### Inclusion of FDA Approved Drugs;

Exclusion of drugs that are approved for Rheumatoid Arthritis;
Exclusion of drugs that have Specific Adverse reactions, Toxicity;
Inclusion of drugs which will be off-patent in near future;
Also other criteria like 2-drug or 3-drug combination is given.

Based on these cost function, the matching drugs are selected from the drug library and combined exclusively and the set of commands for the execution of predictive computational simulation studies are automatically generated and execute through a high through-put systems using cloud computing architecture. These cost functions are programmable based on the fields present in digital drug library.

The results from the above process are used for the analysis of the likely outcome.

The following cost function is designed for the analytical purposes:

The novel therapeutic solution should be efficacious on the predictive RA disease score i.e more than 70%

The novel therapeutic solution should be efficacious on the predictive RA disease phenotypes i.e more than 70%

Also if the novel therapeutic solution is a combination, then the composition should be synergistic at least by >5%

Based on the above mentioned cost functions, the output result is represented as shown below. The effect of the drug combinations in terms of Predictive disease activity score & key RA disease phenotypes sorted based on level of synergy is also shown in below table.

TABLE 25

| | % CHANGE IN DISEASE ACTIVITY SCORE | | | | | |
|---|---|---|---|---|---|---|
| | | PREDICTIVE | | | | |
| | | DISEASE | SYN- | | COST FUNCTION | |
| DRUG | OVERALL | ACTIVITY | ERGY | | MATCHED COST | UNMATCHED COST |
| NAME | AVERAGE | SCORE | % | TAG | FUNCTIONS | FUNCTIONS |
| CW330 (¼) | 27.09 | 20% | 0.1 | NA | Small Molecules | Efficacious combination > 70% |
| CW331 (¼) | | | | | Not Approved for RA | Synergistic combination > 15% |
| CW056 (¼) | | | | | No Specific Toxicity | FDA Approved |
| | | | | | | Off patented Drugs |
| CW331 (¼) | 89.68 | 70% | 39.4 | Sy+ | Efficacious combination > 70% | Off patented Drugs |
| CW121 (¼) | | | | | Synergistic combination > 15% | FDA Approved |
| CW056 (¼) | | | | | Small Molecules | |
| | | | | | Not Approved for RA | |
| | | | | | No Specific Toxicity | |
| CW118 (¼) | 90 | 70% | 38.9 | Sy+ | Efficacious combination > 70% | Off patented Drugs |
| CW121 (¼) | | | | | Synergistic combination > 15% | FDA Approved |
| CW056 (¼) | | | | | Not Approved for RA | Small Molecules |
| | | | | | No Specific Toxicity | |
| CW299( 1/16) | 85.48 | 70% | 25.62 | Sy+ | Efficacious combination > 70% | |
| CW305(1) | | | | | Synergistic combination > 15% | |
| CW302 | | | | | Small Molecules | |
| ( 1/128) | | | | | FDA Approved | |
| | | | | | Not Approved for RA | |
| | | | | | No Specific Toxicity | |
| | | | | | Off patented Drugs | |
| CW330 (¼) | 0.58 | NA | 0 | NA | FDA Approved | Efficacious combination > 70% |
| CW331 (¼) | | | | | Not Approved for RA | Synergistic combination > 15% |
| CW079 (¼) | | | | | No Specific Toxicity | Small Molecules |
| | | | | | | Off patented Drugs |

The best combination drug from Table 25 based on the cost function is taken forward for further analysis. Below Table 26, illustrates the percentage change in predictive disease activity score and synergy of the chosen drug combination on RA disease model.

TABLE 26

| | | | | | % CHANGE IN PREDICTIVE DISEASE ACTIVITY SCORE | | | |
|---|---|---|---|---|---|---|---|---|
| | % CHANGE IN RA DISEASE PHENOTYPES | | | | | PREDICTIVE | | |
| DRUG | SWOLLEN | TENDER | | | OVERALL | DISEASE ACTIVITY | SYNERGY | |
| NAME | JOINTS | JOINTS | PAIN | CRP | AVERAGE | SCORE | % | TAG |
| CW299( 1/16) | 82.69 | 83.59 | 82.38 | 93.28 | 85.48 | 70% | 25.62 | Sy+ |
| CW305(1) | | | | | | | | |
| CW302( 1/128) | | | | | | | | |
| CW299( 1/64) | 88.18 | 86.9 | 89.04 | 96.62 | 90.19 | 70% | 0.06 | Sy |
| CW305(1) | | | | | | | | |
| CW302(1) | | | | | | | | |
| CW299( 1/64) | 53.09 | 45.28 | 50.65 | 67.59 | 54.15 | 50% | −0.01 | — |
| CW305(⅛) | | | | | | | | |
| CW302( 1/32) | | | | | | | | |
| CW299( 1/128) | 14.45 | 11.44 | 13.25 | 21.35 | 15.12 | RESIST | −0.7 | — |
| CW305( 1/128) | | | | | | | | |
| CW302( 1/128) | | | | | | | | |

The effect of the drug combination in terms of key RA disease phenotypes associated biomarker is illustrated in below Table 27.

TABLE 27

| DRUG | SWOLLEN JOINTS | | | | | | | TENDER JOINTS | | | |
|---|---|---|---|---|---|---|---|---|---|---|---|
| NAME | TNF | IL6 | IL1B | IL17A | CCL2 | IL18 | AVG | MMP9 | CTSK | RANKL | AVG |
| CW299( 1/16) | 78.46 | 88.07 | 81.38 | 82.73 | 79.78 | 85.72 | 82.69 | 75.96 | 91.79 | 83.01 | 83.59 |
| CW305(1) | | | | | | | | | | | |
| CW302( 1/128) | | | | | | | | | | | |
| CW299( 1/64) | 83.99 | 91.83 | 88.61 | 88.2 | 87.94 | 88.54 | 88.18 | 83.53 | 91.16 | 86 | 86.9 |
| CW305(1) | | | | | | | | | | | |
| CW302(1) | | | | | | | | | | | |
| CW299( 1/64) | 49.29 | 60.35 | 53.04 | 44.52 | 49.11 | 62.23 | 53.09 | 49.4 | 30.58 | 55.86 | 45.28 |
| CW305(⅛) | | | | | | | | | | | |
| CW302( 1/32) | | | | | | | | | | | |
| CW299( 1/128) | 12.94 | 17.3 | 15.95 | 8.98 | 12.3 | 19.26 | 14.45 | 14.54 | 5.31 | 14.47 | 11.44 |
| CW305( 1/128) | | | | | | | | | | | |
| CW302( 1/128) | | | | | | | | | | | |

| | | | | PREDICTIVE | | |
|---|---|---|---|---|---|---|
| DRUG | PAIN | CRP | OVERALL | DISEASE ACTIV- | SYNERGY | |
| NAME | PGE2 | CRP | AVERAGE | ITY SCORE | % | TAG |
| CW299( 1/16) | 82.38 | 93.28 | 85.48 | 70% | 25.62 | Sy+ |
| CW305(1) | | | | | | |
| CW302( 1/128) | | | | | | |
| CW299( 1/64) | 89.04 | 96.62 | 90.19 | 70% | 0.06 | Sy |
| CW305(1) | | | | | | |
| CW302(1) | | | | | | |
| CW299( 1/64) | 50.65 | 67.59 | 54.15 | 50% | −0.01 | — |
| CW305(⅛) | | | | | | |
| CW302( 1/32) | | | | | | |
| CW299( 1/128) | 13.25 | 21.35 | 15.12 | NO EFFECT | −0.7 | — |
| CW305( 1/128) | | | | | | |
| CW302( 1/128) | | | | | | |

From table 27, it is inferred that the combination comprising CW299, CW305 and CW302 showed highest synergy of 25.62% on improving the RA condition on the developed RA model. Further, this combination of drug is further analyzed to study the effect of the drug combination in terms of key RA disease phenotypes, associated biomarkers, and predictive disease activity score with Marker level synergy, which is illustrate in Table 28 below:

TABLE 28

| DRUG | SWOLLEN JOINTS | | | | | | | TENDER JOINTS | | | |
|---|---|---|---|---|---|---|---|---|---|---|---|
| NAME | TNF | IL6 | IL1B | IL17A | CCL2 | IL18 | AVG | MMP9 | CTSK | RANKL | AVG |
| CW299( 1/16) | 78.46 | 88.07 | 81.38 | 82.73 | 79.78 | 85.72 | 82.69 | 75.96 | 91.79 | 83.01 | 83.59 |
| CW305(1) | | | | | | | | | | | |
| CW302( 1/128) | | | | | | | | | | | |
| CW299( 1/16) | 9.6 | 14.62 | 12.45 | 7.71 | 9.82 | 14.92 | 11.52 | 10.99 | 3.14 | 10.94 | 8.35 |
| CW305(1) | 40.79 | 49.69 | 43.7 | 33.16 | 39.54 | 52.9 | 43.3 | 42.23 | 12.37 | 45.14 | 33.25 |
| CW302( 1/128) | 4.35 | 5.37 | 5.78 | 2.7 | 3.76 | 6.71 | 4.78 | 5.23 | 3.01 | 4.53 | 4.26 |
| MARKER | 23.72 | 18.39 | 19.45 | 39.16 | 26.66 | 11.19 | | 17.51 | 73.27 | 22.4 | |
| LEVEL | | | | | | | | | | | |
| SYNERGY | Sy+ | Sy+ | Sy+ | Sy+ | Sy+ | Sy+ | | Sy+ | Sy+ | Sy+ | |

| | | | | PREDICTIVE | | |
|---|---|---|---|---|---|---|
| DRUG | PAIN | CRP | OVERALL | DISEASE ACTIV- | SYNERGY | |
| NAME | PGE2 | CRP | AVERAGE | ITY SCORE | % | TAG |
| CW299( 1/16) | 82.38 | 93.28 | 85.48 | ACR70 | 25.62 | Sy+ |
| CW305(1) | | | | | | |
| CW302( 1/128) | | | | | | |
| CW299( 1/16) | 9.48 | 15.35 | 11.17 | RESIST | | |
| CW305(1) | 42.19 | 56.36 | 43.77 | ACR20 | | |
| CW302( 1/128) | 4.03 | 6.62 | 4.92 | RESIST | | |
| MARKER | 26.68 | 14.95 | | | | |
| LEVEL | Sy+ | Sy+ | | | | |
| SYNERGY | | | | | | |

Thus by using these cost functions, a 3-drug combination of CW299, CW305 and CW302 is arrived at for treatment of RA. The efficacy of this combination has been validated using Murine Collagen Induced Arthritis Animal Model, which proved the predicted outcome.

### Example-2

### Development of Novel Therapeutic Solution for Cancer

### Development of Unit Model:

For the development of unit model, the data assimilated from literature on a specific signaling/metabolic pathway, which is diligently used for the creation of a static unit model following the same methodology and strategy as explained for the IL6 unit model in the RA example above.

### Development of Cell System Model:

The development of a cell type model mainly involves understanding cell systems, key phenotype and related markers, different stimuli that trigger the cell system to turn cancerous, key unit pathways involved in the cell physiology, crosstalk between different unit pathways and details of the outputs of the cell that acts in autocrine or paracrine fashion.

The below Table 29 illustrates the cell system model development for tumor cell in an in-silico cancer model:

TABLE 29

| Key steps in Cell System | |
|---|---|
| development | Markers |
| Cell systems key phenotype and | For “Tumor Cell” based on data mining the |
| related markers. | following are the important phenotypes |
| | Proliferation (related marker CDK-Cyclin |
| | complexes) |
| | Survival (marker AKT1, BCL2) |
| | Apoptosis (marker BAX, CASP3) |
| | Viability (function of survival and |
| | Apoptosis) |
| | Angiogenesis (VEGFA, IL8) |
| | Metastasis (MMPs, TGFB) |
| Stimuli that can trigger the cell | For “Tumor Cell” based on data mining the |
| system | following are the important triggers |
| | Growth Factor Receptors like EGFR, IFGR |
| | and PDGFRA |
| | Cytokine/Chemokine receptors |
| Key unit pathways involved in the | For “Tumor Cell” based on data mining the |
| cell physiology | following are the important unit pathways |
| | EGFR Receptor pathway (EGFR) |
| | IGFR Receptor pathway (IGFR) |
| | Cell Cycle pathway |
| | Apoptotic machinery (Extrinsic- Caspases |
| | and Intrinsic- P53 regulation) |
| | DNA repair machinery (RAD proteins) |
| | Cytokine pathways (IL1,1L4) |
| | HGF/MET pathway |
| | Wnt/B-catenin pathway |
| | Chemokines (CCL2, CCL4, CCL5) |
| Crosstalk between different unit | For “Tumor Cell” based on data mining the |
| pathways | following cross talk between EGFR & Cell |
| | cycle pathway is identified |
| | EGFR pathway stimulates the production of |
| | key CDK and cyclins and activation of these |
| | complexes for cell cycle progression. |
| Details of the outputs of the cell | For “Tumor Cell” based on data mining the |
| that acts in autocrine or paracrine | following key outputs are identified |
| fashion. | Growth factor pathways (EGFR, IGFR, |
| | PDGFRA, HGF/MET, TGFB) |
| | Wnt/B-catenin |
| | CDK/Cyclin complexes |
| | Angiogenic factors like ANGPT2, IL8, |
| | VEGFA, THBS1/2, SERPIN |
| | Cytokines (IL2, IL4, IL6, IL17) |
| | Interferons (IFNG, IFNA) |
| | Chemokines (CCL2, CCL5) |

The markers defined in the above table is converged diligently at different levels to yield a cell system model depicting various signaling/metabolic pathway and each of these convergence points will have varied signaling contribution from different pathways.

### Development of Disease Model Representing Cancer:

Development of an in-silico model for Cancer requires aggregation of details including the different cell systems involved in the patho-physiology of Cancer and their dominance in various stages of the disease, the set of stimuli that triggers the onset of the disease, the in-depth details of the different inter-cellular interactions and details on disease specific phenotype markers. For a predictive computational cancer co-culture disease model designed to represent tumor microenvironment the following cell systems are integrated:

Macrophages which are responsible for synthesizing cytokines and chemokines that help support metastasis;
Fibroblast which synthesizes the extracellular matrix and collagen; and
Endothelial cell which is responsible for angiogenesis

The various inter-cellular interactions between the cell systems are charted out based on the specific input and output of all these cell system models and their biological relationships are represented as specific kinetic rate law equations.

The specific kinetic rate law equations are evaluated with a computational solver to predict the dynamicity of the different cellular interactions for a given simulation time.

The predictive cancer disease model is set for various stages of disease by selective perturbation of trigger or stimulus. Also different disease profiles or mutation profiles is created to evaluate the efficacy of therapy in different disease patient populations.

Various predictive computational simulation studies experiments are coded using set of executable commands. All these different set of predictive computational simulation studies are executed in a parallel mode, through a high through-put system using cloud computing architecture.

The model can be perturbed to different conditions through the set of these commands. The perturbations can be disease setting, an overexpression, knock-down, addition of a drug, addition of a function. Therefore for any predictive computational simulation studies of the model, a set of executable commands can be coded, which can be executed on the model using the computational solver and the results can be validated.

An automated screening of all the output data from the predictive computational simulation studies executed through high through-put systems is carried out and relevant reports are generated for further analysis.

Correlation of the predictive disease activity score

The predictive disease activity score showed high correlation with various Cancer drug's published data like impact on proliferation and viability. The below table 30 shows the correlation details:

TABLE 30

| | | EXPERIMENTAL DATA | | PREDICTIVE DATA | |
|---|---|---|---|---|---|
| DRUG NAME | BASELINE | PROLIFERATION | VIABILITY | PROLIFERATION | VIABILITY |
| ERLOTINIB | H1155 | R | R | −6.91 | −5.63 |
| AZD6244 | COL0205 | S | S | −82.04 | −64.22 |
| AZD6244 | H1155 | R | R | −12.64 | −17.66 |
| PIOGLITAZONE | A549 | S | S | −31.53 | −35.06 |
| CGP049090 | H460 | S | S | −44.7 | −42.96 |
| SORAFENIB | HT29 | S | S | −87.63 | −68.25 |
| XL147 | H460 | S | S | −41.54 | −43.65 |

Note:
For predictive data changes less than 20% are considered resistant

Based on the predictive data, various combinations of drugs are tested from the digital drug library 106 to analyze the efficacy of the combination on cancer disease model.

The drugs within the digital drug library 106 is represented by proprietary designations, such as CWxxx, wherein xxx represents a combination of numbers, depending on the user defined criteria.

The combinations are tested through designed cost functions of concentrations, efficacy, low toxicity and PKPD compatibility of the drugs and compounds, in order to optimize the selectivity and to arrive at the most efficient therapeutic solution, based on which the combinations for specific disease profiles and indications are identified.

Cost functions such as the following are designed for the optimization of the process:

Inclusion of small molecule drugs

### Inclusion of FDA Approved Drugs

Inclusion of drugs that show good efficacy as anti-cancer agents
Exclusion of drugs with existing prior art
Exclusion of drugs with saturating effect of the single agent
Exclusion of drugs that have Specific Adverse reactions, Toxicity
Inclusion of drugs which will be off-patent in near future
Also other criteria like 2-drug or 3-drug combination is given

Based on these cost function, the matching drugs are selected from the drug library and combined exclusively and the set of commands for the execution of predictive computational simulation studies are automatically generated and execute through a high through-put systems using cloud computing architecture. These cost functions are programmable based on the fields present in digital drug library.

The results from the above process are used by the analytical engine. The following cost function is designed for the analytical purposes:

The novel therapeutic solution should be efficacious on the predictive Cancer disease phenotypes i.e., more than 50%

Also if the novel therapeutic solution is a combination, then the composition should be synergistic or show an enhancement over the individual effects

Based on the above mentioned cost functions, the output result is represented as shown below. The effect of the drug combinations in terms of key cancer disease phenotypes sorted based on level of synergy along with the inference is shown in below Tables 31 and 32:

TABLE 31

| | % CHANGE REDUCTION IN CANCER DISEASE PHENOTYPES IN HCT116777 | | | | | |
|---|---|---|---|---|---|---|
| DRUG | PROLIFERATION | | | VIABILITY | | |
| NAME | A | B | AB | A | B | AB |
| CW175-CW161 | −44.94 | −10.73 | −56.23 | −25.25 | −10.65 | −40.86 |
| CW230-CW137 | −47.37 | −41.58 | −73.77 | −42.33 | −22.89 | −59.93 |
| CW178-CW229 | −28.12 | −58.63 | −81.75 | −22.93 | −46.53 | −90.7 |
| CW159-CW231 | −21.98 | −30.14 | −62.09 | −20.32 | −27.8 | −85.03 |
| CW153-CW159 | −49.53 | −36.03 | −78.02 | −42.51 | −37.37 | −89.87 |

TABLE 32

| | % CHANGE REDUCTION IN CANCER DISEASE PHENOTYPES IN SW480 | | | | | |
|---|---|---|---|---|---|---|
| DRUG | PROLIFERATION | | | VIABILITY | | |
| NAME | A | B | AB | A | B | AB |
| CW175-CW161 | −49.56 | −7.19 | −62.25 | −40.65 | −7.9 | −54.98 |
| CW230-CW137 | −48.8 | −39.78 | −91.07 | −50.99 | −31.49 | −94.19 |
| CW178-CW229 | −36.09 | −69.17 | −89.91 | −31.79 | −59.03 | −93.35 |
| CW159-CW231 | −21.91 | −36.98 | −45.72 | −20.71 | −35.53 | −43.95 |
| CW153-CW159 | −52.8 | −42.89 | −59.11 | −51.95 | −46.84 | −59.6 |

Thus by using these cost functions, a 2-drug combination of drug comprising CW229 and CW178 is arrived at for treatment of cancer. Based on the cost function, the combination of drug comprising CW229 and CW178 showed enhanced efficacy with percentage decrease in the proliferation by 89.91% and percentage decrease in the viability by 93.95%.

1-34. (canceled)

35. A system for identifying an individual drug or combination of drugs by user defined cost function for treatment of a disease, said system comprising:
a database comprising:
one or more insilico unit models, wherein the one or more insilico unit models are configured by data mining;
one or more insilico cell system models, wherein the one or more insilico cell system models are obtained by integrating the one or more insilico unit models, said one or more insilico cell system models facilitates simulation of at least one biological system or homeostatic state of the biological system, wherein the simulated biological system or the simulated homeostatic state of the biological system is perturbed to obtain an insilico disease model; and
one or more insilico co-culture models, wherein the one or more insilico co-culture models are obtained by integrating the one or more insilico cell system models, wherein the insilico co-culture model is perturbed to obtain an insilico disease model;
a digital drug library, wherein the digital drug library is an electronic repository comprising digital drug capsule;
a processor, communicatively connected to the database and the digital drug library, said processor configured to
transmit one of the one or more insilico disease models along with a set of digital drug capsules from the digital drug library to a scheduler, said set of digital drug capsules are selected from the digital drug library based on user defined first cost function, wherein the scheduler distributes individual digital drug capsule or combination of digital drug capsules with the one or more insilico disease models to one or more computing devices, further wherein the scheduler is connected to the one or more computing devices through a network;
receive an output comprising an effect of the individual digital drug capsule or combination of digital drug capsules on the insilico disease model from the scheduler, wherein the output is based on user defined second cost function and wherein the scheduler transmits the output to the processor by combining matching results from the one or more computing devices; and
analyze an output to identify the individual drug or the combination of drugs for treatment of the disease.

36. The system as claimed in claim 35, wherein the network is a cloud based network.

37. The system as claimed in claim 35, wherein the data mining comprises assimilation of information from literature resources inclusive of online peer-reviewed journal, published text and reviewed literature source; wherein the information selected from at least one of:
pathways selected from a group comprising signaling pathway, metabolic pathway, apoptotic signaling pathway and signal transduction pathway;
networks selected from a group comprising genomic networks, and protein networks; and biomarkers.

38. The system as claimed in claim 37, wherein the information is selected from a group comprising biological information, therapeutic information, pathological information, computational information, information on mutation, information pertaining to kinetic rate laws and information pertaining to kinetic rate parameters or any combination thereof.

39. The system as claimed in claim 37, wherein the biomarkers are selected from a group comprising proteins, metabolites, nucleic acids, ions, nutrients, hormones, lipids, transporters, receptors and enzymes or any combination thereof.

40. The system as claimed in claim 35, wherein the insilico cell system model comprises insilico cell selected from a group comprising white blood cell, dendritic cell, B Lymphocyte, Helper T Lymphocytes, Cytotoxic T Lymphocytes, Mast cells Beta-Pancreatic cell, Cardiomyocyte, E. Coli, Endothelial Cell, Fibroblast, Adipocyte, Hepatocyte, Keratinocyte, Macrophage, Melanocyte, Mycobacterium Tuberculosis, Neutrophil, Osteoblast, Osteoclast, Skeletal Muscle, Tumor Cell, Epithelial cells, Plasma cells, Natural killer cells, other inflammatory related cells and any other human cell system or cell lines or any combination thereof.

41. The system as claimed in claim 35, wherein the digital drug capsule is an electronic file representing a drug, small molecule, biomolecule, small inhibitory molecule or ligand or a combination thereof and comprises
information selected from a group comprising mechanism of action (MOA), pharmacological properties including IC50, Cmax, bioavailability, AUC, Tmax and half-life, physical properties including structure, molecular formula and molecular weight, information of pharmaceutical formulation, information pertaining to approved or safe dosing range, therapeutic category, indications, information pertaining to off-target effects, interactions and adverse events, manufacturer details, patent information and indication specific alignment information including trends observed for biomarkers, phenotypes and disease scores in experiments performed on patients, animal models and cell-line cultures, or any combination thereof, independently for the drug, the small molecule, the biomolecule, the small inhibitory molecule or the ligand or a combination thereof.

42. The system as claimed in claim 35, wherein the digital drug library comprises at least one of a single target digital drug capsule, a multi-target digital drug capsule, pseudo digital drug capsule and hypothetical digital drug capsule comprising action selected from a group comprising single target or multi-target or any combination thereof.

43. The system as claimed in claim 35, wherein the insilico biological system comprises processes selected from a group comprising gene transcription, RNA translation, signaling pathway, metabolic pathway, antigen presentation, signal transduction pathway, gene over-expression, gene knock-down, gene knock out, gene inhibition, genomic network, protein network, cell cycle, whole cell simulation and cell growth or any combination thereof.

44. The system as claimed in claim 35, wherein the first cost function for selecting the digital drug capsule from the digital drug library is selected from a group comprising chemical nature and properties of the drug, clinical status of the drug, patent status of the drug, toxicity information of the drug, pharmacokinetics of the drug, pharmacodynamics of the drug, pharmacogenomics of the drug and prior known therapeutic efficacy of the drug, or any combination thereof.

45. The system as claimed in claim 35, wherein the second cost function for receiving the output is selected from a group comprising efficacy on disease score by at least 50%, efficacy on disease phenotype by at least 50% and synergy of combination of digital drug capsule by at least 5%, or any combination thereof.

46. A method for identifying an individual drug or combination of drugs by user defined cost function for treatment of a disease, said method comprising:
transmitting one of one or more insilico disease model along with a set of digital drug capsules from a digital drug library to a scheduler, said set of digital drug capsules are selected from the digital drug library based on user defined first cost function, wherein the scheduler distributes individual digital drug capsule or combination of digital drug capsules with the one or more insilico disease models to one or more computing devices, further wherein the scheduler is connected to the one or more computing devices through a network;
receiving an output comprising an effect of the individual digital drug capsule or combination of digital drug capsules on the insilico disease model from the scheduler, wherein the output is processed based on user defined second cost function and wherein the scheduler transmits the output to the processor by combining matching results from the one or more computing devices; and
analyzing the output to identify the individual drug or the combination of drugs for treatment of the disease.

47. The method as claimed in claim 46, wherein the one or more insilico disease models are obtained by:
configuring one or more insilico unit models by data mining;
obtaining one or more insilico cell system models by integrating the one or more insilico unit models, said one or more insilico cell system models facilitates simulation of at least one biological system or homeostatic state of the biological system, wherein the simulated biological system or the simulated homeostatic state of the biological system is perturbed to obtain the insilico disease model; and
obtaining one or more insilico co-culture models, by integrating the one or more insilico cell system models, wherein the insilico co-culture model is perturbed to obtain the insilico disease model.

48. The method as claimed in claim 46, wherein the digital drug library is an electronic repository comprising digital drug capsule, and wherein the digital drug capsule is an electronic file representing a drug, small molecule, biomolecule, small inhibitor molecule or ligand or a combination thereof and comprises: information selected from a group comprising mechanism of action (MOA), pharmacological properties including IC50, Cmax, bioavailability, AUC, Tmax and half-life, physical properties including structure, molecular formula and molecular weight, information of pharmaceutical formulation, information pertaining to approved or safe dosing range, therapeutic category, indications, information pertaining to off-target effects, interactions and adverse events, manufacturer details, patent information and indication specific alignment information including trends observed for biomarkers, phenotypes and disease scores in experiments performed on patients, animal models and cell-line cultures, or any combination thereof, independently for the drug, the small molecule, the biomolecule, the small inhibitory molecule or the ligand or a combination thereof.

49. The method as claimed in claim 47, wherein the biological system comprises processes selected from a group comprising gene transcription, RNA translation, signaling pathway, metabolic pathway, antigen presentation, signal transduction pathway, gene over-expression, gene knock-down, gene knock out, gene inhibition, genomic network, protein network, cell cycle, whole cell simulation and cell growth or any combination thereof.

50. The method as claimed in claim 46, wherein the data mining comprises assimilation of information from literature resources inclusive of online peer-reviewed journal, published text and reviewed literature sources; wherein the information selected from at least one of:
pathways selected from a group comprising signaling pathway, metabolic pathway, apoptotic signaling pathway and signal transduction pathway;
networks selected from a group comprising genomic networks, and protein networks; and biomarkers.

51. The method as claimed in claim 50, wherein the information is selected from a group comprising biological information, therapeutic information, pathological information, computational information, information on mutation, information pertaining to kinetic rate laws and information pertaining to kinetic rate parameters or any combination thereof.

52. The method as claimed in claim 47, wherein the insilico unit model comprises species and bio-molecular interactions across different parts of a insilico cell selected from at least one of cytoplasm, nucleus, mitochondria, Endosome, Endoplasmic Reticulum, Golgi Apparatus, Inner mitochondrial membrane, Inner membrane space, Lysosome, Membrane, Melanosome, Rough Endoplasmic Reticulum, Mitochondrial Matrix, Accessory Compartment, and extracellular space.

53. The method as claimed in claim 47, wherein the insilico cell system model comprises insilico cell selected from a group comprising white blood cells, dendritic cell, B Lymphocyte, Helper T Lymphocyte, Cytotoxic T Lymphocyte, Mast cells, Beta-Pancreatic cell, Cardiomyocyte, E. Coli, Endothelial Cell, Fibroblast, Adipocyte, Hepatocyte, Keratinocyte, Macrophage, Melanocyte, Mycobacterium Tuberculosis, Neutrophil, Osteoblast, Osteoclast, Skeletal Muscle, Tumor Cell, Epithelial cells, Plasma cells, Natural killer cells, other inflammatory related cells and any other human cell system or cell lines or any combination thereof and mutation profiles of the insilico cell.

54. The method as claimed in claim 46, further comprising validation for optimization of insilico model parameters and alignment of datasets.

55. The method as claimed in claim 54, wherein the insilico model parameters are selected from at least one of biological pathway, biological network and biomarkers.

56. The method as claimed in claim 55, wherein change in levels of the parameter are defined by specific trigger which represent perturbation in the homeostatic state, thereby inducing and representing disease, wherein said perturbation leads to change in level of biomarkers.

57. The method as claimed in claim 56, wherein the biomarkers are selected from a group comprising proteins, metabolites, nucleic acids, ions, nutrients, hormones, lipids, transporters, receptors and enzymes or any combination thereof.

58. The method as claimed in claim 56, wherein the perturbation lead to assertive statement which indicate positive or negative adherence of alignment and validation dataset in the insilico model, wherein the assertive statement is based on at least one of quality and quantity of expected trend of a biomarker specific for the perturbed parameters within said insilico model.

59. The method as claimed in claim 46, wherein the digital drug library comprises at least one of a single target digital drug capsule, a multi-target digital drug capsule, pseudo digitaldrug capsule and hypothetical digital drug capsule comprising novel mechanism of action selected from a group comprising single target or multi-target or any combination thereof.

60. The method as claimed in claim 46, wherein the matching comprises:
simulating the perturbed state of the insilico disease model with information from set of digital drug capsule; and
optimizing dosage recursively by the digital drug capsule efficacy characterization to achieve perfect alignment to trends observed in disease specific biomarker or phenotype or a combination thereof.

61. The method as claimed in claim 46, wherein the insilico disease model represents disease selected from at least one of autoimmune diseases, cancers, dermatological diseases, infectious diseases, cardiac conditions, pulmonary diseases, renal diseases, nerve diseases or neurological disorders, inflammatory disorders or any other human diseases.

62. The method as claimed in claim 46, wherein the first cost function for selecting the digital drug capsule from the digital drug library is selected from a group comprising concentration, efficacy, low toxicity, pharmacokinetic and pharmacodynamic, or any combination thereof.

63. The method as claimed in claim 46, wherein the second cost function for receiving the output is selected from a group comprising efficacy on disease score by at least 70%, efficacy on disease phenotype by at least 70% and synergy of combination of digital drug capsule by at least 5%, or any combination thereof.

64. A non-transitory computer readable medium comprising instructions stored thereon that when processed by at least one processor causes a system to:
transmit one of one or more insilico disease model along with a set of digital drug capsules from a digital drug library to a scheduler, said set of digital drug capsules are selected from the digital drug library based on a user defined first cost function, wherein the scheduler distributes the individual digital drug capsule or combination of digital drug capsules with the one or more insilico disease models to one or more computing devices, further wherein the scheduler is connected to the one or more computing devices through a network;
receive an output comprising the effect of the individual digital drug capsule or combination of digital drug capsules on the insilico disease model from the scheduler, wherein the output is based on user defined second cost function and wherein the scheduler transmits the output to the processor by combining matching results from the one or more computing devices; and
analyze an output to identify the individual drug or the combination of drugs for treatment of a disease.

65. A computer program for identifying an individual drug or combination of drugs by user defined cost function for treatment of a disease, said computer program comprising:
code segment for transmitting one of one or more insilico disease model along with a set of digital drug capsules from a digital drug library to a scheduler, said set of digital drug capsules are selected from the digital drug library based on user defined first cost function, wherein the scheduler distributes individual digital drug capsule or combination of digital drug capsules with the one or more insilico disease models to one or more computing devices, further wherein the scheduler is connected to the one or more computing devices through a network, code segment for receiving an output comprising the effect of the individual digital drug capsule or combination of digital drug capsules on the insilico disease model from the scheduler, wherein the output is based on user defined second cost function and wherein the scheduler transmits the output to the processor by combining matching results from the one or more computing devices, code segment for analyzing the output to identify the individual drug or the combination of drugs for treatment of the disease.
